(19) United States
(12) Patent Application Publication
(10) Pub. No.: US 2023/0288770 A1
(43) Pub. Date: Sep. 14, 2023

(54) ATMOSPHERIC ADJUSTMENT IN AN ENCLOSURE

(71) Applicant: View, Inc., Milpitas, CA (US)

(72) Inventors: Anurag GUPTA, San Jose, CA (US); Mohammadreza ABTAHI, Milpitas, CA (US); Piers Iain Ivo Octavian MACNAUGHTON, San Jose, CA (US); Nitesh TRIKHA, Pleasanton, CA (US); Rao P. MULPURI, Saratoga, CA (US); Aditya DAYAL, Sunnyvale, CA (US); Forest Canyon HUGHES, Milpitas, CA (US); Ajay MALIK, Milpitas, CA (US); Siyao SUI, San Jose, CA (US); Chuqing WANG, San Jose, CA (US)

(21) Appl. No.: 18/007,047

(22) PCT Filed: Jul. 26, 2021
(86) PCT No.: PCT/US2021/043143

§ 371 Date: Jan. 27, 2023

Related U.S. Application Data
(63) Continuation-in-part of application No. PCT/US21/15378, filed on Jan. 28, 2021.
Application No. PCT/US21/15378 is a continuation of application No. 17/083,128, filed on Oct. 28, 2020.
Application No. 17/083,128 is a continuation of application No. 16/664,089, filed on Oct. 25, 2019, now Pat. No. 11,294,254.
Application No. 16/664,089 is a continuation-in-part of application No. PCT/US2019/030467, filed on May 2, 2019.
Application No. 16/664,089 is a continuation-in-part of application No. PCT/US2018/029460, filed on Apr. 25, 2018.
Application No. PCT/US2018/029460 is a continuation-in-part of application No. PCT/US18/29460, filed on Apr. 25, 2018.
Application No. PCT/US21/15378 is a continuation-in-part of application No. 16/447,169, filed on Jun. 20, 2019.
Application No. 16/447,169 is a continuation-in-part of application No. PCT/US21/27418, filed on Apr. 15, 2021.
(60) Provisional application No. 63/057,120, filed on Jul. 27, 2020.
(60) Provisional application No. 63/078,805, filed on Sep. 15, 2020.
(60) Provisional application No. 62/967,204, filed on Jan. 29, 2020.
(60) Provisional application No. 62/666,033, filed on May 2, 2018.
(60) Provisional application No. 62/490,457, filed on Apr. 26, 2017.
(60) Provisional application No. 62/506,514, filed on May 15, 2017.
(60) Provisional application No. 62/507,704, filed on May 17, 2017.
(60) Provisional application No. 62/523,606, filed on Jun. 22, 2017.
(60) Provisional application No. 62/607,618, filed on Dec. 19, 2017.
(60) Provisional application No. 62/688,957, filed on Jun. 22, 2018.
(60) Provisional application No. 62/768,775, filed on Nov. 16, 2018.
(60) Provisional application No. 63/080,899, filed on Sep. 21, 2020.
(60) Provisional application No. 62/803,324, filed on Feb. 8, 2019.
(60) Provisional application No. 62/858,100, filed on Jun. 6, 2019.
(60) Provisional application No. 63/080,899, filed on Sep. 21, 2020.
(60) Provisional application No. 63/052,639, filed on Jul. 16, 2020.
(60) Provisional application No. 63/010,977, filed on Apr. 16, 2020.

(51) Int. Cl. G02F 1/163; H02J 50/20; H02J 50/80; G05B 19/042; E06B 9/24

(52) U.S. Cl. CPC G02F 1/163; H02J 50/20; H02J 50/80; G05B 19/042; E06B 9/24; E06B 2009/2417; G05B 2219/2614; G05B 2219/25011; G05B 2219/2628; E06B 2009/2464; G05B 2219/25252

(57) ABSTRACT

Disclosed herein as methods, apparatuses, non-transitory computer readable media, and systems for controlling atmospheric quality of an enclosed zone (e.g., at least one enclosure, an enclosure, or a portion of an enclosure), e.g., by controlling ventilation of the zone and/or adjusting a chemical content of an atmosphere of the enclosed zone.

### RELATED APPLICATIONS

This application claims priority to U.S. Provisional Patent Application Ser. No. 63/057,120, filed Jul. 27, 2020, titled “ATMOSPHERIC QUALITY ADJUSTMENT IN AN ENCLOSURE,” to U.S. Provisional Patent Application Ser. No. 63/078,805, filed Sep. 15, 2020, titled “ATMOSPHERIC ADJUSTMENT IN AN ENCLOSURE.” This application also claims priority to International Patent Application Serial No. PCT/US21/15378, filed Jan. 28, 2021, titled “SENSOR CALIBRATION AND OPERATION,” which claims priority from U.S. Provisional Patent Application Ser. No. 62/967,204, filed Jan. 29, 2020, titled “SENSOR CALIBRATION AND OPERATION.” International Patent Application Serial No. PCT/US21/15378 is also a Continuation-in-Part of U.S. patent application Ser. No. 17/083,128, filed Oct. 28, 2020, titled “BUILDING NETWORK,” which is a Continuation of U.S. patent application Ser. No. 16/664,089, filed Oct. 25, 2019, titled “BUILDING NETWORK.” U.S. patent application Ser. No. 17/083,128 is also a Continuation-in-Part of International Patent Application Serial No. PCT/US19/30467, filed May 2, 2019, titled “EDGE NETWORK FOR BUILDING SERVICES,” which claims priority from U.S. Provisional Patent Application Ser. No. 62/666,033, filed May 2, 2018, titled “EDGE NETWORK FOR BUILDING SERVICES.” U.S. patent application Ser. No. 17/083,128 is also a Continuation-in-Part of International Patent Application Serial No. PCT/US18/29460, filed Apr. 25, 2018, titled “TINTABLE WINDOW SYSTEM FOR BUILDING SERVICES,” that claims priority from U.S. Provisional Patent Application Ser. No. 62/607,618, filed on Dec. 19, 2017, titled “ELECTROCHROMIC WINDOWS WITH TRANSPARENT DISPLAY TECHNOLOGY FIELD,” from U.S. Provisional Patent Application Ser. No. 62/523,606, filed on Jun. 22, 2017, titled “ELECTROCHROMIC WINDOWS WITH TRANSPARENT DISPLAY TECHNOLOGY,” from U.S. Provisional Patent Application Ser. No. 62/507,704, filed on May 17, 2017, “ELECTROCHROMIC WINDOWS WITH TRANSPARENT DISPLAY TECHNOLOGY,” from U.S. Provisional Patent Application Ser. No. 62/506,514, filed on May 15, 2017, titled “ELECTROCHROMIC WINDOWS WITH TRANSPARENT DISPLAY TECHNOLOGY,” and from U.S. Provisional Patent Application Ser. No. 62/490,457, filed on Apr. 26, 2017, titled “ELECTROCHROMIC WINDOWS WITH TRANSPARENT DISPLAY TECHNOLOGY.” International Patent Application Serial No. PCT/US21/15378 is also a Continuation-in-Part of U.S. patent application Ser. No. 16/447,169, filed Jun. 20, 2019, titled “SENSING AND COMMUNICATIONS UNIT FOR OPTICALLY SWITCHABLE WINDOW SYSTEMS,” which claims priority from U.S. Provisional Patent Application Ser. No. 62/858,100, filed Jun. 6, 2019, titled “SENSING AND COMMUNICATIONS UNIT FOR OPTICALLY SWITCHABLE WINDOW SYSTEMS.” U.S. patent application Ser. No. 16/447,169, also claims priority from U.S. Provisional Patent Application Ser. No. 62/803,324, filed Feb. 8, 2019, titled “SENSING AND COMMUNICATIONS UNIT FOR OPTICALLY SWITCHABLE WINDOW SYSTEMS,” U.S. Provisional Patent Application Ser. No. 62/768,775, filed Nov. 16, 2018, titled “SENSING AND COMMUNICATIONS UNIT FOR OPTICALLY SWITCHABLE WINDOW SYSTEMS,” U.S. Provisional Patent Application Ser. No. 62/688,957, filed Jun. 22, 2018, titled “SENSING AND COMMUNICATIONS UNIT FOR OPTICALLY SWITCHABLE WINDOW SYSTEMS,” and from U.S. Provisional Patent Application Ser. No. 62/666,033. U.S. patent application Ser. No. 16/447,169 is also a Continuation-in-Part of International Patent Application Serial No. PCT/US19/30467. This application also claims priority to International Patent Application Serial No. PCT/US21/27418, filed Apr. 15, 2021, titled “INTERACTION BETWEEN AN ENCLOSURE AND ONE OR MORE OCCUPANTS” that claims priority from U.S. Provisional Patent Application Ser. No. 63/080,899, filed Sep. 21, 2020, titled “INTERACTION BETWEEN AN ENCLOSURE AND ONE OR MORE OCCUPANTS,” from U.S. Provisional Application Ser. No. 63/052,639, filed Jul. 16, 2020, titled “INDIRECT INTERACTIVE INTERACTION WITH A TARGET IN AN ENCLOSURE,” and from U.S. Provisional Application Ser. No. 63/010,977, filed Apr. 16, 2020, titled “INDIRECT INTERACTION WITH A TARGET IN AN ENCLOSURE.” Each of the patent applications recited above is incorporated by reference herein in its entirety.

### BACKGROUND

Decreased atmospheric (e.g., air) quality in an enclosure may lead to a decrease in wellbeing, comfort, and/or productivity of enclosure occupant(s). Such decrease in atmospheric quality may arise due to accumulation of gas borne and/or gaseous materials or to insufficient supply thereof, which inadequate amount of materials in the atmosphere of the enclosure may lead to such decrease in atmospheric quality. For example, an accumulation of carbon dioxide (CO₂), VOC, and/or particulate material beyond a threshold may reduce the atmospheric quality. For example, insufficient supply of oxygen and/or humidity may reduce the atmospheric quality. Under-ventilation of indoor environments can lead to decreased atmospheric quality, e.g., due to accumulation of gas-borne and/or gaseous materials (e.g., pollutants) that accumulate in the under-ventilated environment and thus reduce its atmospheric quality. Increased atmosphere quality and/or ventilation may be requested to reduce infection probability of occupants in the enclosure. Enclosures (e.g., facilities) having a high occupancy density and/or high occupancy exchange rate may be particularly affected. Such enclosures (e.g., facilities) may be occupied by large number of individuals and/or may be occupied by frequently changing individuals. Such enclosures may include large work environments, health and/or entertainment centers. For example, transportation hubs, sporting hubs, hospitals, exhibition centers, shopping malls, financial centers, movie theaters, museums, and/or cruise ships. Existing ventilation systems may not adjust (e.g., exchange and/or supplement) at least a portion of the atmosphere of the enclosure (or any portion thereof) at a rate that maintains the requested atmospheric quality level of the enclosure, and/or may increase the risk of pathogen infection (e.g., by forming pathogen growth medium). Existing filtration and/or ventilation systems may be inadequate, e.g., due to low exchange rates (e.g., due to compromised monitoring and/or control). American Society for Testing and Materials (ASTM) standards can provide an example for optimal ventilation flow rates that utilize full occupancy in an enclosure. Over-ventilation may be undesirable, e.g., as it may lead to energy waste. An unknown ratio of fresh to recycled atmosphere may mean that the accumulating atmospheric materials (e.g., gas borne (e.g., air borne) and/or gaseous materials such as carbon dioxide (CO₂), volatile organic compounds (VOC), and/or particulate matter (PM)) are at an unknown concentration. The accumulating atmospheric material may be referred to herein as “accumulant.” The depleting atmospheric material (e.g., consumed atmospheric material such as oxygen) may be referred to herein collectively as “depletant.”

Existing demand control ventilation systems measure one or more atmospheric components (e.g., pollutants and/or accumulants) at a single point in the room, in the supply duct, and/or in the exhaust duct. The degree of deviation of the one or more atmospheric components (e.g., gas borne and/or gaseous materials) from a requested level may not be appreciated. It would be preferable to assess the level of the one or more atmospheric components spatially and/or in combination with occupancy, e.g., to control ventilation rate(s) using the measured atmospheric component(s), at least in the breathing zone of the enclosure. Although it would be useful to quantify the ventilation rate existing for a particular enclosure (or portion thereof, e.g., a room), sensors (e.g., pressure sensors) may not be present to (e.g., accurately) determine the ventilation rate. Gas(es) (e.g., air) may be delivered from an activated heating, ventilation and air conditioning (HVAC) system at a (e.g., substantially) constant ventilation rate. However, the levels of the atmospheric component(s) to be controlled (e.g., monitored) may vary, e.g., as a function of room occupancy, and thus a constant ventilation rate may not adequately maintain an optimal indoor environment. At least one sensor may be configured (e.g., designed) to measure one or more environmental characteristics, for example, temperature, humidity, ambient noise, carbon dioxide, VOC, particulate matter, oxygen, and/or any other aspects of an environment (e.g., atmosphere thereof). A control system may be utilized to control the atmospheric component(s).

### SUMMARY

Various aspects disclosed herein alleviate at least part of the one or more shortcomings related to optimizing the atmospheric quality of the enclosure, e.g., while minimizing energy usage. Various aspects disclosed herein may relate to utilizing data of one or more sensors to adjust a ventilation rate to control the atmospheric quality in the enclosure.

Various aspects disclosed herein relate to combining detection of one or more atmospheric components (such as VOC, particulate matter, or CO₂) with occupancy detection (e.g., utilizing locating technology). The locating technology may utilize ultrawide band radio waves (UWB)), infrared (IR) sensor(s), camera, and/or sound. Combination of the locating technology with the environmental component detection may enable calculation of existing ventilation rate and/or estimating what ventilation rate is required to purge stale atmosphere in a given amount of time. Rate of change in the atmospheric component(s) can be used to predict future levels and/or proactively control ventilation (e.g., with or without taking occupancy into account). By obtaining indoor and outdoor measurements of the environmental components(s) (e.g., particulate matter), filter efficiency may be evaluated, e.g., to detect need for filter change and/or risk of pathogen proliferation.

In another aspect, a method for controlling an atmosphere of an enclosure, the method comprises: (A) determining a present concentration of a substance in the atmosphere of the enclosure, which substance has (i) a first concentration regime having a detrimental effect on one or more occupants in the enclosure, and (ii) a second concentration regime having non-detrimental effect on the one or more occupants in the enclosure; and (B) when the present concentration is at the first concentration regime then (I) determining, an atmosphere exchange rate to yield a target concentration at the second concentration regime, which atmosphere exchange rate is determined within a time and at an occupancy in the enclosure at the time, and (II) adjusting a ventilation system based at least in part on the atmosphere exchange rate determined.

In some embodiments, a threshold between the first concentration regime and the second concentration regime comprises a jurisdictional (e.g., health) standard. In some embodiments, a vent of the ventilation system is disposed in the enclosure. In some embodiments, the enclosure is at least a portion of a facility, building, and/or room. In some embodiments, the method further comprises (C) when the present concentration is at the second concentration regime then (I) determining a ventilation rate of the ventilation system to supply air into the enclosure to obtain a (e.g., steady state) concentration of the substance in the second concentration regime, and (II) adjusting the ventilation system based at least in part on the ventilation rate determined. In some embodiments, the ventilation system includes an atmosphere handling system providing an adjustable ventilation flow rate. In some embodiments, adjustment of the ventilation system in operation (B)(II) comprises increasing the adjustable ventilation flow rate. In some embodiments, adjustment of the ventilation system in operation (C)(II) comprises decreasing the adjustable ventilation flow rate. In some embodiments, the adjustable ventilation flow rate is increased or decreased incrementally. In some embodiments, incrementally is by a predetermined step size. In some embodiments, the adjustable ventilation flow rate is increased or decreased continuously. In some embodiments, the adjustable ventilation flow rate is increased or decreased by an adjustment proportional to a difference between the present concentration and a target concentration. In some embodiments, adjustment of the adjusting a ventilation system comprises controlling the ventilation system at least in part using an absolute flow rate. In some embodiments, in operation (B)(I), the atmosphere exchange rate is determined using a natural logarithm of a ratio of the present concentration to the target concentration divided by the time. In some embodiments, in operation (B)(II), adjustment of the ventilation system comprises converting the atmosphere exchange rate determined to a compensatory flow rate and adjusting the ventilation system using the compensatory flow rate. In some embodiments, the compensatory flow rate is converted using the atmosphere exchange rate and (e.g., multiplied by) a volume of enclosure. In some embodiments, the present concentration of the substance is determined using at least one atmospheric sensor disposed in the enclosure. In some embodiments, the at least one atmospheric sensor includes a carbon dioxide concentration sensor, a volatile organic compound (VOC) concentration sensor, and/or a particular matter concentration sensor. In some embodiments, the at least one atmospheric sensor is part of a sensor ensemble disposed in the enclosure, which sensor ensemble integrates a plurality of sensors. In some embodiments, the ensemble comprises a controller. In some embodiments, the sensor ensemble is operatively coupled to a hierarchical control system comprising a plurality of controllers. In some embodiments, the first concentration regime comprises concentrations greater than the target concentration. In some embodiments, the second concentration regime comprises concentrations less than the target concentration. In some embodiments, the present concentration, the first concentration regime, the second concentration regime, and the target concentration comprise differential concentrations relative to an ambient concentration in air external to the enclosure. In some embodiments, the method further comprises determining an occupancy number corresponding to a number of the one or more occupants in the enclosure. In some embodiments, the occupancy number is estimated in response to the present concentration of carbon dioxide in the enclosure, and a per person generation rate of the carbon dioxide. In some embodiments, the substance comprises carbon dioxide. In some embodiments, a sensed concentration of the carbon dioxide is measured at least in part by at least one sensor. In some embodiments, the occupancy number is determined using (a) a per person generation rate of carbon dioxide, (b) a difference between the sensed concentration and an outside ambient concentration of the carbon dioxide, and (c) a current ventilation rate in the enclosure. In some embodiments, the occupancy number is determined in response to a measurement signal from at least one occupancy sensor. In some embodiments, the at least one occupancy sensor comprises an electromagnetic wave sensor, a camera, or a tag reader. In some embodiments, the electromagnetic wave sensor comprises senses electromagnetic radiation comprising infrared, microwave, or radio wave. In some embodiments, the radio wave comprises ultrawide bandwidth radio waves or ultrahigh frequency radio waves. In some embodiments, the present concentration of the substance is determined using at least one atmospheric sensor. In some embodiments, the at least one occupancy sensor and the at least one atmospheric sensor are integrated in a sensor ensemble disposed in the enclosure. In some embodiments, the occupancy number is a predicted number for a future time. In some embodiments, the predicted number is derived from stored historical concentration data. In some embodiments, the predicted number is derived from (e.g., electronically stored) scheduling data and/or current occupancy measurements. In some embodiments, the method further comprises (C) sensing an occupancy number corresponding to a number of the one or more occupants in the enclosure; and (D) sensing a present ventilation flow rate of the ventilation system into the enclosure. In some embodiments, the present concentration is determined using a per person generation rate of the substance and (e.g., multiplied by) the sensed occupancy and using the present ventilation flow rate. In some embodiments, the method further comprises: (C) determining an occupancy number corresponding to a number of the one or more occupants in the enclosure; and (D) determining a present ventilation flow rate using the present concentration and the occupancy number determined. In some embodiments, the substance is a particulate matter. In some embodiments, the ventilation system includes a filter for removing the particulate matter. In some embodiments, the method further comprises: (C) determining a present filter efficiency of the filter using a present ventilation flow rate and the present concentration of the particulate matter; (D) comparing the present filter efficiency to an efficiency threshold; and (E) generating a notification and/or a report when the present filter efficiency declines below the efficiency threshold. In some embodiments, the notification and/or the report comprises a warning message. In some embodiments, the notification and/or the report is periodically generated.

In another aspect, a non-transitory computer readable media for controlling an atmosphere of an enclosure, the non-transitory computer readable media, when read by one or more processors, is configured to direct operations comprises: (A) determining a present concentration of a substance in the atmosphere of the enclosure, which substance has (i) a first concentration regime having a detrimental effect on one or more occupants in the enclosure, and (ii) a second concentration regime having non-detrimental effect on the one or more occupants in the enclosure; and (B) when the present concentration is at the first concentration regime then: (I) determining, an atmosphere exchange rate to yield a target concentration at the second concentration regime, which atmosphere exchange rate is determined within a time and at an occupancy in the enclosure at the time, and (II) adjusting a ventilation system based at least in part on the atmosphere exchange rate determined.

In some embodiments, a threshold between the first concentration regime and the second concentration regime comprises a jurisdictional (e.g., health) standard. In some embodiments, a vent of the ventilation system is disposed in the enclosure. In some embodiments, the enclosure is at least a portion of a facility, building, and/or room. In some embodiments, the operations comprise (C) when the present concentration is at the second concentration regime then (I) determining a ventilation rate of the ventilation system to supply air into the enclosure to obtain a (e.g., steady state) concentration of the substance in the second concentration regime, and (II) adjusting the ventilation system based at least in part on the ventilation rate determined. In some embodiments, the ventilation system includes an atmosphere handling system providing an adjustable ventilation flow rate. In some embodiments, adjustment of the ventilation system in operation (B)(II) comprises increasing the adjustable ventilation flow rate. In some embodiments, adjustment of the ventilation system in operation (C)(II) comprises decreasing the adjustable ventilation flow rate. In some embodiments, the adjustable ventilation flow rate is increased or decreased incrementally. In some embodiments, incrementally is by a predetermined step size. In some embodiments, the adjustable ventilation flow rate is increased or decreased continuously. In some embodiments, the adjustable ventilation flow rate is increased or decreased by an adjustment proportional to a difference between the present concentration and a target concentration. In some embodiments, adjustment of the ventilation system comprises controlling the ventilation system at least in part using an absolute flow rate. In some embodiments, in operation (B)(I), the atmosphere exchange rate is determined using a natural logarithm of a ratio of the present concentration to the target concentration divided by the time. In some embodiments, in operation (B)(II), adjustment of the ventilation system comprises converting the atmosphere exchange rate determined to a compensatory flow rate and adjusting the ventilation system using the compensatory flow rate. In some embodiments, the compensatory flow rate is converted using the atmosphere exchange rate and (e.g., multiplied by) a volume of enclosure. In some embodiments, the present concentration of the substance is determined using at least one atmospheric sensor disposed in the enclosure. In some embodiments, the at least one atmospheric sensor includes a carbon dioxide concentration sensor, a volatile organic compound (VOC) concentration sensor, and/or a particular matter concentration sensor. In some embodiments, the at least one atmospheric sensor is part of a sensor ensemble disposed in the enclosure, which sensor ensemble integrates a plurality of sensors. In some embodiments, the ensemble comprises a controller. In some embodiments, the sensor ensemble is operatively coupled to a hierarchical control system comprising a plurality of controllers. In some embodiments, the first concentration regime comprises concentrations greater than the target concentration. In some embodiments, the second concentration regime comprises concentrations less than the target concentration. In some embodiments, the present concentration, the first concentration regime, the second concentration regime, and the target concentration comprise differential concentrations relative to an ambient concentration in air external to the enclosure. In some embodiments, the operations comprise determining an occupancy number corresponding to a number of the one or more occupants in the enclosure. In some embodiments, the occupancy number is estimated in response to the present concentration of carbon dioxide in the enclosure, and a per person generation rate of the carbon dioxide. In some embodiments, the substance comprises carbon dioxide. In some embodiments, a sensed concentration of the carbon dioxide is measured at least in part by at least one sensor. In some embodiments, the occupancy number is determined using (a) a per person generation rate of carbon dioxide, (b) a difference between the sensed concentration and an outside ambient concentration of the carbon dioxide, and (c) a current ventilation rate in the enclosure. In some embodiments, the occupancy number is determined in response to a measurement signal from at least one occupancy sensor. In some embodiments, the at least one occupancy sensor comprises an electromagnetic wave sensor, a camera, or a tag reader. In some embodiments, the electromagnetic wave sensor comprises senses electromagnetic radiation comprising infrared, microwave, or radio wave. In some embodiments, the radio wave comprises ultrawide bandwidth radio waves or ultrahigh frequency radio waves. In some embodiments, the present concentration of the substance is determined using at least one atmospheric sensor. In some embodiments, the at least one occupancy sensor and the at least one atmospheric sensor are integrated in a sensor ensemble disposed in the enclosure. In some embodiments, the occupancy number is a predicted number for a future time. In some embodiments, the predicted number is derived from stored historical concentration data. In some embodiments, the predicted number is derived from (e.g., electronically stored) scheduling data and/or current occupancy measurements. In some embodiments, the operations comprise (C) sensing an occupancy number corresponding to a number of the one or more occupants in the enclosure; and (D) sensing a present ventilation flow rate of the ventilation system into the enclosure. In some embodiments, the present concentration is determined using a per person generation rate of the substance and (e.g., multiplied by) the sensed occupancy and using the present ventilation flow rate. In some embodiments, the operations comprise: (C) determining an occupancy number corresponding to a number of the one or more occupants in the enclosure; and (D) determining a present ventilation flow rate using the present concentration and the occupancy number determined. In some embodiments, the substance is a particulate matter. In some embodiments, the ventilation system includes a filter for removing the particulate matter. In some embodiments, the method further comprises: (C) determining a present filter efficiency of the filter using a present ventilation flow rate and the present concentration of the particulate matter; (D) comparing the present filter efficiency to an efficiency threshold; and (E) generating a notification and/or a report when the present filter efficiency declines below the efficiency threshold. In some embodiments, the notification and/or the report comprises a warning message. In some embodiments, the notification and/or the report is periodically generated. In some embodiments, at least two of a plurality of the operations (e.g., operations (A), (B), (C), (D), (E), and (F)) are performed by the same processor. In some embodiments, at least two of a plurality of the operations (e.g., operations (A), (B), (C), (D), (E), and (F)) are performed by different processors.

In another aspect, an apparatus for controlling an atmosphere of an enclosure, the apparatus comprises at least one controller (e.g., comprising circuity) configured to: (A) operatively couple to a ventilation system disposed at least in part in the enclosure; (B) determine, or direct determination of, a present concentration of a substance in the atmosphere of the enclosure, which substance has (i) a first concentration regime having a detrimental effect on one or more occupants in the enclosure, and (ii) a second concentration regime having non-detrimental effect on the one or more occupants in the enclosure; and (C) when the present concentration is at the first concentration regime then: (I) determine, or direct determination of, an atmosphere exchange rate to yield a target concentration at the second concentration regime, which atmospheric exchange rate is determined within a time and at an occupancy in the enclosure at the time, and (II) adjust, or direct adjustment of, a ventilation system based at least in part on the atmosphere exchange rate determined.

In some embodiments, a threshold between the first concentration regime and the second concentration regime comprises a jurisdictional (e.g., health) standard. In some embodiments, a vent of the ventilation system is disposed in the enclosure. In some embodiments, the enclosure is at least a portion of a facility, building, and/or room. In some embodiments, the at least one controller is configured to (D) when the present concentration is at the second concentration regime then (I) determine, or direct determination of, a ventilation rate of the ventilation system to supply air into the enclosure to obtain a (e.g., steady state) concentration of the substance in the second concentration regime, and (II) adjust, or direct adjustment of, the ventilation system based at least in part on the ventilation rate determined. In some embodiments, the ventilation system includes an atmosphere handling system providing an adjustable ventilation flow rate. In some embodiments, adjustment of the ventilation system in operation (C)(II) comprises increasing the adjustable ventilation flow rate. In some embodiments, adjustment of the ventilation system in operation (D)(II) comprises decreasing the adjustable ventilation flow rate. In some embodiments, the at least one controller is configured to alter, or direct alteration of, the adjustable ventilation flow rate is incrementally. In some embodiments, incrementally is by a predetermined step size. In some embodiments, the at least one controller is configured to alter, or direct alteration of, the adjustable ventilation flow rate continuously. In some embodiments, the at least one controller is configured to alter, or direct alteration of, the adjustable ventilation flow rate by an adjustment proportional to a difference between the present concentration and a target concentration. In some embodiments, the at least one controller is configured to adjust, or direct adjustment of, the ventilation system by controlling the ventilation system at least in part using an absolute flow rate. In some embodiments, in operation (C)(I), the atmosphere exchange rate is determined using a natural logarithm of a ratio of the present concentration to the target concentration divided by the time. In some embodiments, in operation (C)(II), adjustment of the ventilation system comprises converting the atmosphere exchange rate determined to a compensatory flow rate and adjusting the ventilation system using the compensatory flow rate. In some embodiments, the at least one controller is configured to convert, or direct conversion of, the compensatory flow rate using the atmosphere exchange rate and (e.g., multiplied by) a volume of enclosure. In some embodiments, the at least one controller is configured to determine, or direct determination of, the present concentration of the substance using at least one atmospheric sensor disposed in the enclosure. In some embodiments, the at least one atmospheric sensor includes a carbon dioxide concentration sensor, a volatile organic compound (VOC) concentration sensor, and/or a particular matter concentration sensor. In some embodiments, the at least one atmospheric sensor is part of a sensor ensemble disposed in the enclosure, which sensor ensemble integrates a plurality of sensors. In some embodiments, the ensemble comprises a controller (e.g., a micro-controller). In some embodiments, the sensor ensemble is operatively coupled to a hierarchical control system comprising a plurality of controllers. In some embodiments, the first concentration regime comprises concentrations greater than the target concentration. In some embodiments, the second concentration regime comprises concentrations less than the target concentration. In some embodiments, the present concentration, the first concentration regime, the second concentration regime, and the target concentration comprise differential concentrations relative to an ambient concentration in air external to the enclosure. In some embodiments, the at least one controller is configured to determine, or direct determination of, an occupancy number corresponding to a number of the one or more occupants in the enclosure. In some embodiments, the occupancy number is estimated in response to the present concentration of carbon dioxide in the enclosure, and a per person generation rate of the carbon dioxide. In some embodiments, the substance comprises carbon dioxide. In some embodiments, a sensed concentration of the carbon dioxide is measured at least in part by at least one sensor. In some embodiments, the occupancy number is determined using (a) a per person generation rate of carbon dioxide, (b) a difference between the sensed concentration and an outside ambient concentration of the carbon dioxide, and (c) a current ventilation rate in the enclosure. In some embodiments, the occupancy number is determined in response to a measurement signal from at least one occupancy sensor. In some embodiments, the at least one occupancy sensor comprises an electromagnetic wave sensor, a camera, or a tag reader. In some embodiments, the electromagnetic wave sensor comprises senses electromagnetic radiation comprising infrared, microwave, or radio wave. In some embodiments, the radio wave comprises ultrawide bandwidth radio waves or ultrahigh frequency radio waves. In some embodiments, the present concentration of the substance is determined using at least one atmospheric sensor. In some embodiments, the at least one occupancy sensor and the at least one atmospheric sensor are integrated in a sensor ensemble disposed in the enclosure. In some embodiments, the occupancy number is a predicted number for a future time. In some embodiments, the predicted number is derived from stored historical concentration data. In some embodiments, the predicted number is derived from (e.g., electronically stored) scheduling data and/or current occupancy measurements. In some embodiments, the at least one controller is configured to (D) direct sensing an occupancy number corresponding to a number of the one or more occupants in the enclosure; and (E) sensing a present ventilation flow rate of the ventilation system into the enclosure. In some embodiments, the present concentration is determined using a per person generation rate of the substance and (e.g., multiplied by) the sensed occupancy and using the present ventilation flow rate. In some embodiments, the at least one controller is configured to (D) determine, or direct determination of, an occupancy number corresponding to a number of the one or more occupants in the enclosure; and (E) determine, or direct determination of, a present ventilation flow rate using the present concentration and the occupancy number determined. In some embodiments, the substance is a particulate matter. In some embodiments, the ventilation system includes a filter for removing the particulate matter. In some embodiments, the at least one controller is configured to: (D) determine, or direct determination of, a present filter efficiency of the filter using a present ventilation flow rate and the present concentration of the particulate matter; (E) compare, or direct comparison of, the present filter efficiency to an efficiency threshold; and (F) generate, or direct generation of, a notification and/or a report when the present filter efficiency declines below the efficiency threshold. In some embodiments, the notification and/or the report comprises a warning message. In some embodiments, the notification and/or the report is periodically generated. In some embodiments, at least two of a plurality of the operations (e.g., operations (A), (B), (C), (D), (E), and (F)) are performed by the same controller. In some embodiments, at least two of a plurality of the operations (e.g., operations (A), (B), (C), (D), (E), and (F)) are performed by different controllers.

In another aspect, a method of adjusting an environment of an enclosure, the method comprises: (a) receiving measurements of the sensed chemical property from the one or more sensors disposed in the environment; (b) comparing the measurements of the sensed chemical property to a requested profile of the chemical property to generate a result, which requested profile is generated by a learning module that is configured to (i) utilize past measurements of the one or more sensors and/or (ii) past preferences of an occupant of the environment; and (c) adjusting the chemical profile of the environment to the requested chemical profile, if the comparison deviates from a threshold.

In some embodiments, the at least one sensor is disposed in one or more device ensembles, and wherein a device ensemble of the device ensembles comprises a sensor and an emitter, or a plurality of sensors. In some embodiments, the device ensemble comprises a memory, or a processor. In some embodiments, the device ensemble is configured for wired and/or wireless communication. In some embodiments, the device ensemble is communicatively coupled to a network that is communicatively coupled to a building management system. In some embodiments, the device ensemble is communicatively coupled to a network that is communicatively coupled to a ventilation system. In some embodiments, the method further comprises expelling at least one chemical into the atmosphere. In some embodiments, the at least one chemical expelled into the atmosphere can be sensed as a smell by an average occupant. In some embodiments, expelling of the at least one chemical into the atmosphere alters the smell of the atmosphere as sensed by an average occupant. In some embodiments, the past preference comprises a past indication of liking or disliking the smell of the environment. In some embodiments, the past preference comprises a past indication of a specific smell profile. In some embodiments, utilizing the past measurements of the one or more sensors comprises a time and/or place of the one or more measurements. In some embodiments, the time comprises a timestamp of the one or more measurements. In some embodiments, the time place utilizes the place at which the occupant is disposed. In some embodiments, the time place utilizes the place at which the one or more sensors are disposed. In some embodiments, the learning module utilizes artificial intelligence, health standards, and/or health recommendations concerning the chemical property. A non-transitory computer readable medium for adjusting an environment of an enclosure, the non-transitory computer readable medium, when read by at least one processor, is configured to direct execution of the operation of any of the afore mentioned methods. In some embodiments, the user provides input related to activity of the user in an enclosure of the facility in which the user is located. In some embodiments, the input related to the user comprises an electronic file. In some embodiments, the input related to the user relates to (e.g., past) preference of the user. In some embodiments, the (e.g., past) preference of the user is provided by a machine learning module that considers past activities of the user, wherein the at least one controller is operatively coupled to the machine learning module.

In another aspect, an apparatus for adjusting an environment of an enclosure, the apparatus comprising one or more controllers comprising circuitry, which one or more controllers are configured to: (a) operatively couple to one or more sensors configured to sense a chemical property of the environment; (b) receive, or direct receipt of, measurements of the sensed chemical property from the one or more sensors disposed in the environment; (c) compare, or direct comparison of, the measurements of the sensed chemical property to a requested profile of the chemical property to generate a result, which requested profile is generated by a learning module that is configured to (i) utilize past measurements of the one or more sensors and/or (ii) past preferences of an occupant of the environment; and (d) adjust, or direct adjustment of, the chemical profile of the environment to the requested chemical profile, if the comparison deviates from a threshold.

In some embodiments, the at least one sensor is disposed in one or more device ensembles, and wherein a device ensemble of the device ensembles comprises a sensor and an emitter, or a plurality of sensors. In some embodiments, the device ensemble comprises a memory, or a processor. In some embodiments, the device ensemble is configured for wired and/or wireless communication. In some embodiments, the device ensemble is communicatively coupled to a network that is communicatively coupled to a building management system. In some embodiments, the device ensemble is communicatively coupled to a network that is communicatively coupled to a ventilation system. In some embodiments, the device ensemble is communicatively coupled to a chemical system configured for expelling at least one chemical into the atmosphere. In some embodiments, the at least one chemical expelled into the atmosphere can be sensed as a smell by an average occupant. In some embodiments, expulsion of the at least one chemical expelled into the atmosphere alters the smell of the atmosphere as sensed by an average occupant. In some embodiments, the past preference comprises a past indication of liking or disliking the smell of the environment. In some embodiments, the past preference comprises a past indication of a specific smell profile. In some embodiments, utilizing the past measurements of the one or more sensors comprises a time and/or place of the one or more measurements. In some embodiments, the time comprises a timestamp of the one or more measurements. In some embodiments, the time place utilizes the place at which the occupant is disposed. In some embodiments, the time place utilizes the place at which the one or more sensors are disposed. In some embodiments, the learning module utilizes artificial intelligence, health standards, and/or health recommendations concerning the chemical property. In some embodiments, the one or more sensors are olfactory sensors. In some embodiments, the one or more sensors constitute an electronic nose. A non-transitory computer readable medium for adjusting an environment of an enclosure, the non-transitory computer readable medium, when read by at least one processor, is configured to execute operations of any of the aforementioned at least one controller. In some embodiments, the controller is configured to receive an input from a user re (e.g., present, and/or past) preference of the user. In some embodiments, the user provides input related to activity of the user in an enclosure of the facility in which the user is located. In some embodiments, the input related to the user comprises an electronic file. In some embodiments, the input related to the user relates to (e.g., past) preference of the user. In some embodiments, the (e.g., past) preference of the user is provided by a machine learning module that considers past activities of the user, wherein the at least one controller is operatively coupled to the machine learning module.

In another aspect, a method of controlling a facility, the method comprises: (a) identifying an identity of a user by a control system; (b) optionally tracking location of the user in the facility by using one or more sensors disposed in the facility, which one or more sensors are communicatively coupled to the control system; (c) using an input related to the user; and (d) using the control system to automatically alter one or more devices in the facility by using the input and location information of the user, which one or more devices are communicatively coupled to the control system.

In some embodiments, the location is a present location of the user or a past location of the user. In some embodiments, identifying the identity of the user comprises receiving an identification card reading, or performing image recognition on a captured image of the user in the facility. In some embodiments, the one or more sensors comprise a camera or a geolocation sensor. In some embodiments, the geolocation sensor comprises an ultrawide bandwidth sensor. In some embodiments, the geolocation sensor can locate the user with a resolution of at least twenty (20) centimeters or a higher resolution. In some embodiments, the input related to the user comprises a service request made by, on behalf of, or for, the user. In some embodiments, the input related to the user relates to activity of the user in an enclosure in which the user is located. In some embodiments, the input related to the user comprises an electronic file. In some embodiments, the input related to the user comprises a gesture and/or voice command made by the user. In some embodiments, the input related to the user relates to preference of the user. In some embodiments, the preference of the user is provided by machine learning that considers past activities of the user. In some embodiments, the preference of the user is input by the user. In some embodiments, the one or more devices comprises a lighting, a ventilation system, and air conditioning system, a heating system, a sound system, or a smell conditioning system. In some embodiments, the one or more devices is configured to affect an atmosphere of an enclosure in which the user is disposed. In some embodiments, the one or more devices comprises a service, office and/or factory apparatus. In some embodiments, the one or more devices are disposed out of an enclosure of the facility in which the user is located. In some embodiments, the one or more devices are disposed in an enclosure of the facility in which the user is located. In some embodiments, the one or more devices comprise a media projecting device. In some embodiments, the one or more devices comprise a tintable window. In some embodiments, the one or more devices comprise an electrochromic window.

In another aspect, a non-transitory computer readable medium for controlling a facility, the non-transitory computer readable medium, when read by one or more processors, is configured to execute operations comprising the any of the above method operations.

In another aspect, an apparatus for controlling a facility, the apparatus comprising at least one controller having circuitry, which at least one controller is configured to: (a) operatively couple to one or more sensors disposed in the facility, and to one or more devices disposed in the facility; (b) identify, or direct identification of, a user; (c) optionally track, or direct tracking of, location of the user in the facility by using the one or more sensors; (d) receive an input related to the user; and (e) automatically alter, or direct automatic alteration of, one or more devices in the facility by using the input and location information of the user.

In some embodiments, at least one controller is configured to utilize location of the user that is a present location of the user or a past location of the user. In some embodiments, the at least one controller is configured to identify, or direct identification of, the user at least in part by (I) receiving an identification card reading, or (II) performing image recognition on a captured image of the user in the facility. In some embodiments, the one or more sensors comprise a camera or a geolocation sensor. In some embodiments, the geolocation sensor comprises an ultrawide bandwidth sensor. In some embodiments, the geolocation sensor can locate the user with a resolution of at least twenty (20) centimeters or higher. In some embodiments, the input related to the user comprises a service request made by, on behalf of, or for, the user. In some embodiments, the input related to the user relates to activity of the user in an enclosure of the facility in which the user is located. In some embodiments, the input related to the user comprises an electronic file. In some embodiments, the input related to the user comprises a gesture and/or voice command made by the user. In some embodiments, the input related to the user relates to preference of the user. In some embodiments, the preference of the user is provided by a machine learning module that considers past activities of the user, wherein the at least one controller is operatively coupled to the machine learning module. In some embodiments, the preference of the user is input by the user. In some embodiments, the one or more devices comprises a lighting, a ventilation system, and air conditioning system, a heating system, a sound system, or a smell conditioning system. In some embodiments, the one or more devices is configured to affect an atmosphere of an enclosure of the facility in which the user is disposed. In some embodiments, the one or more devices comprises a service, office and/or factory apparatus. In some embodiments, the one or more devices are disposed out of an enclosure of the facility in which the user is located. In some embodiments, the one or more devices are disposed in an enclosure of the facility in which the user is located. In some embodiments, the one or more devices comprise a media projecting device. In some embodiments, the one or more devices comprise a tintable window. In some embodiments, the one or more devices comprise an electrochromic window.

In another aspect, a non-transitory computer readable medium for controlling a facility, the non-transitory computer readable medium, when read by one or more processors, is configured to execute operations comprising operations of any of the above one or more controllers.

In some embodiments, the network is a local network. In some embodiments, the network comprises a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. In some embodiments, the communication comprises media communication facilitating stills, music, or moving picture streams (e.g., movies or videos). In some embodiments, the communication comprises data communication (e.g., sensor data). In some embodiments, the communication comprises control communication, e.g., to control the one or more nodes operatively coupled to the networks. In some embodiments, the network comprises a first (e.g., cabling) network installed in the facility. In some embodiments, the network comprises a (e.g., cabling) network installed in an envelope of the facility (e.g., in an envelope of a building included in the facility).

In another aspect, the present disclosure provides systems, apparatuses (e.g., controllers), and/or non-transitory computer-readable medium or media (e.g., software) that implement any of the methods disclosed herein.

In another aspect, the present disclosure provides methods that use any of the systems, computer readable media, and/or apparatuses disclosed herein, e.g., for their intended purpose.

In another aspect, an apparatus comprises at least one controller that is programmed to direct a mechanism used to implement (e.g., effectuate) any of the method disclosed herein, which at least one controller is configured to operatively couple to the mechanism. In some embodiments, at least two operations (e.g., of the method) are directed/executed by the same controller. In some embodiments, at less at two operations are directed/executed by different controllers.

In another aspect, an apparatus comprises at least one controller that is configured (e.g., programmed) to implement (e.g., effectuate) any of the methods disclosed herein. The at least one controller may implement any of the methods disclosed herein. In some embodiments, at least two operations (e.g., of the method) are directed/executed by the same controller. In some embodiments, at less at two operations are directed/executed by different controllers.

In some embodiments, one controller of the at least one controller is configured to perform two or more operations. In some embodiments, two different controllers of the at least one controller are configured to each perform a different operation.

In another aspect, a system comprises at least one controller that is programmed to direct operation of at least one another apparatus (or component thereof), and the apparatus (or component thereof), wherein the at least one controller is operatively coupled to the apparatus (or to the component thereof). The apparatus (or component thereof) may include any apparatus (or component thereof) disclosed herein. The at least one controller may be configured to direct any apparatus (or component thereof) disclosed herein. The at least one controller may be configured to operatively couple to any apparatus (or component thereof) disclosed herein. In some embodiments, at least two operations (e.g., of the apparatus) are directed by the same controller. In some embodiments, at less at two operations are directed by different controllers.

In another aspect, a computer software product (e.g., inscribed on one or more non-transitory medium) in which program instructions are stored, which instructions, when read by at least one processor (e.g., computer), cause the at least one processor to direct a mechanism disclosed herein to implement (e.g., effectuate) any of the method disclosed herein, wherein the at least one processor is configured to operatively couple to the mechanism. The mechanism can comprise any apparatus (or any component thereof) disclosed herein. In some embodiments, at least two operations (e.g., of the apparatus) are directed/executed by the same processor. In some embodiments, at less at two operations are directed/executed by different processors.

In another aspect, the present disclosure provides a non-transitory computer-readable program instructions (e.g., included in a program product comprising one or more non-transitory medium) comprising machine-executable code that, upon execution by one or more processors, implements any of the methods disclosed herein. In some embodiments, at least two operations (e.g., of the method) are directed/executed by the same processor. In some embodiments, at less at two operations are directed/executed by different processors.

In another aspect, the present disclosure provides a non-transitory computer-readable medium or media comprising machine-executable code that, upon execution by one or more processors, effectuates directions of the controller(s) (e.g., as disclosed herein). In some embodiments, at least two operations (e.g., of the controller) are directed/executed by the same processor. In some embodiments, at less at two operations are directed/executed by different processors.

In another aspect, the present disclosure provides a computer system comprising one or more computer processors and a non-transitory computer-readable medium or media coupled thereto. The non-transitory computer-readable medium comprises machine-executable code that, upon execution by the one or more processors, implements any of the methods disclosed herein and/or effectuates directions of the controller(s) disclosed herein.

In another aspect, the present disclosure provides a non-transitory computer readable program instructions that, when read by one or more processors, causes the one or more processors to execute any operation of the methods disclosed herein, any operation performed (or configured to be performed) by the apparatuses disclosed herein, and/or any operation directed (or configured to be directed) by the apparatuses disclosed herein.

In some embodiments, the program instructions are inscribed in a non-transitory computer readable medium or media. In some embodiments, at least two of the operations are executed by one of the one or more processors. In some embodiments, at least two of the operations are each executed by different processors of the one or more processors.

In another aspect, the present disclosure provides networks that are configured for transmission of any communication (e.g., signal) and/or (e.g., electrical) power facilitating any of the operations disclosed herein. The communication may comprise control communication, cellular communication, media communication, and/or data communication. The data communication may comprise sensor data communication and/or processed data communication. The networks may be configured to abide by one or more protocols facilitating such communication. For example, a communications protocol used by the network (e.g., with a BMS) can be a building automation and control networks protocol (BACnet). For example, a communication protocol may facilitate cellular communication abiding by at least a 2nd, 3rd, 4th, or 5th generation cellular communication protocol.

The content of this summary section is provided as a simplified introduction to the disclosure and is not intended to be used to limit the scope of any invention disclosed herein or the scope of the appended claims.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

These and other features and embodiments will be described in more detail with reference to the drawings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.” and “Figs.” herein), of which:

FIG. 1 schematically shows an electrochromic device;

FIG. 2 schematically shows a cross section of an Integrated Glass Unit (IGU);

FIG. 3 shows a schematic example of sensor arrangement;

FIG. 4 shows a schematic example of sensor arrangement and sensor data;

FIGS. 5A-5E show time dependent graphs;

FIG. 6 depicts a time dependent graph of carbon dioxide concentrations;

FIG. 7 shows a topographical map of measured property values;

FIG. 8 shows a perspective view of an enclosure having a control system;

FIG. 9 shows a schematic example of an enclosure with a ventilation system;

FIGS. 10A-10B shows graphs relating to various aspects of enclosure atmosphere as a function of occupancy;

FIG. 11 shows an apparatus and its components for controlling ventilation;

FIG. 12 shows a schematic flow chart;

FIG. 13 shows a schematic flow chart;

FIG. 14 shows a schematic flow chart;

FIG. 15 shows a schematic flow chart;

FIG. 16 shows an apparatus and its components and connectivity options;

FIG. 17 a schematic example of sensor arrangement and sensor data;

FIG. 18 a schematic example of sensor arrangement and sensor data;

FIG. 19 shows a control system and its various components;

FIG. 20 schematically depicts a controller;

FIG. 21 schematically depicts a processing system;

FIG. 22 shows a schematic flow chart;

FIG. 23 shows a flow chart for a control method; and

FIG. 24 shows various graphs including sensor data as a function of time.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an,” and “the” are not intended to refer to only a singular entity but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.”

As used herein, including in the claims, the conjunction “and/or” in a phrase such as “including X, Y, and/or Z”, refers to in inclusion of any combination or plurality of X, Y, and Z. For example, such phrase is meant to include X. For example, such phrase is meant to include Y. For example, such phrase is meant to include Z. For example, such phrase is meant to include X and Y. For example, such phrase is meant to include X and Z. For example, such phrase is meant to include Y and Z. For example, such phrase is meant to include a plurality of Xs. For example, such phrase is meant to include a plurality of Ys. For example, such phrase is meant to include a plurality of Zs. For example, such phrase is meant to include a plurality of Xs and a plurality of Ys. For example, such phrase is meant to include a plurality of Xs and a plurality of Zs. For example, such phrase is meant to include a plurality of Ys and a plurality of Zs. For example, such phrase is meant to include a plurality of Xs and Y. For example, such phrase is meant to include a plurality of Xs and Z. For example, such phrase is meant to include a plurality of Ys and Z. For example, such phrase is meant to include X and a plurality of Ys. For example, such phrase is meant to include X and a plurality of Zs. For example, such phrase is meant to include Y and a plurality of Zs. The conjunction “and/or” is meant to have the same effect as the phrase “X, Y, Z, or any combination or plurality thereof.” The conjunction “and/or” is meant to have the same effect as the phrase “one or more X, Y, Z, or any combination thereof.”

The term “operatively coupled” or “operatively connected” refers to a first element (e.g., mechanism) that is coupled (e.g., connected) to a second element, to allow the intended operation of the second and/or first element. The coupling may comprise physical or non-physical coupling (e.g., communicative coupling). The non-physical coupling may comprise signal-induced coupling (e.g., wireless coupling). Coupled can include physical coupling (e.g., physically connected), or non-physical coupling (e.g., via wireless communication). Operatively coupled may comprise communicatively coupled.

An element (e.g., mechanism) that is “configured to” perform a function includes a structural feature that causes the element to perform this function. A structural feature may include an electrical feature, such as a circuitry or a circuit element. A structural feature may include an actuator. A structural feature may include a circuitry (e.g., comprising electrical or optical circuitry). Electrical circuitry may comprise one or more wires. Optical circuitry may comprise at least one optical element (e.g., beam splitter, mirror, lens and/or optical fiber). A structural feature may include a mechanical feature. A mechanical feature may comprise a latch, a spring, a closure, a hinge, a chassis, a support, a fastener, or a cantilever, and so forth. Performing the function may comprise utilizing a logical feature. A logical feature may include programming instructions. Programming instructions may be executable by at least one processor. Programming instructions may be stored or encoded on a medium accessible by one or more processors. Additionally, in the following description, the phrases “operable to,” “adapted to,” “configured to,” “designed to,” “programmed to,” or “capable of” may be used interchangeably where appropriate.

In some embodiments, an enclosure comprises an area defined by at least one structure. The at least one structure may comprise at least one wall. An enclosure may comprise and/or enclose one or more sub-enclosure. The at least one wall may comprise metal (e.g., steel), clay, stone, plastic, glass, plaster (e.g., gypsum), polymer (e.g., polyurethane, styrene, or vinyl), asbestos, fiber-glass, concrete (e.g., reinforced concrete), wood, paper, or a ceramic. The at least one wall may comprise wire, bricks, blocks (e.g., cinder blocks), tile, drywall, or frame (e.g., steel frame).

In some embodiments, the enclosure comprises one or more openings. The one or more openings may be reversibly closable. The one or more openings may be permanently open. A fundamental length scale of the one or more openings may be smaller relative to the fundamental length scale of the wall(s) that define the enclosure. A fundamental length scale may comprise a diameter of a bounding circle, a length, a width, or a height. A surface of the one or more openings may be smaller relative to the surface the wall(s) that define the enclosure. The opening surface may be a percentage of the total surface of the wall(s). For example, the opening surface can measure at most about 30%, 20%, 10%, 5%, or 1% of the walls(s). The wall(s) may comprise a floor, a ceiling, or a side wall. The closable opening may be closed by at least one window or door. The enclosure may be at least a portion of a facility. The facility may comprise a building. The enclosure may comprise at least a portion of a building. The building may be a private building and/or a commercial building. The building may comprise one or more floors. The building (e.g., floor thereof) may include at least one of: a room, hall, foyer, attic, basement, balcony (e.g., inner or outer balcony), stairwell, corridor, elevator shaft, façade, mezzanine, penthouse, garage, porch (e.g., enclosed porch), terrace (e.g., enclosed terrace), cafeteria, and/or Duct. In some embodiments, an enclosure may be stationary and/or movable (e.g., a train, an airplane, a ship, a vehicle, or a rocket).

In some embodiments, the enclosure encloses an atmosphere. The atmosphere may comprise one or more gases. The gases may include inert gases (e.g., comprising argon or nitrogen) and/or non-inert gases (e.g., comprising oxygen or carbon dioxide). The enclosure atmosphere may resemble an atmosphere external to the enclosure (e.g., ambient atmosphere) in at least one external atmosphere characteristic that includes: temperature, relative gas content, gas type (e.g., humidity, and/or oxygen level), debris (e.g., dust and/or pollen), and/or gas velocity. The enclosure atmosphere may be different from the atmosphere external to the enclosure in at least one external atmosphere characteristic that includes: temperature, relative gas content, gas type (e.g., humidity, and/or oxygen level), debris (e.g., dust and/or pollen), and/or gas velocity. For example, the enclosure atmosphere may be less humid (e.g., drier) than the external (e.g., ambient) atmosphere. For example, the enclosure atmosphere may contain the same (e.g., or a substantially similar) oxygen-to-nitrogen ratio as the atmosphere external to the enclosure. The velocity of the gas in the enclosure may be (e.g., substantially) similar throughout the enclosure. The velocity of the gas in the enclosure may be different in different portions of the enclosure (e.g., by flowing gas through to a vent that is coupled with the enclosure).

Certain disclosed embodiments provide a network infrastructure in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, transmitter, receiver, radio, processor and/or controller (that may comprise a processor). The network infrastructure may be operatively coupled to, and/or include, a wireless network. The network infrastructure may comprise wiring. One or more sensors can be deployed (e.g., installed) in an environment as part of installing the network and/or after installing the network. The network may be a local network. The network may comprise a cable configured to transmit power and communication in a single cable. The communication can be one or more types of communication. The communication can comprise cellular communication abiding by at least a second generation (2G), third generation (3G), fourth generation (4G) or fifth generation (5G) cellular communication protocol. The communication may comprise media communication facilitating stills, music, or moving picture streams (e.g., movies or videos). The communication may comprise data communication (e.g., sensor data). The communication may comprise control communication, e.g., to control the one or more nodes operatively coupled to the networks. The network may comprise a first (e.g., cabling) network installed in the facility. The network may comprise a (e.g., cabling) network installed in an envelope of the facility (e.g., such as in an envelope of an enclosure of the facility. For example, in an envelope of a building included in the facility).

In another aspect, the present disclosure provides networks that are configured for transmission of any communication (e.g., signal) and/or (e.g., electrical) power facilitating any of the operations disclosed herein. The communication may comprise control communication, cellular communication, media communication, and/or data communication. The data communication may comprise sensor data communication and/or processed data communication. The networks may be configured to abide by one or more protocols facilitating such communication. For example, a communications protocol used by the network (e.g., with a BMS) can comprise a building automation and control networks protocol (BACnet). The network may be configured for (e.g., include hardware facilitating) communication protocols comprising BACnet (e.g., BACnet/SC), LonWorks, Modbus, KNX, European Home Systems Protocol (EHS), BatiBUS, European Installation Bus (EIB or Instabus), zigbee, Z-wave, Insteon, X10, Bluetooth, or WiFi. The network may be configure to transmit the control related protocol. A communication protocol may facilitate cellular communication abiding by at least a 2^{nd}, 3^{rd}, 4^{th}, or 5^{th} generation cellular communication protocol. The (e.g., cabling) network may comprise a tree, line, or star topologies. The network may comprise interworking and/or distributed application models for various tasks of the building automation. The control system may provide schemes for configuration and/or management of resources on the network. The network may permit binding of parts of a distributed application in different nodes operatively coupled to the network. The network may provide a communication system with a message protocol and models for the communication stack in each node (capable of hosting distributed applications (e.g., having a common Kernel). The control system may comprise programmable logic controller(s) (PLC(s)).

In various embodiments, a network infrastructure supports a control system for one or more windows such as tintable (e.g., electrochromic) windows. The control system may comprise one or more controllers operatively coupled (e.g., directly or indirectly) to one or more windows. While the disclosed embodiments describe tintable windows (also referred to herein as “optically switchable windows,” or “smart windows”) such as electrochromic windows, the concepts disclosed herein may apply to other types of switchable optical devices comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). The tintable window may be disposed in a (non-transitory) facility such as a building, and/or in a transitory facility (e.g., vehicle) such as a car, RV, bus, train, airplane, helicopter, ship, or boat.

In some embodiments, a tintable window exhibits a (e.g., controllable and/or reversible) change in at least one optical property of the window, e.g., when a stimulus is applied. The change may be a continuous change. A change may be to discrete tint levels (e.g., to at least about 2, 4, 8, 16, or 32 tint levels). The optical property may comprise hue, or transmissivity. The hue may comprise color. The transmissivity may be of one or more wavelengths. The wavelengths may comprise ultraviolet, visible, or infrared wavelengths. The stimulus can include an optical, electrical and/or magnetic stimulus. For example, the stimulus can include an applied voltage and/or current. One or more tintable windows can be used to control lighting and/or glare conditions, e.g., by regulating the transmission of solar energy propagating through them. One or more tintable windows can be used to control a temperature within a building, e.g., by regulating the transmission of solar energy propagating through the window. Control of the solar energy may control heat load imposed on the interior of the facility (e.g., building). The control may be manual and/or automatic. The control may be used for maintaining one or more requested (e.g., environmental) conditions, e.g., occupant comfort. The control may include reducing energy consumption of a heating, ventilation, air conditioning and/or lighting systems. At least two of heating, ventilation, and air conditioning may be induced by separate systems. At least two of heating, ventilation, and air conditioning may be induced by one system. The heating, ventilation, and air conditioning may be induced by a single system (abbreviated herein as “HVAC”). In some cases, tintable windows may be responsive to (e.g., and communicatively coupled to) one or more environmental sensors and/or user control. Tintable windows may comprise (e.g., may be) electrochromic windows. The windows may be located in the range from the interior to the exterior of a structure (e.g., facility, e.g., building). However, this need not be the case. Tintable windows may operate using liquid crystal devices, suspended particle devices, microelectromechanical systems (MEMS) devices (such as microshutters), or any technology known now, or later developed, that is configured to control light transmission through a window. Windows (e.g., with MEMS devices for tinting) are described in U.S. Pat. No. 10,359,681, issued Jul. 23, 2019, filed May 15, 2015, titled “MULTI-PANE WINDOWS INCLUDING ELECTROCHROMIC DEVICES AND ELECTROMECHANICAL SYSTEMS DEVICES,” and incorporated herein by reference in its entirety. In some cases, one or more tintable windows can be located within the interior of a building, e.g., between a conference room and a hallway. In some cases, one or more tintable windows can be used in automobiles, trains, aircraft, and other vehicles, e.g., in lieu of a passive and/or non-tinting window.

In some embodiments, the tintable window comprises an electrochromic device (referred to herein as an “EC device” (abbreviated herein as ECD), or “EC”). An EC device may comprise at least one coating that includes at least one layer. The at least one layer can comprise an electrochromic material. In some embodiments, the electrochromic material exhibits a change from one optical state to another, e.g., when an electric potential is applied across the EC device. The transition of the electrochromic layer from one optical state to another optical state can be caused, e.g., by reversible, semi-reversible, or irreversible ion insertion into the electrochromic material (e.g., by way of intercalation) and a corresponding injection of charge-balancing electrons. For example, the transition of the electrochromic layer from one optical state to another optical state can be caused, e.g., by a reversible ion insertion into the electrochromic material (e.g., by way of intercalation) and a corresponding injection of charge-balancing electrons. Reversible may be for the expected lifetime of the ECD. Semi-reversible refers to a measurable (e.g. noticeable) degradation in the reversibility of the tint of the window over one or more tinting cycles. In some instances, a fraction of the ions responsible for the optical transition is irreversibly bound up in the electrochromic material (e.g., and thus the induced (altered) tint state of the window is not reversible to its original tinting state). In various EC devices, at least some (e.g., all) of the irreversibly bound ions can be used to compensate for “blind charge” in the material (e.g., ECD).

In some implementations, suitable ions include cations. The cations may include lithium ions (Li+) and/or hydrogen ions (H+) (i.e., protons). In some implementations, other ions can be suitable. Intercalation of the cations may be into an (e.g., metal) oxide. A change in the intercalation state of the ions (e.g. cations) into the oxide may induce a visible change in a tint (e.g., color) of the oxide. For example, the oxide may transition from a colorless to a colored state. For example, intercalation of lithium ions into tungsten oxide (WO3−y (0<y≤˜0.3)) may cause the tungsten oxide to change from a transparent state to a colored (e.g., blue) state. EC device coatings as described herein are located within the viewable portion of the tintable window such that the tinting of the EC device coating can be used to control the optical state of the tintable window.

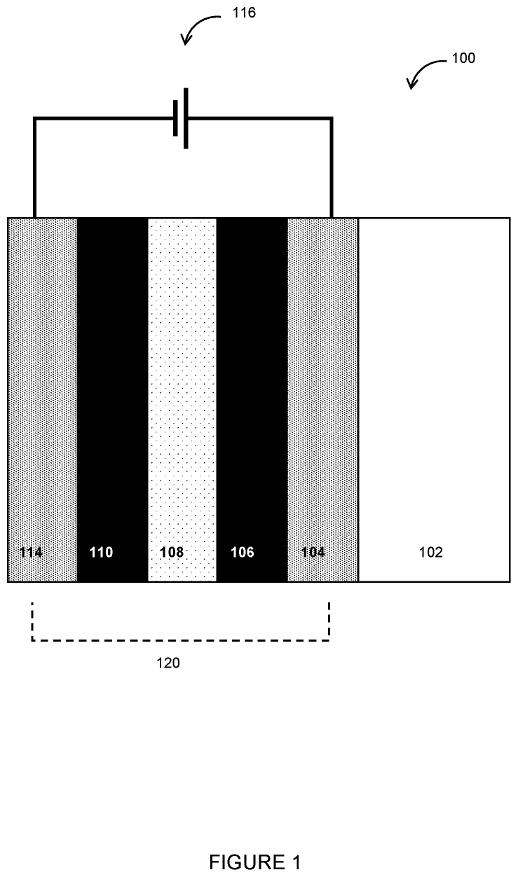

FIG. 1 shows an example of a schematic cross-section of an electrochromic device 100 in accordance with some embodiments is shown in FIG. 1. The EC device coating is attached to a substrate 102, a transparent conductive layer (TCL) 104, an electrochromic layer (EC) 106 (sometimes also referred to as a cathodically coloring layer or a cathodically tinting layer), an ion conducting layer or region (IC) 108, a counter electrode layer (CE) 110 (sometimes also referred to as an anodically coloring layer or anodically tinting layer), and a second TCL 114.

Elements 104, 106, 108, 110, and 114 are collectively referred to as an electrochromic stack 120. A voltage source 116 operable to apply an electric potential across the electrochromic stack 120 effects the transition of the electrochromic coating from, e.g., a clear state to a tinted state. In other embodiments, the order of layers is reversed with respect to the substrate. That is, the layers are in the following order: substrate, TCL, counter electrode layer, ion conducting layer, electrochromic material layer, TCL.

In various embodiments, the ion conductor region (e.g., 108) may form from a portion of the EC layer (e.g., 106) and/or from a portion of the CE layer (e.g., 110). In such embodiments, the electrochromic stack (e.g., 120) may be deposited to include cathodically coloring electrochromic material (the EC layer) in direct physical contact with an anodically coloring counter electrode material (the CE layer). The ion conductor region (sometimes referred to as an interfacial region, or as an ion conducting substantially electronically insulating layer or region) may form where the EC layer and the CE layer meet, for example through heating and/or other processing steps. Examples of electrochromic devices (e.g., including those fabricated without depositing a distinct ion conductor material) can be found in U.S. patent application Ser. No. 13/462,725, filed May 2, 2012, titled “ELECTROCHROMIC DEVICES,” that is incorporated herein by reference in its entirety. In some embodiments, an EC device coating may include one or more additional layers such as one or more passive layers. Passive layers can be used to improve certain optical properties, to provide moisture, and/or to provide scratch resistance. These and/or other passive layers can serve to hermetically seal the EC stack 120. Various layers, including transparent conducting layers (such as 104 and 114), can be treated with anti-reflective and/or protective layers (e.g., oxide and/or nitride layers).

In certain embodiments, the electrochromic device is configured to (e.g., substantially) reversibly cycle between a clear state and a tinted state. Reversible may be within an expected lifetime of the ECD. The expected lifetime can be at least about 5, 10, 15, 25, 50, 75, or 100 years. The expected lifetime can be any value between the aforementioned values (e.g., from about 5 years to about 100 years, from about 5 years to about 50 years, or from about 50 years to about 100 years). A potential can be applied to the electrochromic stack (e.g., 120) such that available ions in the stack that can cause the electrochromic material (e.g., 106) to be in the tinted state reside primarily in the counter electrode (e.g., 110) when the window is in a first tint state (e.g., clear). When the potential applied to the electrochromic stack is reversed, the ions can be transported across the ion conducting layer (e.g., 108) to the electrochromic material and cause the material to enter the second tint state (e.g., tinted state).

It should be understood that the reference to a transition between a clear state and tinted state is non-limiting and suggests only one example, among many, of an electrochromic transition that may be implemented. Unless otherwise specified herein, whenever reference is made to a clear-tinted transition, the corresponding device or process encompasses other optical state transitions such as non-reflective-reflective, and/or transparent-opaque. In some embodiments, the terms “clear” and “bleached” refer to an optically neutral state, e.g., untinted, transparent and/or translucent. In some embodiments, the “color” or “tint” of an electrochromic transition is not limited to any wavelength or range of wavelengths. The choice of appropriate electrochromic material and counter electrode materials may govern the relevant optical transition (e.g., from tinted to untinted state).

In certain embodiments, at least a portion (e.g., all of) the materials making up electrochromic stack are inorganic, solid (i.e., in the solid state), or both inorganic and solid. Because various organic materials tend to degrade over time, particularly when exposed to heat and UV light as tinted building windows are, inorganic materials offer an advantage of a reliable electrochromic stack that can function for extended periods of time. In some embodiments, materials in the solid state can offer the advantage of being minimally contaminated and minimizing leakage issues, as materials in the liquid state sometimes do. One or more of the layers in the stack may contain some amount of organic material (e.g., that is measurable). The ECD or any portion thereof (e.g., one or more of the layers) may contain little or no measurable organic matter. The ECD or any portion thereof (e.g., one or more of the layers) may contain one or more liquids that may be present in little amounts. Little may be of at most about 100 ppm, 10 ppm, or 1 ppm of the ECD. Solid state material may be deposited (or otherwise formed) using one or more processes employing liquid components, such as certain processes employing sol-gels, physical vapor deposition, and/or chemical vapor deposition.

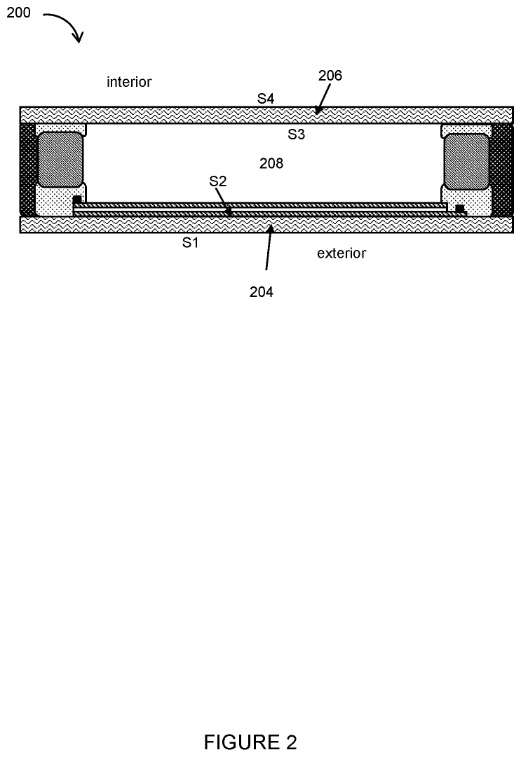

FIG. 2 show an example of a cross-sectional view of a tintable window embodied in an insulated glass unit (“IGU”) 200, in accordance with some implementations. The terms “IGU,” “tintable window,” and “optically switchable window” can be used interchangeably herein. It can be desirable to have IGUs serve as the fundamental constructs for holding electrochromic panes (also referred to herein as “lites”) when provided for installation in a building. An IGU lite may be a single substrate or a multi-substrate construct. The lite may comprise a laminate, e.g., of two substrates. IGUs (e.g., having double- or triple-pane configurations) can provide a number of advantages over single pane configurations. For example, multi-pane configurations can provide enhanced thermal insulation, noise insulation, environmental protection and/or durability, when compared with single-pane configurations. A multi-pane configuration can provide increased protection for an ECD. For example, the electrochromic films (e.g., as well as associated layers and conductive interconnects) can be formed on an interior surface of the multi-pane IGU and be protected by an inert gas fill in the interior volume (e.g., 208) of the IGU. The inert gas fill may provide at least some (heat) insulating function for an IGU. Electrochromic IGUs may have heat blocking capability, e.g., by virtue of a tintable coating that absorbs (and/or reflects) heat and light.

In some embodiments, an “IGU” includes two (or more) substantially transparent substrates. For example, the IGU may include two panes of glass. At least one substrate of the IGU can include an electrochromic device disposed thereon. The one or more panes of the IGU may have a separator disposed between them. An IGU can be a hermetically sealed construct, e.g., having an interior region that is isolated from the ambient environment. A “window assembly” may include an IGU. A “window assembly” may include a (e.g., stand-alone) laminate. A “window assembly” may include one or more electrical leads, e.g., for connecting the IGUs and/or laminates. The electrical leads may operatively couple (e.g. connect) one or more electrochromic devices to a voltage source, switches and the like, and may include a frame that supports the IGU or laminate. A window assembly may include a window controller, and/or components of a window controller (e.g., a dock).

FIG. 2 shows an example implementation of an IGU 200 that includes a first pane 204 having a first surface S1 and a second surface S2. In some implementations, the first surface S1 of the first pane 204 faces an exterior environment, such as an outdoors or outside environment. The IGU 200 also includes a second pane 206 having a first surface S3 and a second surface S4. In some implementations, the second surface (e.g., S4) of the second pane (e.g., 206) faces an interior environment, such as an inside environment of a home, building, vehicle, or compartment thereof (e.g., an enclosure therein such as a room).

In some implementations, the first and the second panes (e.g., 204 and 206) are transparent or translucent, e.g., at least to light in the visible spectrum. For example, each of the panes (e.g., 204 and 206) can be formed of a glass material. The glass material may include architectural glass, and/or shatter-resistant glass. The glass may comprise a silicon oxide (SOₓ). The glass may comprise a soda-lime glass or float glass. The glass may comprise at least about 75% silica (SiO₂). The glass may comprise oxides such as Na₂O, or CaO. The glass may comprise alkali or alkali-earth oxides. The glass may comprise one or more additives. The first and/or the second panes can include any material having suitable optical, electrical, thermal, and/or mechanical properties. Other materials (e.g., substrates) that can be included in the first and/or the second panes are plastic, semi-plastic and/or thermoplastic materials, for example, poly(methyl methacrylate), polystyrene, polycarbonate, allyl diglycol carbonate, SAN (styrene acrylonitrile copolymer), poly(4-methyl-1-pentene), polyester, and/or polyamide. The first and/or second pane may include mirror material (e.g., silver). In some implementations, the first and/or the second panes can be strengthened. The strengthening may include tempering, heating, and/or chemically strengthening.

In some embodiments, an enclosure includes one or more sensors. The sensor may facilitate controlling the environment of the enclosure such that inhabitants of the enclosure may have an environment that is more comfortable, delightful, beautiful, healthy, productive (e.g., in terms of inhabitant performance), easer to live (e.g., work) in, or any combination thereof. The sensor(s) may be configured as low or high resolution sensors. Sensor may provide on/off indications of the occurrence and/or presence of a particular environmental event (e.g., one pixel sensors). In some embodiments, the accuracy and/or resolution of a sensor may be improved via artificial intelligence analysis of its measurements. Examples of artificial intelligence techniques that may be used include: reactive, limited memory, theory of mind, and/or self-aware techniques know to those skilled in the art). Sensors may be configured to process, measure, analyze, detect and/or react to one or more of: data, temperature, humidity, sound, force, pressure, electromagnetic waves, position, distance, movement, flow, acceleration, speed, vibration, dust, light, glare, color, gas(es), and/or other aspects (e.g., characteristics) of an environment (e.g., of an enclosure). The gases may include volatile organic compounds (VOCs). The gases may include carbon monoxide, carbon dioxide, water vapor (e.g., humidity), oxygen, radon, and/or hydrogen sulfide. The one or more sensors may be calibrated in a factory setting. A sensor may be optimized to be capable of performing accurate measurements of one or more environmental characteristics present in the factory setting. In some instances, a factory calibrated sensor may be less optimized for operation in a target environment. For example, a factory setting may comprise a different environment than a target environment. The target environment can be an environment in which the sensor is deployed. The target environment can be an environment in which the sensor is expected and/or destined to operate. The target environment may differ from a factory environment. A factory environment corresponds to a location at which the sensor was assembled and/or built. The target environment may comprise a factory in which the sensor was not assembled and/or built. In some instances, the factory setting may differ from the target environment to the extent that sensor readings captured in the target environment are erroneous (e.g., to a measurable extent). In this context, “erroneous” may refer to sensor readings that deviate from a specified accuracy (e.g., specified by a manufacture of the sensor). In some situations, a factory-calibrated sensor may provide readings that do not meet accuracy specifications (e.g., by a manufacturer) when operated in the target environments.

In certain embodiments, one or more shortcomings in sensor operation may be at least partially corrected and/or alleviated by allowing a sensor to be self-calibrated in its target environment (e.g., where the sensor is installed). In some instances, a sensor may be calibrated and/or recalibrated after installation in the target environment. In some instances, a sensor may be calibrated and/or recalibrated after a certain period of operation in the target environment. The target environment may be the location at which the sensor is installed in an enclosure. In comparison to a sensor that is calibrated prior to installation, in a sensor calibrated and/or recalibrated after installation in the target environment may provide measurements having increased accuracy (e.g., that is measurable). In certain embodiments, one or more previously-installed sensors in an enclosure provide readings that are used to calibrated and/or recalibrate a newly-installed sensor in the enclosure. A calibrated and/or localized component may be utilized as a standard for calibrating and/or localizing other components. Such component may be referred to as the “golden component.” The golden component be utilized as a reference component. Such component may be the one most calibrated and/or accurately localized in the facility. The component (e.g., sensor, emitter, or transceiver) may be calibrated and/or localized via a traveler. The traveler may be human or non-human (e.g., robotic). The traveler may be a field service engineer. The traveler may comprise a mobile robot such as a drone, a wheeled robot, or any other maneuverable robot. Examples of components (e.g., devices), control, calibration, and travelers can be found in International Patent Application Serial No. PCT/US21/15378 that is incorporated herein by reference in its entirety.

In some embodiments, a target environment corresponding to a first enclosure differs from a target environment corresponding to a second enclosure. For example, a target environment of an enclosure that corresponds to a cafeteria or to an auditorium may present sensor readings different than a target enclosure that corresponds to a conference room. A sensor may consider the target environment (e.g., one or more characteristics thereof) when performing sensor readings and/or outputting sensor data. For example, during lunchtime a carbon dioxide sensor installed in an occupied cafeteria may provide higher readings than a sensor installed in an empty conference room. In another example, ambient noise sensor located in an occupied cafeteria during lunch may provide higher readings than an ambient noise sensor located in a library.

In some embodiments, a sensor (e.g., occasionally) provides an output signal indicating an erroneous measurement. The sensor may be operatively coupled to at least one controller. The controller(s) may obtain erroneous sensor reading from the sensor. The controller(s) may obtain readings of the same type, at a similar time (e.g., or simultaneously), from one or more other (e.g., nearby) sensors. The one or more other sensors may be disposed at the same environment as the one sensor. The controller(s) may evaluate the erroneous sensor reading in conjunction with one or more readings of the same type made by one or more other sensors of the same type to identify the erroneous sensor reading as an outlier. For example, the controller may evaluate an erroneous temperature sensor reading and one or more readings of temperature made by one or more other temperature sensors. The controller(s) may determine that the sensor reading is erroneous in response to consideration (e.g., including evaluating and/or comparing with) the sensor reading with one or more readings from other sensors in the same environment (e.g., in the same enclosure). Controller(s) may direct the one sensor providing the erroneous reading to undergo recalibration (e.g., by undergoing a recalibration procedure). For example, the controller(s) may transmit one or more values and/or parameters to the sensor(s) providing the erroneous reading. The sensor(s) providing the erroneous reading may utilize the transmitted value and/or parameter to adjust its subsequent sensor reading(s). For example, the sensor(s) providing the erroneous reading may utilize the transmitted value and/or parameter to adjust its baseline for subsequent sensor reading(s). The baseline can be a value, a set of values, or a function.

In some embodiments, a sensor has an operational lifespan. An operational lifespan of a sensor may be related to one or more readings taken by the sensor. Sensor readings from certain sensors may be more valuable and/or varied during certain time periods and may be less valuable and/or varied during other time periods. For example, movement sensor readings may be more varied during the day than during the night. The operational lifespan of the sensor may be extended. Extension of the operational lifespan may be accomplished by permitting the sensor to reduce sampling of environmental parameters at certain time periods (e.g., having the lower beneficial value). Certain sensors may modify (e.g., increase or decrease) a frequency at which sensor readings are sampled. Timing and/or frequency of the sensor operation may depend on the sensor type, location in the (e.g., target) environment, and/or time of day. A sensor type may require constant and/or more frequent operation during the day (e.g., CO₂, volatile organic compounds (VOCs), occupancy, and/or lighting sensor). Volatile organic compounds may be animal and/or human derived. VOCs may comprise a compound related to human produced odor. A sensor may require infrequent operation during at least a portion of the night. A sensor type may require infrequent operation during at least a portion of the day (e.g., temperature and/or pressure sensor). A sensor may be assigned a timing and/or frequency of operation. The assignment may be controlled (e.g., altered) manually and/or automatically (e.g., using at least one controller operatively coupled to the sensor). Operatively coupled may include communicatively coupled, electrically coupled, optically coupled, or any combination thereof. Modification of the timing and/or frequency at which sensor readings are taken may be responsive to detection of an event by a sensor of the same type or of a sensor of a different type. Modification of the timing and/or frequency at which sensor readings may utilize sensor data analysis. The sensor data analysis may utilize artificial intelligence (abbreviated herein as “AI”). The control may be fully automatic or partially automatic. The partially automatic control may allow a user to (i) override a direction of the controller, and/or (ii) indicate any preference (e.g., of the user).

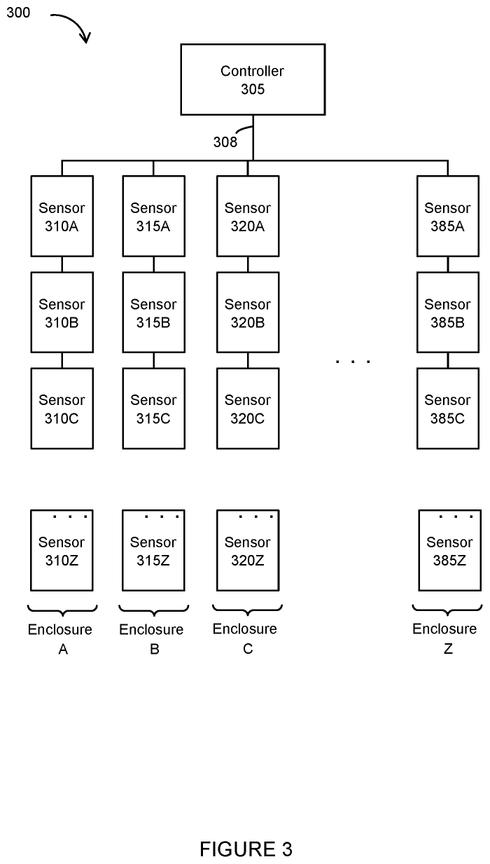

In some embodiments, processing sensor data comprises performing sensor data analysis. The sensor data analysis may comprise at least one rational decision making process, and/or learning. The sensor data analysis may be utilized to adjust the environment, e.g., by adjusting one or more components that affect the environment of the enclosure. The data analysis may be performed by a machine based system (e.g., a circuitry). The circuitry may be of a processor. The sensor data analysis may utilize artificial intelligence. The sensor data analysis may rely on one or more models (e.g., mathematical models). In some embodiments, the sensor data analysis comprises linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition, fuzzy measure theory, Borel measure, Han measure, risk-neutral measure, Lebesgue measure, group method of data handling (GMDH), Naive Bayes classifiers, k-nearest neighbors algorithm (k-NN), support vector machines (SVMs), neural networks, support vector machines, classification and regression trees (CART), random forest, gradient boosting, or generalized linear model (GLM) technique. FIG. 3 shows an example of a diagram 300 of an arrangement of sensors distributed among enclosures. In the example shown in FIG. 3, controller 305 is communicatively linked 308 with sensors located in enclosure A (sensors 310A, 310B, 310C, . . . 310Z), enclosure B (sensors 315A, 315B, 315C, 315Z), enclosure C (sensors 320A, 320B, 320C, . . . 320Z), and enclosure Z (sensors 385A, 385B, 385C, . . . 385Z). Communicatively linked comprises wired and/or wireless communication. In some embodiments, a sensor ensemble includes at least two sensors of a differing types. In some embodiments, a sensor ensemble includes at least two sensors of the same type. In the example shown in FIG. 3, sensors 310A, 310B, 310C, . . . 310Z of enclosure A represent an ensemble. An ensemble of sensors can refer to a collection of diverse sensors. In some embodiments, at least two of the sensors in the ensemble cooperate to determine environmental parameters, e.g., of an enclosure in which they are disposed. For example, a sensor ensemble may include a carbon dioxide sensor, a carbon monoxide sensor, a volatile organic chemical sensor, an ambient noise sensor, a visible light sensor, a temperature sensor, and/or a humidity sensor. A sensor ensemble may comprise other types of sensors, and claimed subject matter is not limited in this respect. The enclosure may comprise one or more sensors that are not part of an ensemble of sensors. The enclosure may comprise a plurality of ensembles. At least two of the plurality of ensembles may differ in at least one of their sensors. At least two of the plurality of ensembles may have at least one of their sensors that is similar (e.g., of the same type). For example, an ensemble can have two motion sensors and one temperature sensor. For example, an ensemble can have a carbon dioxide sensor and an IR sensor. The ensemble may include one or more devices that are not sensors. The one or more other devices that are not sensors may include sound emitter (e.g., buzzer), and/or electromagnetic radiation emitters (e.g., light emitting diode). In some embodiments, a single sensor (e.g., not in an ensemble) may be disposed adjacent (e.g., immediately adjacent such as contacting) another device that is not a sensor.

In some embodiments, sensors of a sensor ensemble collaborate with one another (e.g., using the control system). The sensors can comprise an array of sensors. The array of sensors can collaborate synergistically (e.g., using the network and/or controller(s)). The controllers may be included in a control system (e.g., as disclosed herein). A sensor of one type may have a correlation with at least one other type of sensor. A situation in an enclosure may affect one or more of different sensors. Sensor readings of the one or more different may be correlated and/or affected by the situation. The correlations may be predetermined. The correlations may be determined over a period of time (e.g., using a learning process). The period of time may be predetermined. The period of time may have a cutoff value. The cutoff value may consider an error threshold (e.g., percentage value) between a predictive sensor data and a measured sensor data, e.g., in similar situation(s). The time may be ongoing. The correlation may be derived from a learning set (also referred to herein as “training set”). The learning set may comprise, and/or may be derived from, real time observations in the enclosure. The observations may include data collection (e.g., from sensor(s)). The learning set may comprise sensor(s) data from a similar enclosure. The learning set may comprise third party data set (e.g., of sensor(s) data). The learning set may derive from simulation, e.g., of one or more environmental conditions affecting the enclosure. The learning set may compose detected (e.g., historic) signal data to which one or more types of noise were added. The correlation may utilize historic data, third party data, and/or real time (e.g., sensor) data. The correlation between two sensor types may be assigned a value. The value may be a relative value (e.g., strong correlation, medium correlation, or weak correlation). The learning set that is not derived from real-time measurements, may serve as a benchmark (e.g., baseline) to initiate operations of the sensors and/or various components that affect the environment (e.g., HVAC system, and/or tinting windows). Real time sensor data may supplement the learning set, e.g., on an ongoing basis or for a defined time period. The (e.g., supplemented) learning set may increase in size during deployment of the sensors in the environment. The initial learning set may increase in size, e.g., with inclusion of additional (i) real time measurements, (ii) sensor data from other (e.g., similar) enclosures, (iii) third party data, (iv) other and/or updated simulation.

In some embodiments, data from sensors may be correlated. Once a correlation between two or more sensor types is established, a deviation from the correlation (e.g., from the correlation value) may indicate an irregular situation and/or malfunction of a sensor of the correlating sensors. The malfunction may include a slippage of a calibration. The malfunction may indicate a requirement for re-calibration of the sensor. A malfunction may comprise complete failure of the sensor. In an example, a movement sensor may collaborate with a carbon dioxide sensor. In an example, responsive to a movement sensor detecting movement of one or more individuals in an enclosure, a carbon dioxide sensor may be activated to begin taking carbon dioxide measurements. An increase in movement in an enclosure, may be correlated with increased levels of carbon dioxide. In another example, a motion sensor detecting individuals in an enclosure may be correlated with an increase in noise detected by a noise sensor in the enclosure. In some embodiments, detection by a first type of sensor that is not accompanied by detection by a second type of sensor may result in a sensor posting an error message. For example, if a motion sensor detects numerous individuals in an enclosure, without an increase in carbon dioxide and/or noise, the carbon dioxide sensor and/or the noise sensor may be identified as having failed or as having an erroneous output. An error message may be posted. A first plurality of different correlating sensors in a first ensemble may include one sensor of a first type, and a second plurality of sensors of different types. If the second plurality of sensors indicate a correlation, and the one sensor indicates a reading different from the correlation, there is an increased likelihood that the one sensor malfunctions. If the first plurality of sensors in the first ensemble detect a first correlation, and a third plurality of correlating sensors in a second ensemble detect a second correlation different from the first correlation, there is an increased likelihood that the situation to which the first ensemble of sensors is exposed to is different from the situation to which the third ensemble of sensors are exposed to.

Sensors of a sensor ensemble may collaborate with one another. The collaboration may comprise considering sensor data of another sensor (e.g., of a different type) in the ensemble. The collaboration may comprise trends projected by the other sensor (e.g., type) in the ensemble. The collaboration may comprise trends projected by data relating to another sensor (e.g., type) in the ensemble. The other sensor data can be derived from the other sensor in the ensemble, from sensors of the same type in other ensembles, or from data of the type collected by the other sensor in the ensemble, which data does not derive from the other sensor. For example, a first ensemble may include a pressure sensor and a temperature sensor. The collaboration between the pressure sensor and the temperature sensor may comprise considering pressure sensor data while analyzing and/or projecting temperature data of the temperature sensor in the first ensemble. The pressure data may be (i) of a pressure sensor in the first ensemble, (ii) of pressure sensor(s) in one or more other ensembles, (iii) pressure data of other sensor(s) and/or (iv) pressure data of a third party.

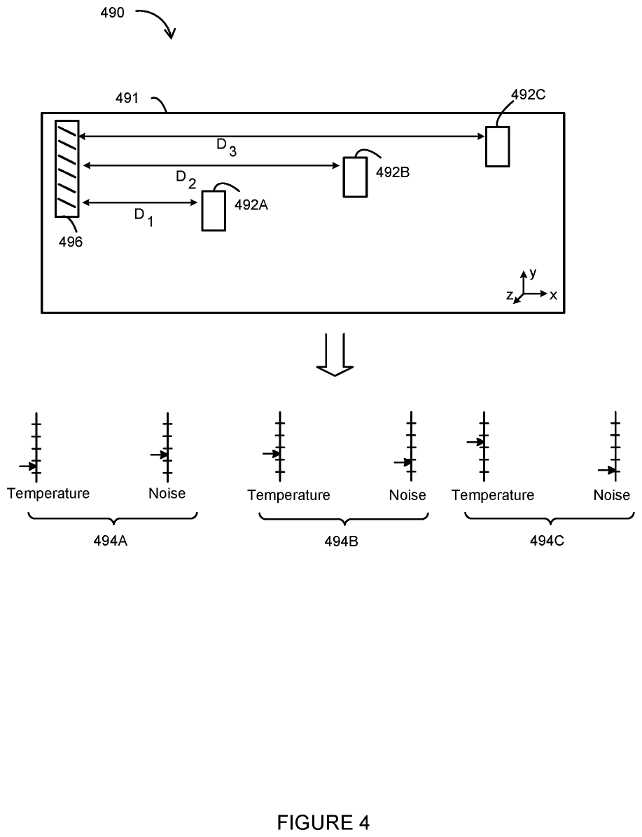

In some embodiments, sensor ensembles, are distributed throughout an enclosure. Sensors of a same type may be dispersed in an enclosure, e.g., to allow measurement of environmental parameters at various locations of an enclosure. Sensors of the same type may measure a gradient along one or more dimensions of an enclosure. A gradient may include a temperature gradient, an ambient noise gradient, or any other variation (e.g., increase or decrease) in a measured parameter as a function of location from a point. A gradient may be utilized in determining that a sensor is providing erroneous measurement (e.g., the sensor has a failure). FIG. 4 shows an example of a diagram 490 of an arrangement of sensor ensembles in an enclosure. In the example of FIG. 4, ensemble 492A is positioned at a distance D1 from vent 496. Sensor ensemble 492B is positioned at a distance D2 from vent 496. Sensor ensemble 492C is positioned at a distance D3 from vent 496. In the example of FIG. 4B, vent 496 corresponds to an air conditioning vent, which represents a relatively constant source of cooling atmosphere and a relatively constant source of white noise. Thus, in the example of FIG. 4B, temperature and noise measurements are made by sensor ensemble 492A. Temperature and noise measurements made by sensor 492A are shown by output reading profile 494A. Output reading profile 494A indicates a relatively low temperature and a significant amount of noise. Temperature and noise measurements made by sensor ensemble 492B are shown by output reading profile 494B. Output reading profile 494B indicates a somewhat higher temperature, and a somewhat reduced noise level. Temperature and noise measurements made by sensor ensemble 492C are shown by output reading profile 494C. Output reading profile 494C indicates a temperature somewhat higher than the temperature measured by sensor ensemble 492B and 492A. Noise measured by sensor ensemble 492C indicates a lower level than noise measured by sensor ensemble 492A and 492B. In an example, if a temperature measured by sensor ensemble 492C indicates a lower temperature than a temperature measured by sensor ensemble 492A, one or more processors and/or controllers may identify sensor ensemble 492C sensor as providing erroneous data.

In another example of a temperature gradient, a temperature sensor installed near a window may measure increased temperature fluctuations with respect to temperature fluctuations measured by a temperature sensor installed at a location opposite the window. A sensor installed near a midpoint between the window and the location opposite the window may measure temperature fluctuations in between those measured near a window with respect to those measured at the location opposite the window. In an example, an ambient noise sensor installed near an air conditioner (or near a heating vent) may measure greater ambient noise than an ambient noise sensor installed away from the air conditioning or heating vent.

In some embodiments, a sensor of a first type cooperates with a sensor of a second type. In an example, an infrared radiation sensor may cooperate with a temperature sensor. Cooperation among sensor types may comprise establishing a correlation (e.g., negative or positive) among readings from sensors of the same type or of differing types. For example, an infrared radiation sensor measuring an increase in infrared energy may be accompanied by (e.g., positively correlated to) an increase in measured temperature. A decrease in measured infrared radiation may be accompanied by a decrease in measured temperature. In an example, an infrared radiation sensor measuring an increase in infrared energy that is not accompanied by a measurable increase in temperature, may indicate failure or degradation in operation of a temperature sensor.

In some embodiments, one or more sensors are included in an enclosure. For example, an enclosure may include at least 1, 2, 4, 5, 8, 10, 20, 50, or 500 sensors. The enclosure may include a number of sensors in a range between any of the aforementioned values (e.g., from about 1 to about 1000, from about 1 to about 500, or from about 500 to about 1000). The sensor may be of any type. For example, the sensor may be configured (e.g., and/or designed) to measure concentration of a gas (e.g., carbon monoxide, carbon dioxide, hydrogen sulfide, volatile organic chemicals, or radon). For example, the sensor may be configured (e.g., and/or designed) to measure ambient noise. For example, the sensor may be configured (e.g., and/or designed) to measure electromagnetic radiation (e.g., RF, microwave, infrared, visible light, and/or ultraviolet radiation). For example, the sensor may be configured (e.g., and/or designed) to measure security-related parameters, such as (e.g., glass) breakage and/or unauthorized presence of personnel in a restricted area. Sensors may cooperate with one or more (e.g., active) devices, such as a radar or lidar. The devices may operate to detect physical size of an enclosure, personnel present in an enclosure, stationary objects in an enclosure and/or moving objects in an enclosure.

In some embodiments, the sensor is operatively coupled to at least one controller. The coupling may comprise a communication link. A communications link (e.g., FIG. 3, 308) may comprise any suitable communications media (e.g., wired and/or wireless). The communication link may comprise a wire, such as one or more conductors arranged in a twisted-pair, a coaxial cable, and/or optical fibers. A communications link may comprise a wireless communication link, such as Wi-Fi, Bluetooth, ZigBee, cellular, or optical. One or more segments of the communications link may comprise a conductive (e.g., wired) media, while one or more other segments of a communications link may comprise a wireless link.

In some embodiments, the enclosure is a facility (e.g., building). The enclosure may comprise a wall, a door, or a window. In some embodiments, at least two enclosures of a plurality of enclosures are disposed in the facility. In some embodiments, at least two enclosures of a plurality of enclosures are disposed different facilities. The different facilities may be a campus (e.g. and belong to the same entity). At least two of the plurality of enclosures may reside in the same floor of the facility. At least two of the plurality of enclosures may reside in different floors of the facility. Enclosures of shown in FIG. 4, such as enclosures A, B, C, and Z, may correspond to enclosures located on the same floor of a building, or may correspond to enclosures located on different floors of the building. Enclosures of FIG. 4 may be located in different buildings of a multi-building campus. Enclosures of FIG. 4 may be located in different campuses of a multi-campus neighborhood.

In some embodiments, following installation of a first sensor, a sensor performs self-calibration to establish an operating baseline. Performance of a self-calibration operation may be initiated by an individual sensor, a nearby second sensor, or by one or more controllers. For example, upon and/or following installation, a sensor deployed in an enclosure may perform a self-calibration procedure. A baseline may correspond to a lower threshold from which collected sensor readings may be expected to comprise values higher than the lower threshold. A baseline may correspond to an upper threshold, from which collected sensor readings may be expected to comprise values lower than the upper threshold. A self-calibration procedure may proceed beginning with sensor searching for a time window during which fluctuations or perturbations of a relevant parameter are nominal. In some embodiments, the time window is sufficient to collect sensed data (e.g., sensor readings) that allow separation and/or identification of signal and noise form the sensed data. The time window may be predetermined. The time window may be non-defined. The time window may be kept open (e.g., persist) until a calibration value is obtained.

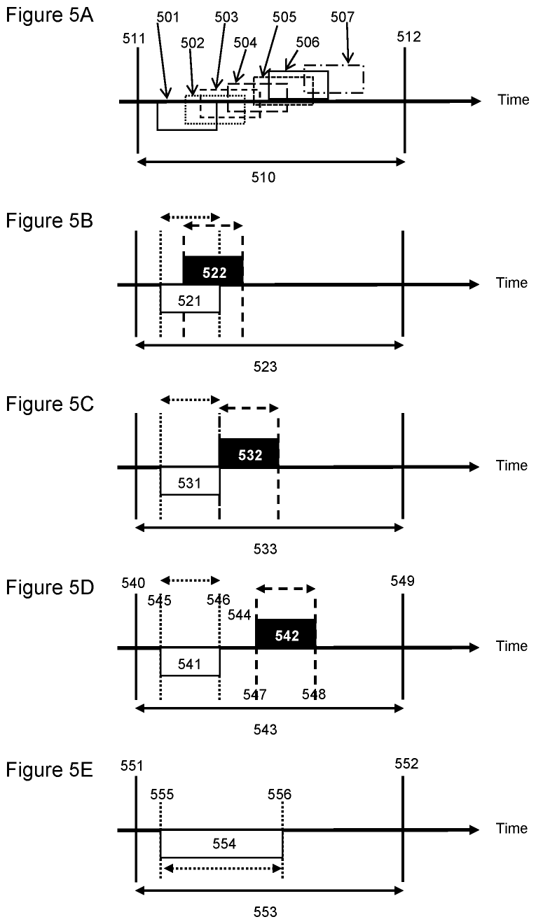

In some embodiments, a sensor may search for an optimal time to measure a baseline (e.g., in a time window). The optimal time (e.g., in the time window) may be a time span during which (i) the measured signal is most stable and/or (ii) the signal to noise ratio is highest. The measured signal may contain some level of noise. A complete absence of noise may indicate malfunction of the sensor or inadequacy for the environment. The sensed signal (e.g., sensor data) may comprise a time stamp of the measurement of the data. The sensor may be assigned a time window during which it may sense the environment. The time window may be predetermined (e.g., using third party information and/or historical data concerning the property measured by the sensor). The signal may be analyzed during that time window, and an optimal time span may be found in the time window, in which time span the measured signal ism most stable and/or the signal no noise ratio is highest. The time span may be equal to, or shorter than, the time window. The time span may occur during the entire, or during part of the time window. FIG. 5E shows an example of a time windows 553 is indicated having a start time 551 and an end time 552. In the time window 553, a time span 554 is indicated, having a start time 555 and an end time 556. The sensor may sense a property which it is configured to sense (e.g., VOC level) during the time window 553 for the purpose of finding a time span during which an optimal sensed data (e.g., optimal sensed data set) is collected, which optimal data (e.g., data set) has the highest signal to noise ratio, and/or indicates collection of a stable signal. The optimal sensed data may have a (e.g., low) level of noise (e.g., to negate a malfunctioning sensor). For example, a time window may be 12 hours between 5 PM and 5 AM. During that time span, sensed VOC data is collected. The collected sensed data set may be analyzed (e.g., using a processor) to find a time span during the 12 h, in which there is a minimal noise level (e.g., indicating that the sensor is functioning) and (i) a highest signal to noise ratio (e.g., the signal is distinguishable) and/or (ii) the signal is most stable (e.g., has a low variability). This time may be of a 1 h duration between 4 AM and 5 AM. In this example, the time window is 12 h between 5 PM and 5 AM, and the time span is 1 h between 4 AM and 5 AM.

In some embodiments, finding the optimal data (e.g., set) to be used for calibration comprises comparing sensor data collected during time spans (e.g., in the time window). In the time window, the sensor may sense the environment during several time spans of (e.g., substantially) equal duration. A plurality of time spans may fit in the time window. The time spans may overlap, or not overlap. The time spans may contract each other. Data collected by the sensors in the various time spans may be compared. The time span having the highest signal to noise and/or having the most stable signal, may be selected as determining the baseline signal. For example, the time window may include a first time span and a second time span. The first time span (e.g., having a first duration, or a first time length) may be shorter than the time windows. The second time span (e.g., having a second duration) may be shorter than the time windows. In some embodiments, evaluating the sensed data (e.g., to find the optimal sensed data used for calibration) comprises comparing a first sensed data set sensed (e.g., and collected) during the first time span, with a second sensed data set sensed (e.g., and collected) during the second time span. The length of the first time span may be different from the length of the second time span. The length of the first time span may be equal (or substantially equal) to the length of the second time span. The first time span may have a start time and/or end time, different than the second time span. The start time and/or end time of the first time span and of the second time span may be in the time window. The start time of the first time span and/or of the second time span, may be equal to the start time of the time window. The end time of the first time span and/or of the second time span, may be equal to the end time of the time window. FIG. 5D shows an example of a time window 543 having a start time 540 and an end time 549, a first time window 541 having a start time 545 and an end time 546, and a second time window 542 having a start time 547 and an end time 458. In the example shown in FIG. 5D, start times 545 and 547 are in the time window 543, and end times 546 and 548 are in the time window 543.

FIGS. 5A-5D show examples of various time windows that include time spans. FIG. 5A depicts a time lapse diagram in which a time window 510 is indicated having a start time 511 and an end time 512. In the time window 510, various time spans 501-507 are indicated, which time spans overlap each other. The sensor may sense a property which it is configured to sense (e.g., humidity, temperature, or CO₂ level) during at least two of the time spans (e.g., of 501-507), e.g., for the purpose of comparing the signal to find at time at which the signal is most stable and/or has a highest signal to noise ratio. For example, the time window (e.g., 501) may be a day, and the time span may be 50 minutes. The sensor may measure a property (e.g., CO₂ level) during overlapping periods of 50 minutes (e.g., during the collective time 501-507), and the data may later on be divided into distinct (overlapping) 50 minutes, e.g., by using the time stamped measurements. The 50 minutes that indicates the stables CO₂ signal (e.g., at night) and/or having the highest signal to noise, may be designates as an optimal time for measuring a baseline CO₂ signal. The signal measured may be selected as a baseline for the sensor. Once the optimal time span has been selected, other CO₂ sensors (e.g., in other locations) can utilize this time span for baseline determination. Finding of the optimal time for baseline determination can speed up the calibration process. Once the optimal time has been found, other sensors may be programmed to measure signal at the optimal time to record their signal, which may be used for baseline calibration. FIG. 5B depicts a time lapse diagram in which a time window 523 is indicated, during which two time spans 521 and 522 are indicated, which time spans overlap each other. FIG. 5C depicts a time lapse diagram in which a time window 533 is indicated, during which two time spans 531 and 532 are indicated, which time spans contact each other, that is, ending of the first time span 531 is the beginning of the second time span 532. FIG. 5D depicts a time lapse diagram in which a time window 543 is indicated, during which two time spans 541 and 542 are indicated, which time spans are separate by a time gap 544.

In an example, for a carbon dioxide sensor, a relevant parameter may correspond to carbon dioxide concentration. In an example, a carbon dioxide sensor may determine that a time window during which fluctuations in carbon dioxide concentration could be minimal corresponds to a two-hour period, e.g., between 5:00 AM and 7:00 AM. Self-calibration may initiate at 5:00 AM and continue while searching for a duration within these two hours during which measurements are stable (e.g., minimally fluctuating). In some embodiments, the duration is sufficiently long to allow separation between signal and noise. In an example, data from a carbon dioxide sensor may facilitate determination that a 5-minute duration (e.g., between 5:25 AM and 5:30 AM) within a time window between 5:00 AM and 7:00 AM forms an optimal time period to collect a lower baseline. The determination can be performed at least in part (e.g., entirely) at the sensor level. The determination can be performed by one or more processors operatively couple to the sensor. During a selected duration, a sensor may collect readings to establish a baseline, which may correspond to a lower threshold.

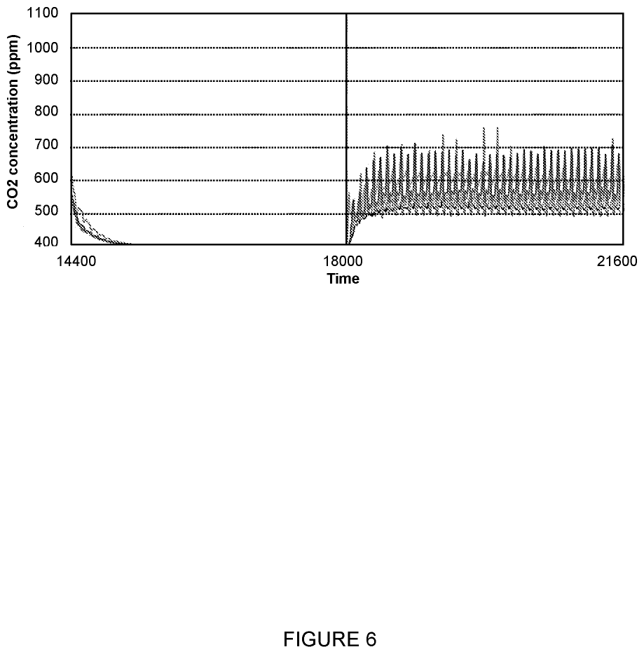

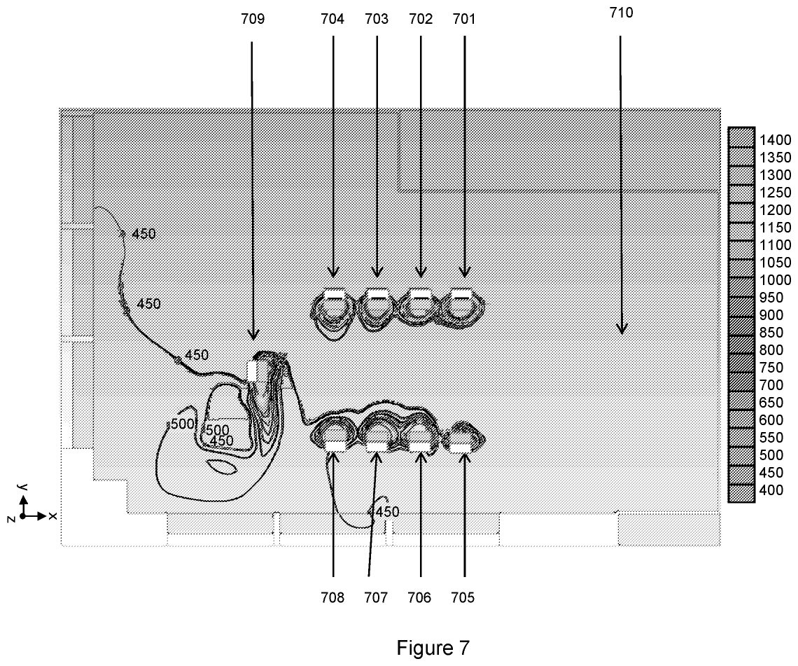

In an example, for gas sensors disposed in a room (e.g., in an office environment), a relevant parameter may correspond to gas (e.g., CO₂) levels, where requested levels are typically in a range of about 1000 ppm or less. In an example, a CO₂ sensor may determine that self-calibration should occur during a time window where CO₂ levels are minimal such as when no occupants are in the vicinity of the sensor (e.g., see CO₂ levels before 18000 seconds in FIG. 6). Time windows during which fluctuations in CO₂ levels are minimal, may correspond to, e.g., a one-hour period during lunch from about 12:00 PM to about 1:00, and during closed business hours. FIG. 7 shows a contour map example of a horizontal (e.g., top) view of an office environment depicting various levels of CO₂ concentrations. The office environment may include a first occupant 701, a second occupant 702, a third occupant 703, a fourth occupant 704, a fifth occupant 705, a sixth occupant 706, a seventh occupant 707, an eighth occupant 708, and a ninth occupant 709. The gas (CO₂) concentrations may be measured by sensors placed at various locations of the enclosure (e.g., office).

In some examples, a source chemical component(s) of the atmosphere material (e.g., VOC) is located using a plurality of sensors in the room. A spatial profile indicating distribution of the chemical(s) in the enclosure may indicate various (e.g., relative or absolute) concentrations of the chemical(s) as a function of space. The profile may be a two or three dimensional profile. The sensors may be disposed in different locations of the room to allow sensing of the chemical(s) in different room locations. Mapping the (e.g., entire) enclosure (e.g., room) may require (i) overlap of sensing regions of the sensors and/or (i) extrapolating distribution of the chemical(s) in the enclosure (e.g., in regions of low or absence of sensor coverage (e.g., sensing regions)). For example, FIG. 7 shows an example of relatively steep and high concentration of carbon dioxide towards 705 where an occupant is present, relative to low concentration 710 in an unoccupied region of the enclosure. This can indicate that in position 705 there is a source of carbon dioxide expulsion. Similarly, one can find a location (e.g., source) of chemical removal by finding a (e.g., relatively steep) low concentration of a chemical in the environment. Relative is with respect to the general distribution of the chemical(s) in the enclosure.

Certain disclosed embodiments provide a network infrastructure in the enclosure (e.g., a facility such as a building). The network infrastructure is available for various purposes such as for providing communication and/or power services. The communication services may comprise high bandwidth (e.g., wireless and/or wired) communications services. The communication services can be to occupants of a facility and/or users outside the facility (e.g., building). The network infrastructure may work in concert with, or as a partial replacement of, the infrastructure of one or more cellular carriers. The network infrastructure can be provided in a facility that includes electrically switchable windows. Examples of components of the network infrastructure include a high speed backhaul. The network infrastructure may include at least one cable, switch, physical antenna, transceivers, sensor, transmitter, receiver, radio, processor and/or controller (that may comprise a processor). The network infrastructure may be operatively coupled to, and/or include, a wireless network. The network infrastructure may comprise wiring. At least a portion of the wiring may be disposed at an envelope of the enclosure (e.g., outer walls of a building). One or more sensors can be deployed (e.g., installed) in an environment as part of installing the network and/or after installing the network.

In various embodiments, a network infrastructure supports a control system. The control system may control one or more windows such as tintable (e.g., electrochromic) windows. The control system may comprise one or more controllers operatively coupled (e.g., directly or indirectly) to the one or more windows. The one or more windows may be an optically switchable window, a tintable windows, and/or a smart window. Concepts disclosed herein for electrochromic windows may apply to other types of smart and/or tintable windows (e.g., comprising switchable optical devices) comprising a liquid crystal device, an electrochromic device, suspended particle device (SPD), NanoChromics display (NCD), Organic electroluminescent display (OELD), suspended particle device (SPD), NanoChromics display (NCD), or an Organic electroluminescent display (OELD). The display element may be attached to a part of a transparent body (such as the windows). The tintable window may be disposed in a (non-transitory) facility such as a building, and/or in a transitory vehicle such as a car, buss, train, airplane, helicopter, ship, recreational vehicle, or boat.

In some embodiments, a building management system (BMS) is a control system installed in a building, that controls (e.g., monitors) the mechanical and/or electrical equipment of the enclosure. The control system may comprise a hierarchy of controllers (e.g., controllers configured for hierarchical communication). The control system may comprise at least one controller that is directed to at least one tintable window. The tintable window may change its color, transparency, and/or hue in response to electrical current and/or voltage differential. For example, the control system can control ventilation, lighting, power system, elevator, fire system, and/or security system, of the enclosure. The control system (e.g., comprising nodes and/or processors) described herein may be suited for integration with a BMS. A BMS may consist of hardware, including interconnections by communication channels to computer(s) and/or associated software for maintaining conditions in the building, e.g., according to preferences set by at least one user. The user can be an occupant, an owner, a lessor, and/or a building manager. For example, a BMS may be implemented using a local area network, such as Ethernet. The software can include open standards and/or comply with internet protocols, and cellular network protocols (e.g., of at least third generation, fourth generation, or fifth generation cellular network protocol). One example is software from Tridium, Inc. (of Richmond, Va.). One communication protocol commonly used with a BMS is building automation and control networks (BACnet).

In some embodiments, a BMS is disposed in an enclosure such as a facility. The facility can comprise a building such as a multistory building. The BMS may functions at least to control the environment in the building. The control system and/or BMS may control at least one environmental characteristic of the enclosure. The at least one environmental characteristic may comprise temperature, humidity, fine spray (e.g., aerosol), sound, electromagnetic waves (e.g., light glare, and/or color), gas makeup, gas concentration, gas speed, vibration, volatile compounds (VOCs), debris (e.g., dust), or biological matter (e.g., gas borne bacteria and/or virus). The gas(es) may comprise oxygen, nitrogen, carbon dioxide, carbon monoxide, hydrogen sulfide, Nitric oxide (NO) and nitrogen dioxide (NO₂), inert gas, Nobel gas (e.g., radon), cholorophore, ozone, formaldehyde, methane, or ethane. For example, a BMS may control temperature, carbon dioxide levels, and/or humidity in an enclosure. Mechanical devices that can be controlled by a BMS and/or control system may comprise lighting, a heater, air conditioner, blower, or vent. To control the enclosure (e.g., building) environment, a BMS and/or control system may turn on and off one or more of the devices it controls, e.g., under defined conditions. A (e.g., core) function of a modern BMS and/or control system may be to maintain a comfortable, healthy, and/or productive environment for the occupant(s) of the enclosure, e.g., while minimizing energy consumption (e.g., while minimizing heating and cooling costs/demand). A modern BMS and/or control system can be used to control (e.g., monitor), and/or to optimize the synergy between various systems, for example, to conserve energy and/or lower enclosure (e.g., facility) operation costs.

In some embodiments, the control system controls at least one environmental characteristic of an enclosure (e.g., atmosphere of the enclosure). The environmental characteristic can be any environmental characteristic disclosed herein. For example, a level of a gas borne and/or gaseous component of the atmosphere. For example, an atmospheric accumulant. For example, at atmospheric depletant. In some embodiments, the control system is operatively (e.g., communicatively) coupled to an ensemble of devices (e.g., comprising one or more sensors and/or emitters). The ensemble facilitates the control of the environment and/or the alert. The control may utilize a control scheme such as feedback control, or any other control scheme delineated herein (e.g., feed forward, closed loop, and/or open loop). The ensemble may comprise at least one sensor configured to sense electromagnetic radiation. The electromagnetic radiation may comprise (humanly) visible, infrared (IR), or ultraviolet (UV) radiation. The at least one sensor may comprise an array of sensors. For example, the ensemble may comprise an IR sensor array. The ensemble may comprise a sound detector and/or emitter. The ensemble may comprise a microphone. The ensemble may comprise any sensor and/or emitter disclosed herein.

In some embodiments, the ensemble (or a group of ensembles) may be utilized to detect characteristics of enclosure occupant(s). The ensemble may be utilized to detect abnormal bodily characteristic of enclosure occupant(s). The abnormal bodily characteristic may comprise bodily temperature, coughing, sneezing, perspiration (e.g., humidity and/or VOCs expulsion), or CO₂ level. The ensemble(s) may be utilized to locate an absolute and/or relative positioning of enclosure occupant(s). For example, the ensemble(s) may be utilized to measure relative distances between occupants in the enclosure, and/or between occupant(s) and hard and/or dense objects in the enclosure (e.g., fixtures and/or non-fixtures). The hard and/or dense objects may comprise fixtures (e.g., wall, ceiling, floor, window, door, shelf, ceiling light, or wall light) or mobile furniture (e.g., chair, desk, or lamp).

In some examples, one or more sensors in the enclosure are VOC sensors. A VOC sensor can be specific for a VOC compound (e.g., as disclosed herein), or to a class of compounds (e.g., having similar chemical characteristic). For example, the sensor can be sensitive to aldehydes, esters, thiophenes, alcohols, aromatics (e.g., benzenes and/or toluenes), or olefins. In some example, a group of sensors (e.g., sensor array) sensed various chemical compounds (VOCs) (e.g., having different chemical characteristics). The group of compound may comprise identified or non-identified compounds. The chemical sensor(s) can output a sensed value of a particular compound, class of compounds, or group of compounds. The sensor output may be of a total (e.g., accumulated) measurements of the class, or group of compounds sensed. The sensor output may be of a total (e.g., accumulated) measurements of multiple sensor outputs of (i) individual compounds, (ii) classes of compounds, or (iii) groups of compounds. The one or more sensors may output a total VOC output (also referred to herein as TVOC). Sensing can be over a period of time.

In some embodiments, a local (e.g., window) controller can be integrated with a BMS and/or control system. The local controller can be configured to control one or more devices comprising tintable windows (e.g., comprising an electrochromic window), sensors, emitters, antennas, or any other element communicatively coupled to the network (that is controllable by communication). In one embodiment, the electrochromic windows include at least one all solid state and inorganic electrochromic device. The electrochromic window may include more than one electrochromic device, e.g. where at least two lites (e.g., each lite) are tintable. In one embodiment, the electrochromic windows include (e.g., only) all solid state and inorganic electrochromic devices. In one embodiment, the one or more electrochromic windows include organic electrochromic devices. In one embodiment, the electrochromic windows are multistate electrochromic windows. Examples of tintable windows and their control can be found in U.S. patent application Ser. No. 12/851,514, filed on Aug. 5, 2010, and titled “MULTI-PANE ELECTROCHROMIC WINDOWS” that is incorporated herein by reference in its entirety.

In some embodiments, a plurality of devices may be operatively (e.g., communicatively) coupled to the control system. The plurality of devices may be disposed in a facility (e.g., including a building and/or room). The control system may comprise the hierarchy of controllers. The devices may comprise an emitter, a sensor, or a window (e.g., IGU). The device may be any device as disclosed herein. At least two of the plurality of devices may be of the same type. For example, two or more IGUs may be coupled to the control system. At least two of the plurality of devices may be of different types. For example, a sensor and an emitter may be coupled to the control system. At times the plurality of devices may comprise at least 20, 50, 100, 500, 1000, 2500, 5000, 7500, 10000, 50000, 100000, or 500000 devices. The plurality of devices may be of any number between the aforementioned numbers (e.g., from 20 devices to 500000 devices, from 20 devices to 50 devices, from 50 devices to 500 devices, from 500 devices to 2500 devices, from 1000 devices to 5000 devices, from 5000 devices to 10000 devices, from 10000 devices to 100000 devices, or from 100000 devices to 500000 devices). For example, the number of windows in a floor may be at least 5, 10, 15, 20, 25, 30, 40, or 50. The number of windows in a floor can be any number between the aforementioned numbers (e.g., from 5 to 50, from 5 to 25, or from 25 to 50). At times the devices may be in a multi-story building. At least a portion of the floors of the multi-story building may have devices controlled by the control system (e.g., at least a portion of the floors of the multi-story building may be controlled by the control system). For example, the multi-story building may have at least 2, 8, 10, 25, 50, 80, 100, 120, 140, or 160 floors that are controlled by the control system. The number of floors (e.g., devices therein) controlled by the control system may be any number between the aforementioned numbers (e.g., from 2 to 50, from 25 to 100, or from 80 to 160). The floor may be of an area of at least about 150 m², 250 m², 500 m², 1000 m², 1500 m², or 2000 square meters (m²). The floor may have an area between any of the aforementioned floor area values (e.g., from about 150 m² to about 2000 m², from about 150 m² to about 500 m² from about 250 m² to about 1000 m², or from about 1000 m² to about 2000 m²). The building may comprise an area of at least about 1000 square feet (sqft), 2000 sqft, 5000 sqft, 10000 sqft, 100000 sqft, 150000 sqft, 200000 sqft, or 500000 sqft. The building may comprise an area between any of the above mentioned areas (e.g., from about 1000 sqft to about 5000 sqft, from about 5000 sqft to about 500000 sqft, or from about 1000 sqft to about 500000 sqft). The building may comprise an area of at least about 100 m², 200 m², 500 m², 1000 m², 5000 m², 10000 m², 25000 m², or 50000 m². The building may comprise an area between any of the above mentioned areas (e.g., from about 100 m² to about 1000 m², from about 500 m² to about 25000 m², from about 100 m² to about 50000 m²). The facility may comprise a commercial or a residential building. The commercial building may include tenant(s) and/or owner(s). The residential facility may comprise a multi or a single family building. The residential facility may comprise an apartment complex. The residential facility may comprise a single family home. The residential facility may comprise multifamily homes (e.g., apartments). The residential facility may comprise townhouses. The facility may comprise residential and commercial portions. The facility may comprise at least about 1, 2, 5, 10, 50, 100, 150, 200, 250, 300, 350, 400, 420, 450, 500, or 550 windows (e.g., tintable windows). The components of the facility (e.g., devices such as the windows) may be allocated into zones (e.g., based at least in part on the location, façade, floor, ownership, utilization of the enclosure (e.g., room) in which they are disposed, any other assignment metric, random assignment, or any combination thereof. Allocation of components (e.g., devices such as windows) to the zone may be static or dynamic (e.g., based on a heuristic). There may be at least about 2, 5, 10, 12, 15, 30, 40, or 46 components (e.g., devices such as sensor and/or windows) per zone. The zones may be grouped into groups (e.g., each having a distinguishable name and/or notation). The zones may be clustered (e.g., with each cluster having a distinguishable name and/or notation). The zones, their grouping and/or clustering may form a hierarchy of zones.

In some embodiments, the various components (e.g., IGUs) are grouped into zones of components (e.g., of EC windows). At least one zone (e.g., each of which zones) can include a subset of components (e.g., devices). For example, at least one (e.g., each) zone of components may be controlled by one or more respective floor controllers and one or more respective local controllers (e.g., window controllers) controlled by these floor controllers. In some examples, at least one (e.g., each) zone can be controlled by a single floor controller and two or more local controllers controlled by the single floor controller. For example, a zone can represent a logical grouping of the components (e.g., devices). Each zone may correspond to a set of components (e.g., of the same type) in a specific location or area of the facility that are driven together based at least in part on their location. For example, a facility (e.g., building) may have four faces or sides (a North face, a South face, an East Face, and a West Face) and ten floors. In such a didactic example, each zone may correspond to the set of smart windows (e.g., tintable windows) on a particular floor and on a particular one of the four faces. At least one (e.g., each) zone may correspond to a set of components (e.g., devices) that share one or more physical characteristics (for example, device parameters such as size or age). In some embodiments, a zone of components (e.g., devices) is grouped based at least in part on one or more non-physical characteristics such as, for example, a security designation or a business hierarchy (for example, IGUs bounding managers' offices can be grouped in one or more zones while IGUs bounding non-managers' offices can be grouped in one or more different zones).

In some embodiments, at least one (e.g., each) floor controller is able to address all of the components (e.g., devices) in at least one (e.g., each) of one or more respective zones. The components in the zone may be of the same type or of different types. For example, the master controller can issue a primary tint command to the floor controller that controls a target zone.

In some embodiments, the facility may be divided into one or more zones. The zones may be defined at least in part by a customer, or by the facility manager. The zones may be at least in part automatically defined. For example, the zone of devices (e.g., comprising tintable windows, sensors, or emitters) may associate with (i) a façade of a building they are facing, (ii) a floor they are disposed in, (iii) a building in the facility they are disposed in, (iv) a functionality of the enclosure they are disposed in (e.g., a conference room, a gym, an office, or a cafeteria), (iv) prescribed and/or in fact occupation (e.g., organizational function) to the enclosure they are disposed in, (v) prescribed and/or in fact activity in the enclosure they are disposed in, (vi) tenant, owner, and/or manager of the enclosure of the facility (e.g., for a facility having various tenants, owners, and/or managers), and/or (vii) their geographic location. The zones may be alterable (e.g., using the software app). The status of the zone (e.g., in conjunction to the status of the components (such as devices) therein), may be displayed by the app (e.g., updated in real-time, or substantially in real time). One or more zones may be grouped. For example, all zones in a certain floor may be groped. There may be a zone hierarchy using any of the zone in association with (i) a façade of a building they are facing, (ii) a floor they are disposed in, (iii) a building in the facility they are disposed in, (iv) a functionality of the enclosure they are disposed in (e.g., a conference room, a gym, an office, or a cafeteria), (iv) prescribed and/or in fact occupation (e.g., organizational function) to the enclosure they are disposed in, (v) prescribed and/or in fact activity in the enclosure they are disposed in, (vi) tenant, owner, and/or manager of the enclosure of the facility (e.g., for a facility having various tenants, owners, and/or managers), and/or (vii) their geographic location.

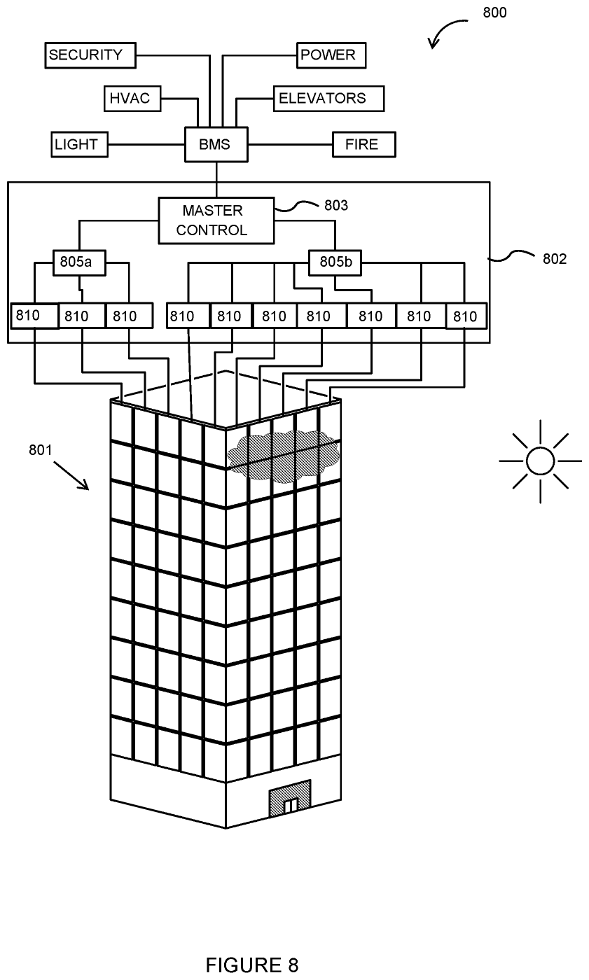

FIG. 8 depicts a schematic diagram example of an embodiment of a BMS and control system 800. In this example, the BMS manages a number of systems of a building 801, including security systems, heating ventilation and air conditioning system (abbreviated herein as “HVAC”), lighting, power systems, elevators, fire systems, and the like. Security systems may include magnetic card access, turnstile, solenoid driven door lock, (e.g., surveillance) camera, (e.g., burglar) alarm, and/or metal detector. The BMS and/or control system may control at least one fire system and/or fire suppression system. The fire system(s) may include fire alarm. The fire suppression system(s) may include a water plumbing control. The lighting system may include interior lighting, exterior lighting, emergency warning light, emergency exit sign, and/or emergency floor (e.g., egress or ingress) lighting. The power system may include the main power for the enclosure (e.g., facility), backup power generator, and/or uninterrupted power source (UPS) grid. The BMS can manage the control system. The BMS can be managed by the control system. The BMS can be included in the control system. In the example shown in FIG. 1, master controller 803 is depicted as a distributed network 802 of local (e.g., window) controllers including a master controller 803, intermediate controllers 805a and 805b (that can be floor controllers and/or network controllers), and local controllers (e.g., end or leaf controllers such as window controllers) 810. Master controller 803 may or may not be in physical proximity to the BMS 800. At least one floor (e.g., each floor) of building 801 may have one or more intermediate controllers 805a and 805b. At least one device (e.g., window) may have its own local controller 810. A local controller may control at least 1, 2, 3, 4, 5, 6, 7, 8, 9, or 10 devices. The control system may or may not have intermediate controller(s). The control system may have 1, 2, 3, or more hierarchal control levels. In the example shown in FIG. 2, a local controller (e.g., 804) can control a plurality of devices. The devices may comprise a window, a sensor, an emitter, an antenna, a receiver, or a transceiver.

At least one (e.g., each) local controller can be disposed in a separate location from the device it controls or be integrated into the device. In the example shown in FIG. 8, ten electrochromic windows of building 801 are depicted as controlled by master controller 803. In a setting there may be a larger number of devices in an enclosure controlled by master controller 803.

In some embodiments, the control system may comprise, or be operatively (e.g., communicatively) coupled to, a BMS. By incorporating a (e.g., feedback) control scheme, a BMS and/or control system can provide enhanced: (1) environmental control, (2) energy savings, (3) security, (4) flexibility in control options, (5) improved reliability and usable life of other systems (e.g., coordination of systems may reduce overall operating time of individual systems, leading to less system maintenance), (6) information availability and diagnostics, and/or (7) effective use of, and higher productivity from, staff, and any combination thereof (e.g., because the electrochromic windows can be automatically controlled). In some embodiments, (i) a BMS may not be present, (ii) a BMS may be present but may not communicate with a control system (e.g., with a master controller), or (iii) a BMS may communicate at a high level with the control system (e.g., with a master controller). In certain embodiments, maintenance on the BMS would not interrupt control of the one or more devices (e.g., electrochromic windows) to which the BMS and/or control system is coupled to.

In some embodiments, the BMS and/or the control system controls ventilation within an enclosure. A ventilation system (e.g., as part of an HVAC system) may providing a comfortable environment and good atmospheric (e.g., air) quality. A ventilation system may have significant energy demands. Providing good atmospheric quality to occupants of an enclosure may result in increased wellbeing, comfort, and/or productivity. Such enclosures (e.g., facilities) may be occupied by large number of individuals and/or may be occupied by frequently changing individuals. Such enclosures may include large work environments, health and/or entertainment centers. For example, transportation hubs, sporting hubs, hospitals, exhibition centers, shopping malls, financial centers, movie theaters, museums, and/or cruise ships. The ventilation of an enclosure can exchange the internal environment of the enclosure with the external environment. For example, the ventilation system can bring in outside atmosphere and evacuate inside atmosphere to the environment external to the enclosure (e.g., outside of the facility). The exchange of external and internal atmosphere may adjust one or more components of the internal atmosphere. For example, the exchange of external and internal atmosphere (e.g., by the ventilation system) may reduce any accumulates atmospheric components emitted within the enclosure (e.g., CO₂ from human respiration and VOCs emanating from human breath, saliva, and skin). For example, the exchange of external and internal atmosphere (e.g., by the ventilation system) may alter the levels of oxygen and/or humidity (when their internal and external levels differ). Industry standard(s) may provide recommended ventilation flow rates based at least in part on full occupancy (e.g., number of people), room size, and/or type of facility (e.g., people in an office space generate less CO₂/VOCs than in a gym). Operating a ventilation rate at the recommendation of the industry standard(s) may (e.g., significantly) over-ventilate the enclosure (e.g., when an enclosure (e.g., a room) is occupied at less than maximum occupancy), which may leads to an undesirable energy waste. In addition, a ventilation system may utilize a mixture of outside atmosphere and recirculated inside atmosphere (e.g., at an unknown ratio) for its ventilation. Since the quantity of external atmosphere (e.g., one or more component thereof) may be unknown, the concentration of atmospheric components (e.g., pollutants) may varied (e.g., increased or decreased) to an undesirable level. Further, levels of the atmospheric component(s) may vary as a function of occupancy (e.g., when they are emitted by the occupant), and thus a constant ventilation rate may inadequately maintain a requested indoor environmental atmosphere. Thus, it would be desirable to optimize ventilation rates in a manner that optimizes both the concentration of the one or more atmospheric component of the enclosure, and energy use of the enclosure (e.g., of the ventilation system servicing the enclosure).

In some embodiments, a ventilation system (E.g., as part of an HVAC system) supplies conditioned, fresh, external, and/or recirculated atmosphere to an enclosure. The ventilation system may include a heat pump and/or gas (e.g., air) handler. The gas handler may include one or more blowers (e.g., single speed or variable speed), one or more mixing chambers, one or more filters, one or more dampers, and/or one or more ducts. The ventilation system may deliver conditioned atmosphere to an enclosure (e.g., a room such as an office, a conference room, a cafeteria, a corridor, an elevator, or a lobby) via delivery and/or return ducts. In some embodiments, one or more sensors or sensor ensembles in an enclosure are configured to (e.g., and do) measure concentration of one or more atmospheric components, room occupancy, and/or ventilation flow rate. In some embodiments, sensed (e.g., measured) quantities are utilized to estimate the concentration of atmospheric components, zone (e.g., room) occupancy, or ventilation rate. A control system may use the sensed and/or the estimated concentration of the (i) atmospheric component, (ii) occupancy, and/or (iii) ventilation rate, together with knowledge of an outside (fresh air) concentration of the atmospheric component(s), to issue commands to the ventilation system. The commands to issue to the ventilation system may be for adjusting ventilation rates to optimize atmospheric quality in the enclosure, and energy usage of the enclosure (e.g., of the ventilation system servicing the enclosure). In some embodiments, combining atmospheric components(s) (such as VOC, particulate matter, or CO₂) detection and occupancy detection enables calculation of an existing ventilation rate and estimating what ventilation rate is needed to purge stale atmosphere in a given amount of time. The particulate matter may comprise particles associated with smoke and/or soot (e.g., having a FLS of at most one micrometer). The particulate matter sensor may be utilized to detect smoke and/or fire in the facility (or in the vicinity thereof). Particulate matter may affect the air quality (e.g., per air quality index). A rate of change in the atmospheric component(s) can be used to predict future levels and proactively control ventilation (with or without taking occupancy into account). Furthermore, by obtaining indoor and outdoor measurements of particulate matter, a filter efficiency can be evaluated in order to detect a need for any filter changing and/or pathogen buildup.

In some embodiments, the particulate matter sensor may use sensing an optical density of a body of gas (e.g., air), e.g., through which an energy beam travels. The particular matter sensor may measure a dispersion (e.g., dispersion pattern) of the energy beam as it travels through the body of gas. The particulate matter sensor may measure an intensity (e.g., an optical density) of the energy beam after it has passed through the body of gas, e.g., as compared to that of the energy beam as it is entering into the body of gas (e.g., as it is emitted from the energy source such as from a laser). The particulate matter sensor may utilize an energy beam that travels through a body of gas, e.g., and is dispersed on encountering a particulate matter in that body of gas (e.g., air). The energy beam may comprise a laser beam. The laser beam may be configured to an energy of at least 500 nanometers (nm), 525 nm, 550 nm, 600 nm, 650 nm, 660 nm, 700 nm, 750 nm, or 800 nm. The energy beam may comprise an infrared (IR) energy beam. The particulate matter may sese at a frequency of every 1 second (sec), 2.5 sec, 5 sec, 7.5 sec, 10 sec, 20 sec, 30 sec, or 60 sec. The particulate matter may be configured to sense at least nanometer, or micrometer sized particles. The particulate matter sensed by a particulate matter sensor may comprise particles of a FLS (e.g., diameter or diameter of its bounding circle) of at least a nanometer or a micrometer scale. For example, the particulate matter sensed by the particulate matter sensor may be of a FLS of at least 1 micrometer (μm), 2 μm, 2.5 μm, 5 μm, 7 μm, 10 μm, or 20 μm. The particulate matter sensed by the particulate matter sensor may be of any value between the aforementioned values, e.g., from about 1 μm (PM₁) to about 20 μm (PM₂₀), from about 1 μm (PM₁) to about 5 μm (PM₅), from about 2.5 μm (PM_{2.5}) to about 10 μm (PM₁₀), or from about 5 μm (PM₅) to about 20 μm (PM₂₀). The particulate matter sensor alone or in conjunction with data of other sensor(s) (e.g., VOC sensor, light sensor, noise sensor, and/or personnel ID sensor) may be utilized to monitor, notify, and/or optimize cleaning service in a facility. For example, the sensor(s) may be utilized to alert that a cleaning service is required in a portion (e.g., an enclosure) of a facility, e.g., based on sensing elevated foul odor, elevated particulate matter, and/or high number of personnel (e.g., beyond a threshold value, and/or as a function of time such as at a certain timespan). For example, the sensor(s) may be utilized to alert that a cleaning service is taking place in a portion (e.g., an enclosure) of a facility, e.g., based on sensing elevated VOC levels associated with cleaning supplies and/or particulate matter emitted during cleaning, noise of the cleaning machine, sensing ID of the cleaning personnel, and/or turning light on an off as the cleaning personnel passes through the facility. Such monitoring may allow cleaning a facility on demand, e.g., based on sensor(s), e.g., as opposed to following a scheduled cleaning service that is not sensitive to the degree of cleaning required. Such sensor(s) may also allow monitoring the rate of cleaning, certain aspects regarding the manner of cleaning (e.g., level of cleaning supplies utilized, time it takes to clean certain areas of the facility, sequence of cleaning, cleaning path, or any combination thereof). The sensor(s) (e.g., along or in synergy) may be utilized to detect odor detection in a facility (e.g., enclosure thereof such as a restroom or an office). The enclosure may constitute a space type, e.g., any space type disclosed herein. The odor may comprise volatile organic compound(s). The synergy may be of data from one sensor type with data from other sensor type(s). The synergy may be of data from one sensor type with data from other sensor of the same type. At least two of the sensor types may be disposed at (e.g., approximately) the same location, e.g., as part of a device ensemble. At least two of the sensor types may be disposed at different locations. The sensor(s) may be disposed internally in the facility (e.g., in the enclosure).

In some embodiments, an occupant in a zone is discovered and/or located via locating technology (e.g., auto-location technology). At least a portion of the locating technology may be embedded in an identification tag of an occupant (e.g., as a microchip). In some embodiments, and identification (ID) tag of a user can include a micro-chip. The micro-chip can be a micro-location chip. The micro-chip can incorporate auto-location technology (referred to herein also as “micro-location chip”). The micro-chip may incorporate technology for automatically reporting high-resolution and/or high accuracy location information. The auto-location technology can comprise Global Positioning System (GPS), Bluetooth, or radio-wave technology. The auto-location technology can comprise electromagnetic wave (e.g., radio wave) emission and/or detection. The radio-wave technology may be any RF technology disclosed herein (e.g., high frequency, ultra-high frequency, super high frequency. The radio-wave technology may comprise UWB technology. The micro-chip may facilitate determination of its location within an accuracy of at most about 25 centimeters, 20 cm, 15 cm, 10 cm, or 5 cm. In various embodiments, the control system and/or antennas (that are operatively coupled to the network) are configured to communicate with the micro-location chip. In some embodiments, the ID tag may comprise the micro-location chip. The micro-location chip may be configured to broadcast one or more signals. The signals may be omnidirectional signals. One or more component operatively coupled to the network may (e.g., each) comprise the micro-location chip. The micro-location chips (e.g., that are disposed in stationary and/or known locations) may serve as anchors. By analyzing the time taken for a broadcast signal to reach the anchors within the transmittable distance of the ID-tag, the location of the ID tag may be determined. One or more processors (e.g., of the control system) may perform an analysis of the location related signals. For example, the relative distance between the micro-chip and one or more anchors and/or other micro-chip(s) (e.g., within the transmission range limits) may be determined. The relative distance, know location, and/or anchor information may be aggregated. At least one of the anchors may be disposed in a floor, ceiling, wall, and/or mullion of a building. There may be at least 1, 2, 3, 4, 5, 8, or 10 anchors disposed in the enclosure (e.g., in the room, in the building, and/or in the facility). At least two of the anchors may have at least of (e.g., substantially) the same X coordinate, Y coordinate, and Z coordinate (of a Cartesian coordinate system).

In some embodiments, a control system enables locating and/or tracking one or more devices (e.g., comprising auto-location technology such as the micro location chip) and/or at least one user carrying such device. The relative location between two or more such devices can be determined from information relating to received transmissions, e.g., at one or more antennas and/or sensors. The location of the device may comprise geo-positioning and/or geolocation. The location of the device may an analysis of electromagnetic signals emitted from the device and/or the micro-location chip. Information that can be used to determine location includes, e.g., the received signal strength, the time of arrival, the signal frequency, and the angle of arrival. When determining a location of the one or more devices from these metrics, a triangulation module may be implemented. The triangulation module may comprise a calculation and/or algorithm. The triangulation may account for and/or utilize the physical layout of a building. The auto-location may comprise geolocation and/or geo-positioning. Examples of location methods may be found in International Patent Application Serial No. PCT/US17/31106, filed May 4, 2017, titled “WINDOW ANTENNAS,” which is incorporated herein by reference in its entirety.

In some embodiments, pulse-based ultra-wideband (UWB) technology (e.g., ECMA-368, or ECMA-369) is a wireless technology for transmitting large amounts of data at low power (e.g., less than about 1 millivolt (mW), 0.75 mW, 0.5 mW, or 0.25 mW) over short distances (e.g., of at most about 300 feet (′), 250′, 230′, 200′, or 150′). The short distances can be of at most about 100 meters (m), 90 m, 80 m, 70 m, 60 m, 50 m, 40 m, 30 m, 20 m, 15 m, 10 m or 5 m. A UWB signal can occupy at least about 750 MHz, 500 MHz, or 250 MHz of bandwidth spectrum, and/or at least about 30%, 20%, or 10% of its center frequency. The UWB signal can be transmitted by one or more pulses. A component broadcasts digital signal pulses may be timed (e.g., precisely) on a carrier signal across a number of frequency channels at the same time. Information may be transmitted, e.g., by modulating the timing and/or positioning of the signal (e.g., the pulses). Signal information may be transmitted by encoding the polarity of the signal (e.g., pulse), its amplitude and/or by using orthogonal signals (e.g., pulses). The UWB signal may be a low power information transfer protocol. The UWB technology may be utilized for (e.g., indoor) location applications. The broad range of the UWB spectrum comprises low frequencies having long wavelengths, which allows UWB signals to penetrate a variety of materials, including various building fixtures (e.g., walls). The wide range of frequencies, including the low penetrating frequencies, may decrease the chance of multipath propagation errors (without wishing to be bound to theory, as some wavelengths may have a line-of-sight trajectory). UWB communication signals (e.g., pulses) may be short (e.g., of at most about 70 cm, 60 cm, or 50 cm for a pulse that is about 600 MHz, 500 MHz, or 400 MHz wide; or of at most about 20 cm, 23 cm, 25 cm, or 30 cm for a pulse that is has a bandwidth of about 1 GHz, 1.2 GHz, 1.3 GHz, or 1.5 GHz). The short communication signals (e.g., pulses) may reduce the chance that reflecting signals (e.g., pulses) will overlap with the original signal (e.g., pulse).

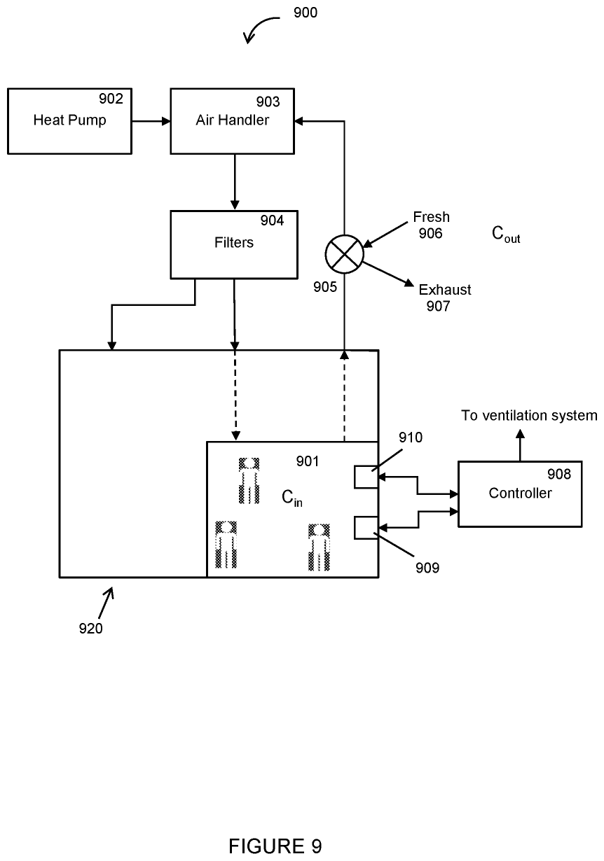

FIG. 9 depicts a ventilation system 900 for ventilating an enclosure (e.g., room) 901 in a building 920. A heat pump 902 provides a heated or cooled heat exchange media to a gas handling system having blowers 903, filters 904, and mixing chamber 905. After filtration, conditioned atmosphere is delivered to room 901 and mixes with the atmosphere in room 901 resulting in an inside atmospheric component concentration Cᵢₙ. Return atmosphere from room 901 is ducted to mixing chamber 905 where some or all may be directed to an exhaust 907 and replaced by fresh atmosphere (e.g., air) 906 having an ambient outside atmospheric component concentration Cₒᵤₜ. A controller 908 may be part of a controller network in building 920 for controlling, e.g., one or more devices (e.g., tintable windows) and/or other aspects of a BMS. Controller 908 is coupled to sensors 909 and 910 deployed in room 901 to monitor environmental characteristics such as atmosphere component concentration (e.g., CO₂, VOC, and/or particulate matter concentration). Controller 908 may be configured to perform operations that identify adjustments to a ventilation rate that optimizes atmospheric component concentration and atmosphere quality, and the adjustments are transmitted to the ventilation system 900 (e.g., directly or via a BMS).

Industry standards (e.g., from the American Society of Heating, Refrigerating and Air-Conditioning Engineers under ANSI) recommend a minimum ventilation rate defined according to a size (e.g., floor space or room volume) of an enclosure (e.g., room), enclosure occupancy, and use case (e.g., an office). Occupancy and/or use case may indicate a requested level of the creation of atmospheric components (e.g., pollutants) (e.g., such as CO₂, hydrogen, methane, and/or VOCs) generated in the room. Occupancy and/or use case may indicate a requested level of any required components (e.g., oxygen and/or humidity). A mass balance equation can be used to calculate a necessary ventilation rate (e.g., including intake of external atmosphere (e.g., fresh air)) to maintain a requested concentration in the room. The external atmosphere may have a lower concentration of the atmospheric component (e.g., accumulant or depletant) as compared to the concentration of that component in the atmosphere of the enclosure. The external atmosphere may have a higher concentration of the atmospheric component (e.g., humidity) as compared to the concentration of that component in the atmosphere of the enclosure. A target (e.g., optimum such as maximum or minimum) concentration of the atmospheric component to be maintained may be different (e.g., higher or lower) than an outdoor concentration. For an accumulant (e.g., VOC, or CO₂) the target may be a maximum optimum. For a depletant (e.g., O₂), the target may be a minimum optimum. At a maximum room occupancy, a minimum ventilation rate can be determined, e.g., by considering the standard recommendations and/or ventilation rate lookup table, so that the target concentration of the component is maintained at or below a threshold. The threshold can be a value, or a function (e.g., temperature dependent function). The target concentration may be specified in terms of a differential concentration (ΔPOL) between in the internal concentration of the component in the enclosure (Cᵢₙ) and an external concentration of the component out of the enclosure (Cₒᵤₜ), e.g., concentration in the ambient atmosphere. If the minimum ventilation rate for maximum occupancy is maintained during times of lower occupancy within the room, then over-ventilation is likely to occur. The (e.g., health and/or jurisdictional) standards may recommend a lower minimum ventilation rate threshold, e.g., for lower occupancy levels within the enclosure (e.g., room). However, such recommendations may over-ventilate the enclosure (even at the lower occupancy levels). Thus, an accurate ventilation rate that relies of (e.g., real time and/or in-situ) sensor measurements may provide a more accurate guideline, may facilitate reduction of energy (e.g., of the ventilation system), and/or may facility reduction in operational cost (e.g., ventilation cost) as compared to following the guidelines. The lookup table may consider (and/or delineate) the zone type (e.g., building part type such as office, conference room, corridor, lobby, etc.), relative geographical location of the zone (e.g., in relation to the sun and/or building), weather condition, zone surface area, zone volume, zone temperature, and/or expected activity in the zone (e.g., exercise in a gym, eating in a cafeteria, talking in a conference room, quiet work in an office). Data in the lookup table may be utilized to estimate the requested ventilation rate. For example, more oxygen is consumed by occupants of a gym as compared to those of an office of the same (e.g., approximate) size. For example, more humidity, VOC, and CO₂ are expelled by occupants of a gym as compared to occupants of an office of the same (e.g., approximate) size. For example, more VOCs are expelled by occupants and/or become otherwise volatile in a hot room (e.g., in a south directed room), than in a cooler room (e.g., in a north directed room).

In some embodiments, at least one of the atmospheric components is a VOC. The atmospheric component (e.g., VOC) may include benzopyrrole volatiles (e.g., indole and skatole), ammonia, short chain fatty acids (e.g., having at most six carbons), and/or volatile sulfur compounds (e.g., Hydrogen sulfide, methyl mercaptan (also known as methanethiol), dimethyl sulfide, dimethyl disulfide and dimethyl trisulfide). The atmospheric component (e.g., VOC) may include 2-propanone (acetone), 1-butanol, 4-ethyl-morpholine, Pyridine, 3-hexanol, 2-methyl-cyclopentanone, 2-hexanol, 3-methyl-cyclopentanone, 1-methyl-cyclopentanol, p-cymene, Octanal, 2-methyl-cyclopentanol, Lactic acid, methyl ester, 1,6-heptadien-4-ol, 3-methyl-cyclopentanol, 6-methyl-5-hepten-2-one, 1-methoxy-hexane, Ethyl (−)-lactate, Nonanal, 1-octen-3-ol, Acetic acid, 2,6-dimethyl-7-octen-2-ol (dihydromyrcenol), 2-ethyl hexanol, Decanal, 2,5-hexanedione, 1-(2-methoxypropoxy)-2-propanol, 1,7,7-trimethylbicyclo[2·2·1]heptan-2-one (camphor), Benzaldehyde, 3,7-dimethyl-1,6-octadien-3-ol (linalool), 1-methyl hexyl acetate, Propanoic acid, 6-hydroxy-hexan-2-one, 4-cyanocyclohexene, 3,5,5-trimethylcyclohex-2-en-1-one (isophoron), Butanoic acid, 2-(2-propyl)-5-methyl-1-cyclohexanol (menthol), Furfuryl alcohol, 1-phenyl-ethanone (acetophenone), Isovaleric acid, Ethyl carbamate (urethane), 4-tert-butylcyclohexyl acetate (vertenex), p-menth-1-en-8-ol (alpha-terpineol), Dodecanal, 1-phenylethylester acetic acid, 2(5H)-furanone, 3-methyl, 2-ethylhexyl 2-ethylhexanoate, 3,7-dimethyl-6-octen-1-ol (citronellol), 1,1′-oxybis-2-propanol, 3-hexene-2,5-diol, 3,7-dimethyl-2,6-octadien-1-ol (geraniol), Hexanoic acid, Geranylacetone³, 2,4,6-tri-tert-butyl-phenol, Unknown, 2,6-bis(1,1-dimethylethyl)-4-(1-oxopropyl)phenol, Phenyl ethyl alcohol, Dimethylsulphonec, 2-ethyl-hexanoic acid, Unknown, Benzothiazole, Phenol, Tetradecanoic acid, 1-methylethyl ester (isopropyl myristate), 2-(4-tert-butylphenyl)propanal (p-tert-butyl dihydrocinnamaldehyde), Octanonic acid, α-methyl-β-(p-tert-butylphenyl)propanal (lilial), 1,3-diacetyloxypropan-2-yl acetate (triacetin), p-cresol, Cedrol, Lactic acid, Hexadecanoic acid, 1-methylethyl ester (isopropyl palmitate), 2-hydroxy, hexyl ester benzoic acid (hexyl salicylate), Palmitic acid, ethyl ester, Methyl 2-pentyl-3-oxo-1-cyclopentyl acetate (methyl dihydrojasmonate or hedione), 1,3,4,6,7,8-hexahydro-4,6,6,7,8,8-hexamethyl-cyclopenta-gamma-2-benzopyran (galaxolide), 2-ethylhexylsalicylate, Propane-1,2,3-triol (glycerin), Methoxy acetic acid, dodecyl ester, α-hexyl cinnamaldehyde, Benzoic acid, Dodecanoic acid, 5-(hydroxymethyl)-2-furaldehyde, Homomethylsalicylate, 4-vinyl imidizole, Methoxy acetic acid, tetradecyl ester, Tridecanoic acid, Tetradecanoic acid, Pentadecanoic acid, Hexadecanoic acid, 9-hexadecanoic acid, Heptadecanoic acid, 2,6,10,15,19,23-hexamethyl-2,6,10,14,18,22-tetracosahexaene (squalene), Hexadecanoic acid, and/or 2-hydroxyethylester.

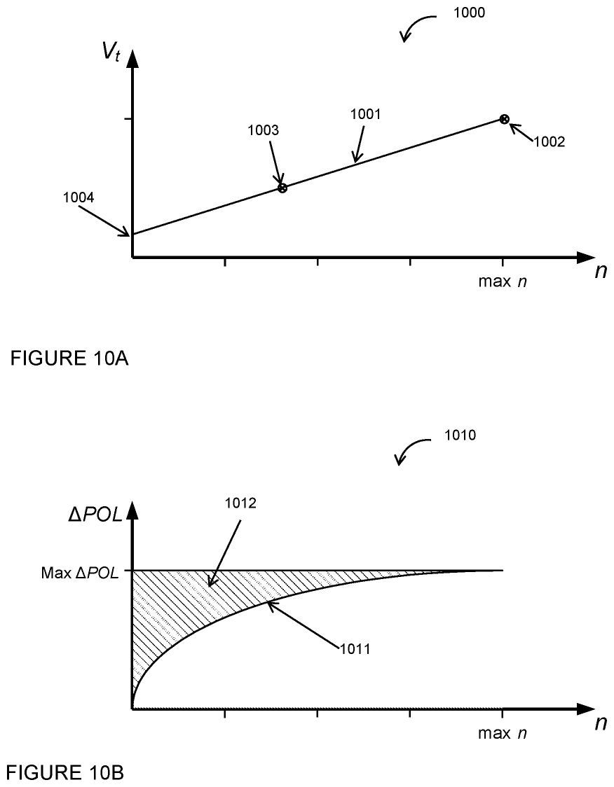

FIG. 10A depicts a graph 1000 plotting enclosure (e.g., room) occupancy as a function of minimum ventilation rates facilitating that a maximum differential concentration (max ΔPOL) is not exceeded at any occupancy level of the enclosure. For example, a curve 1001 specifies a total ventilation rate (Vₜ) to be delivered for levels of occupancy (n) up to a maximum occupancy (max n). Curve 1001 may, for example, be derived according to an industry standard according to a formula:

Minimum_Ventilation_Rate=Vₜ=7.5·n+0.06·Area

(with the symbol “·” designates the mathematical operation “times,” or “multiplied by”). In this formula, (Vₜ) is measured cubic feet per minute (cfm), Area is measured as square foot floor area of the enclosure, and the coefficients 7.5 and 0.06 are specified in the standard according to the use case of the space being (e.g., an office space), and the atmospheric component being carbon dioxide. It should be noted that even at zero occupancy, a positive ventilation rate is specified 1004. As used herein, a concentration of an atmospheric component (e.g., accumulant, depletant, or other gaseous or gas borne component) may be in a first concentration regime when greater than a target concentration and in a second concentration regime when less than the target concentration. The target concentration may correspond to the maximum differential concentration (max ΔPOL) inherent in a (e.g., jurisdictional and/or health) standard, or selected according to any other requested criterion.

FIG. 10B depicts a graph 1010 plotting enclosure (e.g., room) occupancy and differential atmospheric component (e.g., carbon dioxide) concentration ΔPOL as a curve 1011 that results if the ventilation rate equals the minimum ventilation rate Vₜ from FIG. 10A (assuming environmental component generation by the occupants is as expected). The maximum differential concentration (max ΔPOL) is approached only at maximum occupancy in the enclosure. If the ventilation rate is set at the minimum rate for maximum occupancy, then over-ventilation occurs in a region 1012 of graph 1010. Even if a variable ventilation rate according to curve 1001 matching a measured occupancy is used, the recommended standards typically result in over-ventilation. A detailed numerical example using carbon dioxide as an atmospheric component is as follows. In FIG. 10A, a data point 1002 corresponds to a maximum occupancy of 65 people in a room of 1000 ft² (of about 92.9 m²) floor space, where a minimum ventilation rate is specified to be at about 550 cfm (at about 934.5 cubic meters per hour (m³/h)). A mass balance equation can be used to model a steady state as follows:

$$\frac{V ( t )}{n} = \frac{G}{Δ POL}$$

where G is the per person generation rate of the atmospheric component. A typical CO₂ generation rate may be about 0.0105 cfm (may be about 0.0178 m³/h) per occupant, for example. Solving for ΔPOL at the maximum occupancy of 65 yields a max ΔPOL of 1250 ppm (e.g., if ambient outside CO₂ is at 400 ppm then CO₂ concentration in the room at the minimum ventilation rate is limited to about 1650 ppm). In FIG. 10A, a data point 1003 corresponds to an occupancy level of 20 people in the same room of 1000 ft² (of about 92.9 m²) floor space, where a minimum ventilation rate is specified at about 210 cfm (at about 357 m³/h). At a ventilation rate of 210 cfm (at about 357 m³/h) with 20 people, the actual steady state atmospheric component differential ΔPOL would be 1000 ppm, which represents over-ventilation whenever a ΔPOL of 1250 ppm has been selected to represent an acceptable atmosphere quality. Thus, an actual characterization of the atmospheric component concentration and/or the current or future rate of generation of the atmospheric component could provide improved ventilation control that would avoid under-ventilation and over-ventilation. In some embodiments or in some situations (e.g., a pandemic), a building manager may determine that a higher level of atmosphere quality should be adopted than what is embodied in the industry standard. Using a measured or estimated ΔPOL, ventilation rate may be further increased to obtain lower concentration of an atmospheric component. However, sensing errors in determining ΔPOL may be greater at lower magnitudes. The modeling shown herein has a good performance when the difference between indoor atmospheric component (e.g., CO₂) levels and outdoor atmospheric component levels is at least 200 ppm, 300 ppm, 400 ppm, or 500 ppm.

In some embodiments, sensor data (e.g., both indoor and outdoor) for atmospheric component(s) of interest (e.g., depletant such as O₂, accumulant such as CO₂) is used in conjunction with occupancy sensor, to estimate a level of the atmospheric component(s) in an enclosure, and/or distribution of the atmospheric component(s) in the enclosure. Sensors (e.g., differential pressure sensors) for measuring ventilation flow rates in ducts and/or into particular rooms, are not used due to high cost and/or low accuracy. Even when present, a gas flow and/or a pressure sensor cannot detect the makeup of the gas(es) (e.g., that arrive from an ambient outdoor environment and/or are recirculated in the enclosure). Absence of gas makeup detection hinders and/or compromises determination of (i) the actual accurate flow rate of external atmosphere (e.g., fresh air) into the enclosure, and/or (ii) the quality of the atmosphere in the enclosure (e.g., at a given time). The enclosure, a portion of the enclosure, or a group of enclosures, can define a zone. In some embodiments, inhabitant population of a zone, area and/or volume of the zone, and typical per-person generation and/or consumption rates of the atmospheric component(s) are used to calculate a difference between atmospheric component(s) levels inside the zone and atmospheric component(s) levels outside of the zone. The zone can be an enclosure. Some atmospheric components of interest are accumulants as occupants expel them. Some atmospheric components of interest are depletants as occupants consume and thus deplete them. An assumption may be used that each person expels an average atmospheric component(s) of interest (e.g., VOC, and/or CO₂) rates. An assumption may be used that each person consumes an average atmospheric component(s) of interest (e.g., O₂) rates.

In some embodiments, room occupancy, ventilation rate, and ΔPOL for one or more component(s) are related such that any one of them can be derived (e.g., calculated) from the other two. In some embodiments, occupancy (n) is calculated from measured ΔPOL (e.g., ΔCO₂ or ΔVOC) and known gas-flow rate. In some embodiments, ΔPOL is determined (e.g., calculated) from known gas-flow rate and occupancy data. The occupancy data may be detected occupancy (e.g., using an occupancy sensor). The occupancy data may consider a schedule. The occupancy data may consider historical occupancy data and/or predictive logic (e.g., using learning algorithm(s)). The learning algorithms may utilize historic data, and/or projected schedule as a learning set to predict occupancy in the enclosure. The predicted occupancy may be based on a schedule (e.g., calendar) for the enclosure and/or for the facility in which the enclosure is disposed. The schedule may be an electronic schedule. The schedule may be considered by the control system. In some embodiments, a gas-flow rate is determined from occupancy data (e.g., detected and/or projected) and measure ΔPOL. In some embodiments, once all three parameters are obtained, they can be used for regulating (e.g., with increased accuracy) ventilation rate and/or atmospheric (e.g., air) quality in the zone (e.g., enclosure). In some embodiments, measured and/or determined (e.g., calculated) values of ΔPOL (e.g., alone) are used for gross adjustment of ventilation rate (e.g., either increased or decreased rate) according to whether the actual ΔPOL is greater than or less than the target ΔPOL.

In some embodiments, a control system (e.g., comprising a processor) is adapted to control, identify and/or implement changes in a ventilation rate. Control identification and/or implementation can be according to one or more of the relationships delineated herein, e.g., between zone occupancy, ventilation rate, and ΔPOL. The control system (e.g., a controller and/or processor thereof) may store and/or retrieve one or more parameters and/or configuration data, e.g., depending upon the control actions to be performed and/or the sensor data available. For example, stored parameters may include occupancy (e.g., real time, and/or maximum occupancy), a minimum ventilation rate (e.g., a standard curve and/or ventilation zone mapping), a target (e.g., average, mean, maximum, or minimum) atmospheric component concentration, and/or a differential of the target atmospheric component concentration (e.g., ΔPOL). The control system (e.g., a controller and/or processor thereof) may be configured to store values for the zone (e.g., room) occupancy, actual current ventilation rate in the zone, and/or atmospheric component concentration (e.g., indoor concentration, outdoor concentration, target concentration, and/or differential concentration ΔPOL). At least one of the stored values may be an estimated value derived from measured values for one or more (e.g., two or more) of the other parameters. Based at least in part on a determination of the stored values, the control system may output a change in the ventilation rate such that atmospheric quality in the zone (e.g., in the enclosure) is properly maintained, e.g., while minimizing energy waste (e.g., through over-ventilation). Adjustment to the ventilation flow rate may include a relative change to the ventilation flow rate or an absolute value for a new ventilation flow rate (e.g., when the ventilation system is configured to respond to commands for an absolute ventilation flow rate). A relative change may be proportional to a difference between the actual current ventilation rate and the target ΔPOL, or may be comprised of a predetermined incremental step size in the ventilation flow rate.

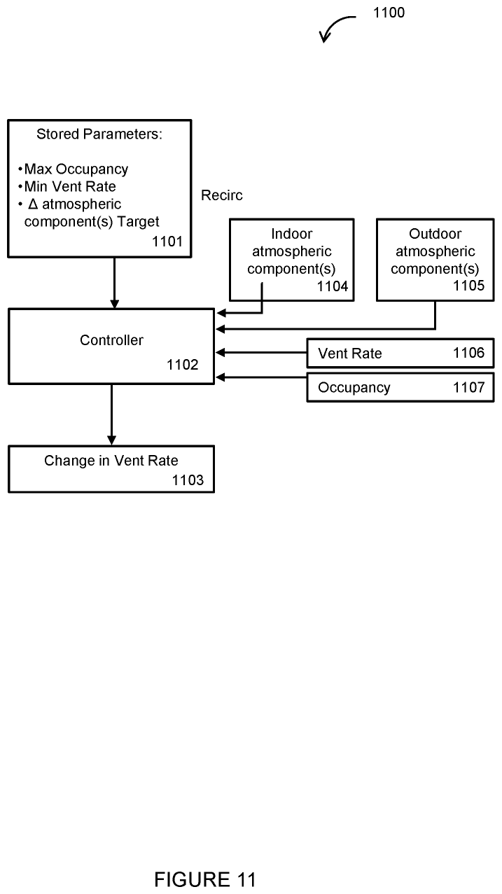

FIG. 11 depicts a control system 1100 configured to control ventilation. An electronic memory 1101 stores parameters such as maximum occupancy, minimum ventilation rate, maximum ventilation rate, target ventilation rate, and/or target ΔPOL. The parameter(s) are used in a control system block 1102 in an analysis (e.g., including calculations) to output a changed (e.g., altered) ventilation rate 1103. Provided that corresponding sensors are available, control system block 1102 obtains measured actual indoor (e.g., in situ) atmospheric component concentration 1104 (e.g., in real time), measured actual outdoor atmospheric component concentration 1105 (e.g., in real time), measured actual ventilation rate 1106 (e.g., in real time), and/or measured actual occupancy 1107 (e.g., in real time). When one or more sensors (e.g., sensor types) are not available to facilitate the measured data, then control system block 1102 may use available (e.g., historically measured and/or projected) values to determine (e.g., estimate and/or project) the corresponding actual values as necessary.

In some embodiments, a control system (e.g., a controller) may be configured to adapt a ventilation rate to maintain a requested atmosphere quality according to a zone (e.g., enclosure) occupancy and/or target atmospheric component levels for one or more atmospheric components. Zone occupancy may be measured, estimated, and/or determined (e.g., calculated). For example, without knowing an absolute ventilation rate, the ventilation rate can be adjusted relative to current ventilation rate, e.g., according to a difference between measured atmospheric component(s) and the target atmospheric component(s) (e.g., pollutants, depletants, and/or accumulants). A measured zone (e.g., room) occupancy may be obtained using locating technologies. The location technologies may comprise geolocation. The location technologies may utilize one or more sensors (e.g., an IR sensor array for detecting body heat signatures, a camera for identifying people using pattern recognition techniques on acquired images, or UWB tracking receivers for detect user security badges) and/or use scheduling information (e.g., an online calendar for booking a conference room). In some embodiments, the occupancy data may be used to determine a minimum ventilation rate according to an industry standard and/or other empirical relationship. While maintaining the minimum ventilation rate, one or more sensors deployed in the zone (e.g., room) may monitor atmospheric component concentration affecting atmosphere quality (e.g., O₂, CO₂, VOCs, humidity, and PM). The atmospheric component(s) may be measured both inside the enclosure and outdoors to obtain a differential concentration ΔPOL. In some embodiments, when a ΔPOL for an atmospheric component exceeds a target (e.g., optimum such as maximum or minimum) value, then the ventilation rate is increased to restore a requested atmospheric quality. The increase in ventilation rate may be proportional to the difference between the actual atmospheric component concentration and the target atmospheric component concentration. The increase in ventilation rate may be a predetermined step size. In some embodiments, a plurality (e.g., two or more) of atmospheric components can be controller in the zone (e.g., in the enclosure). The at least two of the plurality of atmospheric components can be controller simultaneously. The at least two of the plurality of atmospheric components can be controller consecutively. At least one of the plurality of atmospheric components can be controller continuously. At least one of the plurality of atmospheric components can be controller intermittently. One or more of the plurality of atmospheric components can be included into recommended changes in the ventilation rate for the zone (e.g., enclosure). Standard ventilation rates relating to one or more of the plurality of atmospheric components can be considered while formulating the recommended changes in the ventilation rate for the zone (e.g., enclosure). When atmospheric components (e.g., or standard ventilation rates thereof) are considered when formulating any change to the ventilation rate, at least two of the atmospheric components can have (e.g., substantially) the same weight, or least two of the atmospheric components can have can be given different weights. For example, the primary atmospheric component being controlled (e.g., monitored and/or adjusted) can be CO₂ while VOCs (from human or other sources, e.g., perspiration, aldehydes from carpet/furnishing, etc.) and/or other substances are monitored and can be given a lesser weight when included into recommended changes to the ventilation rate. The CO₂ levels can be continuously monitored and can be given the greatest weight. The VOC levels can be intermittently monitored and can be given a lesser weight as compared to the weight given to the CO₂ levels.

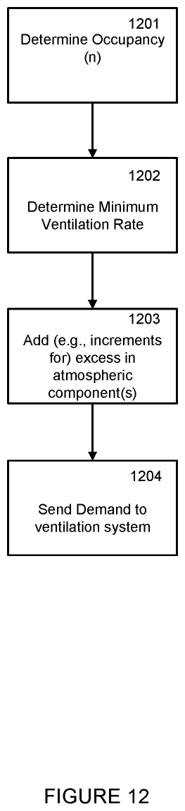

FIG. 12 depicts operation of a control system (e.g., comprising a processor) for controlling an atmosphere in a zone (e.g., an enclosure). Occupancy in a zone (e.g., room) is determined in a block 1201. Determining occupancy may be performed by sensing the number of occupants in the zone using any suitable locating technology (e.g., using occupancy sensor(s)). Present occupancy or a future occupancy may be determined and/or projected (e.g., based at least in part on an electronic calendar, historical data, and/or learning module). In a block 1202, a minimum ventilation rate is determined. The minimum ventilation rate may be determined based at least in part on the occupancy obtained in block 1201. The occupancy may be used to look up a corresponding ventilation rate according to a lookup table and/or an industry standard, e.g., as applied to the dimensions and/or usage type of the enclosure. In block 1203, a further increase in ventilation rate is added in the event that there one or more atmospheric components are at a level that undesirably deviates from the requested level. In block 1204, a demand (e.g., command signal) is sent to the ventilation system to adjust the ventilation flow rate for the room accordingly. A numerical example is as follows. For a 1000 ft² (that is about 92.9 m²) room in an office space, a total gas flow rate at maximum occupancy of 60 people using CO₂ as the controlled variable may be as follows:

Total_Gas flow=7.5×60+0.06×1000=510 cfm (that is about 896 m³/h).

A maximum atmospheric component concentration occurs at this maximum occupancy as follows:

max(ΔCO₂)=60×10500/510=1235 ppm.

Taking outside ambient concentration for CO₂ at 400 ppm, a maximum absolute indoor concentration (C_{design}) is as follows:

C_{design}=ΔCO₂+Cₒᵤₜ=1235+400=1635 ppm.

At a lower room occupancy (e.g., 28 people), the industry standard minimum ventilation rate is:

Total_Gas flow=7.5×28+0.06×1000=270 cfm.

Thus, a ventilation rate command for 270 cfm (that is about 459 m³/h) can be sent to the ventilation system. A steady state differential concentration of CO₂ under this occupancy and ventilation rate is:

ΔCO₂=28×10500/270=1089 ppm.

In the event that a higher atmosphere quality (lower concentration of the atmospheric component) is requested, then an incremental ventilation rate may be requested. For example, in order to limit the differential ΔCO₂ to a value of 800 ppm, the ventilation rate determined above for 28 people would be increased according to a ratio of the differential concentrations as follows:

Requested_Gas flow=270×(1089/800)=368 cfm.

Thus, the ventilation rate would be incremented to 368 cfm (that is about 625 m³/h) for the higher atmosphere quality.

In some embodiments, a ventilation rate is controlled in response to occupancy, a maximum or target atmospheric component concentration, and an actual atmospheric component concentration. For example, ventilation rate may be adjusted up or down in order to provide an exchange of fresh atmosphere into a zone (e.g., an enclosure) to maintain the requested atmospheric component concentration without knowing a proportion of fresh to recirculated atmosphere being supplied, without requiring numerical determination of the actual ventilation rate, and/or without measurement of the actual ventilation rate. In some embodiments, occupancy is measured using at least one sensor operatively (e.g., communicatively coupled) to a network of the building. The at least one of the sensor(s) can be mounted in a sensor ensemble (e.g., a networked module integrating sensor(s), emitter(s) and/or actuator(s)) that may include atmospheric component sensor(s) (e.g., CO₂ sensor, VOC sensor, humidity sensor, oxygen sensor, and/or PM sensor). In some embodiments, occupancy may be inferred (e.g., using the mass balance equation) from atmospheric component concentration measurements, e.g., if an actual fresh atmosphere ventilation rate is available. In some embodiments, an actual atmospheric component differential concentration can be estimated from a known occupancy and actual fresh atmosphere ventilation rate. The actual differential atmospheric component concentration ΔPOL may be compared to a target (e.g., maximum) ΔPOL to determine whether a current ventilation rate should be altered (e.g., increased or decreased). The alteration can be incremental, continuous, linear, or non-linear (e.g., exponential). At least two of the increments of the incremental alteration can be of the same duration. At least two of the increments of the incremental alteration can be of different durations. At least two intermissions of the incremental alteration can be of different durations. At least two intermissions of the incremental alteration can be of the same durations. The duration and/or intermissions of the incremental alteration can follow a linear or non-linear (e.g., exponential) function. If measured atmospheric component(s) ΔPOL is less than maximum ΔPOL atmospheric component(s), then the ventilation gas flow rate may be reduced. The altered gas flow rate may be set to a threshold (e.g., value) expected to reach the target ΔPOL at time t (and thereafter maintain that threshold). The altered gas flow rate may (e.g., briefly, at time<<t) deviate from the target threshold to expediate reaching the target threshold. For example, a reduced gas flow rate may be set to a value expected to reach the target ΔPOL at t (and thereafter maintain it). The reduced gas flow rate may be (e.g., briefly, at time<<t) reduced below the set threshold in order to more quickly reach the target ΔPOL. An absolute value for a target ventilation rate that would be needed to reach and maintain target concentration (e.g., maximum ΔCO2) may be determined based at least in part on actual and/or projected occupancy. For example, a gas flow per person may be calculated by dividing the generation/consumption rate of the atmospheric component(s) by the target differential concentration (e.g., 10500/ΔCO₂), and multiply by the number of occupants in the zone (e.g., enclosure) to calculate the needed ventilation rate, with the demand being set accordingly. In some embodiments, the change in gas flow demand is proportional to a difference between the current atmospheric component(s) ΔPOL and the target ΔPOL. If measured atmospheric component(s) ΔPOL is greater than the optimum (e.g., maximum) atmospheric component(s) ΔPOL, then the ventilation gas flow rate may be increased. A selected time (t) within which a new steady state is reached can be established by controlling a transitional ventilation rate which results in an atmosphere exchange rate (AER) adapted to lower the ΔPOL. For example, an AER can be utilized as follows:

AER=[ln(C_{actual}/C_{design})]/t.

The AER may be used to derive a transitional ventilation rate as follows:

Gas flow Vₜ=AER×Room Volume.

Using a constant transitional ventilation rate can provide a linear slope for the changing differential concentration ΔPOL. In some embodiments, an adaptive, nonlinear slope is obtained by providing a variable ventilation rate during the transition which may be less noticeable (e.g., distracting) to the occupants.

As an example of a transitional ventilation rate, a hypothetical differential concentration ΔCO₂ will be assumed of 2000 ppm with a target max(ΔCO₂) of 1235 ppm. The time to reach the target is 5 minutes. A requested atmosphere exchange rate (using an outside CO₂ of 400 ppm) is as follows:

AER=[ln(2400)−ln(1635)]/5=0.077.

Converting to total gas flow for a 10 foot room height in a 1000 square foot room yields:

Vₜ=AER×Room Volume=0.077×1000×10=770 cfm.

Thus, the indoor CO₂ concentration is reduced to 1635 ppm in 5 minutes using a ventilation rate of 770 cfm. Rather than a constant 770 cfm (that is about 1308 m³/h), a variable rate may be used provided that the average rate over the 5 minute period is 770 cfm.

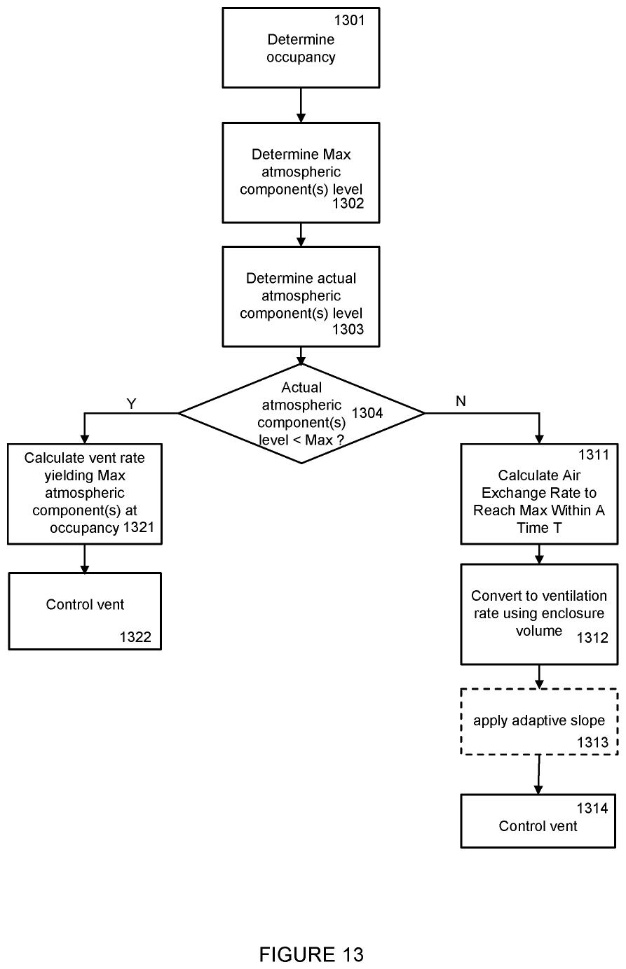

FIG. 13 depicts operations for controlling ventilation rate wherein occupancy is determined in a block 1301. In block 1302, a maximum (e.g., target) atmospheric component level (e.g., target differential atmospheric component concentration ΔPOL) is determined, such as from an industry standard, lookup table, historical data, learning module, and/or from user preferences. An actual atmospheric component level (e.g., actual differential atmospheric component concentration ΔPOL) is determined in block 1303. The actual ΔPOL and the target ΔPOL are compared in block 1304. If actual ΔPOL is less than target ΔPOL (e.g., there is over-ventilation), then a more appropriate ventilation rate corresponding to the present or predicted occupancy level is calculated in block 1321, and the ventilation system is controlled accordingly in block 1322. If actual ΔPOL is greater than target ΔPOL (e.g., there is under-ventilation), then a more appropriate ventilation rate corresponding to the present or predicted occupancy level is calculated in block 1311 together with an incremental atmosphere exchange rate to reach the target ΔPOL within a time T. Based at least in part on the AER needed to transition to steady state at the new ΔPOL value, an incremental ventilation rate is obtained in block 1312 by converting the AER to a gas flow rate by multiplying by the zone (e.g., room) volume. An adaptive slope (if any) can be optionally applied to the transitional gas flow rate in a block 1313, and the ventilation system is controlled (e.g., by the control system and/or BMS) accordingly in block 1314.

In some embodiments, ventilation rates are controlled proactively prior to expected changes in zone (e.g., enclosure such as a room) occupancy so that atmosphere quality may be better maintained, e.g., when occupant(s) may enter or exit a room. For example, historical data recording regular fluctuations in one or more atmospheric component concentrations (e.g., ΔPOL for CO₂ and/or VOCs) can be used to anticipate regular gatherings of people (see, e.g., FIG. 6). Changes in occupancy can be predicted (e.g., anticipated) based at least in part on other data sources such as an online calendar for the room or a particular person associated with the room. For example, electronic scheduling information may provide a planned meeting and attendance list. Using predicted changes in occupancy, atmospheric component generation in the room may be predicted by multiplying per person generation or consumption rates of the atmospheric component(s) according the predicted occupancy. Prior to a substantial change in a combined atmospheric component generation/consumption rate, the ventilation rate bringing fresh atmosphere into the room may be varied to avoid spikes in the differential atmospheric component concentration(s).

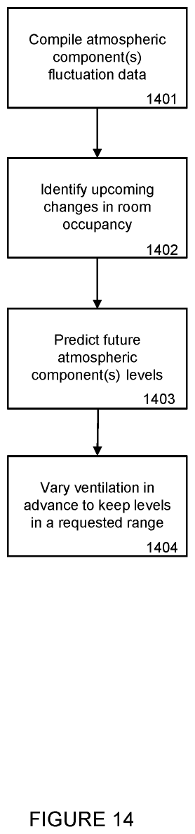

FIG. 14 depicts a procedure for predictively controlling ventilation rate. Atmospheric component fluctuations at various times of day are compiled in block 1401. Upcoming times for which (e.g., recent) data suggests an increase in atmospheric component generation is a likely occur, are identified and targeted for proactive changes in the ventilation rate. In block 1402, predictive occupancy information (e.g., using schedules such as calendar(s), historic data, and/or learning module) is identified. The occupancy information may foretell occupancy changes. In block 1403, future atmospheric component generation/consumption (based at least in part on predicted occupancy) is predicted according to the occupancy information. When a time for any particular predicted change (e.g., rise or decline) in atmospheric component generation approaches, it may be compared to the current occupancy and/or generation/consumption rate of the atmospheric component. If the predicted atmospheric component generation/consumption passes a threshold (either is decreased below a minimum threshold for a depletant, or increased above a maximum threshold for an accumulant), then a corresponding ventilation rate may be calculated in block 1404 to maintain a differential atmospheric component concentration ΔPOL within a requested range (e.g., substantially equal to the target ΔPOL), and the ventilation system is controlled to adjust and/or be maintained accordingly.

In some embodiments, recommendations for changes in a ventilation rate are obtained by activating ventilation mechanisms (e.g., opening and closing of atmosphere handlers). The sensor(s) for measuring atmospheric component concentrations, room occupancy, ventilation pressure, and/or flow rates, may be self-contained. At least two of the sensors (e.g., of different time or of the same type) may be incorporated into a sensor ensemble. One or more sensor ensembles may be disposed in a room being controlled (e.g., monitored). A sensor ensemble may be operatively (e.g., communicatively and/or connectively) coupled to the network. The network may be operatively cooled to the control system and/or BMS. The network may be operatively coupled to the ventilation system. At least a portion of the network may comprise wires disposed in an envelope of an enclosure (e.g., building). A sensor may be configured for continuous or intermittent sensing. The continuous and/or intermittence sensing may be scheduled. For example, scheduling of the sensing can consider the past, present, and/or projected occupancy of the zone of interest. In some embodiments, a sensor ensemble is installed in a window faming (e.g., in a mullion or transom). At least a portion of the devices in the ensemble may be utilized in controlling a tintable window that is operatively coupled to the network (and therethrough to the control system). In some embodiments, the ensemble and/or window framing may incorporates an actuator (e.g., a fan or blower) configured to circulate inside atmosphere and/or exchange atmosphere between the enclosure and the outside ambient atmosphere (as an exhaust and/or an intake). Examples for ventilation system, heat management system components (e.g., fans), smart windows, networks, sensors, and control systems can be found in International Patent Application Serial No. PCT/US15/14453, filed Feb. 4, 2015, titled “FORCED AIR SMART WINDOWS,” which is incorporated herein by reference in its entirety.

In some embodiments, monitoring of atmospheric components and ventilation rates facilitates monitoring of filter efficiency. The filter efficiency may deviate due to accumulated debris (e.g., particular matter). Accumulation of debris on the filter may reduce its filtration efficiency and/or form growth media for pathogens. The efficiency of the filter may be determined using pressure sensor, gas flow sensor, time from filter installation, and/or particulate matter (PM) sensing. Atmosphere quality in an enclosure may depend on the use of filter(s) in an atmosphere handling system to remove various contaminants such as particulate matter (e.g., dust, soot, viruses, bacteria, and/or fungi). Over time, efficiency of a filter declines as it accumulates more and more particulate matter. Based at least in part on (i) knowledge of an outside PM concentration before filtering and an inside PM concentration after filtering (e.g., a differential concentration ΔPOL), (ii) a ventilation rate through the filter (e.g., total volume of contaminated atmosphere treated by the filter per unit time), (iii) time lapse from past installation, (iv) gas pressure before the filter, (v) gas pressure after the filter, (vi) filter morphology, (v) optical density of the gas before the filter, (vi) optical density of the gas after the filter, an actual filter efficiency may be determined and/or estimated. When efficiency of filtration declines below a predetermined threshold from its nominal efficiency, a user (e.g., a building manager) can be notified to perform a corrective action such as a filter replacement. A notification may be generated as a warning message delivered immediately or may be included in a periodically generated report, for example.

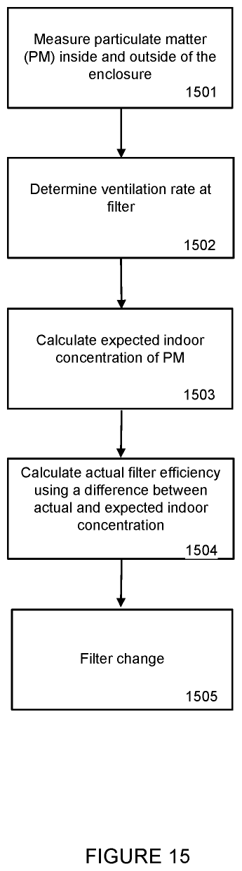

FIG. 15 depicts a procedure wherein particulate matter (PM) concentrations are determined (e.g., measured using PM sensors) for atmosphere inside and outside of an enclosure in block 1501. In block 1502, a ventilation rate (e.g., in cubic feet per minute) is measured or calculated from other measured quantities such as room occupancy and differential CO₂ concentration. Assuming the filter is operating at a nominal filter efficiency, an expected indoor PM concentration is calculated in block 1503 according to the determined outside PM concentration and the determined ventilation rate. In block 1504, an actual filter efficiency is calculated in response to a difference (or a ratio) between the expected indoor PM concentration and the actual indoor PM concentration. In the event that an actual filter efficiency is less than a threshold efficiency (e.g., a discrepancy between actual efficiency and the nominal efficiency is greater than a threshold), a filter change message is sent in block 1505 to a user so that a filter change can be initiated.

Sensors of a sensor ensemble may be organized into a sensor module. A sensor ensemble may comprise a circuit board, such as a printed circuit board, in which a number of sensors are adhered or affixed to the circuit board. Sensors can be removed from a sensor module. For example, a sensor may be plugged and/or unplugged from the circuit board. Sensors may be individually activated and/or deactivated (e.g., using a switch). The circuit board may comprise a polymer. The circuit board may be transparent or non-transparent. The circuit board may comprise metal (e.g., elemental metal and/or metal alloy). The circuit board may comprise a conductor. The circuit board may comprise an insulator. The circuit board may comprise any geometric shape (e.g., rectangle or ellipse). The circuit board may be configured (e.g., may be of a shape) to allow the ensemble to be disposed in a mullion (e.g., of a window). The circuit board may be configured (e.g., may be of a shape) to allow the ensemble to be disposed in a frame (e.g., door frame and/or window frame). The mullion and/or frame may comprise one or more holes to allow the sensor(s) to obtain (e.g., accurate) readings. The circuit board may include an electrical connectivity port (e.g., socket). The circuit board may be connected to a power source (e.g., to electricity). The power source may comprise renewable or non-renewable power source.

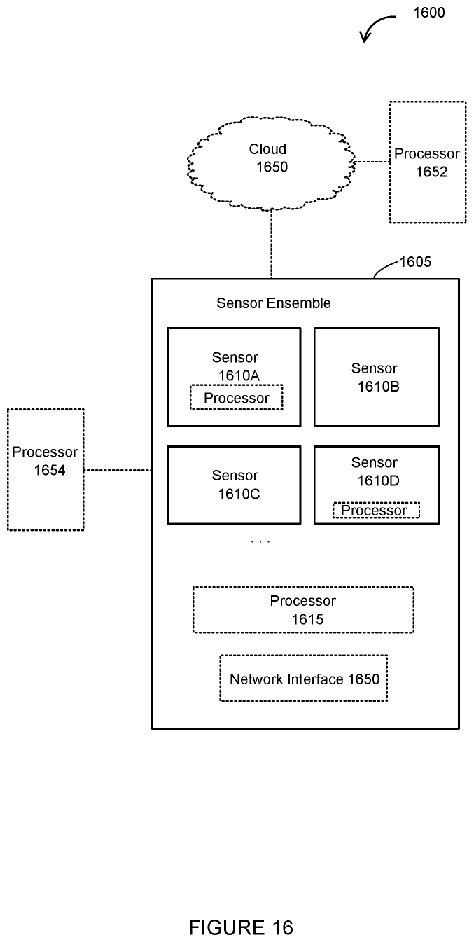

FIG. 16 shows an example of a diagram 1600 of an ensemble of sensors organized into a sensor module. Sensors 1610A, 1610B, 1610C, and 1610D are shown as included in sensor ensemble 1605. An ensemble of sensors organized into a sensor module may include at least 1, 2, 4, 5, 8, 10, 20, 50, or 500 sensors. The sensor module may include a number of sensors in a range between any of the aforementioned values (e.g., from about 1 to about 1000, from about 1 to about 500, or from about 500 to about 1000). Sensors of a sensor module may comprise sensors configured or designed for sensing a parameter comprising, temperature, humidity, carbon dioxide, particulate matter (e.g., from about 2.5 μm to about 10 μm), total volatile organic compounds (e.g., via a change in a voltage potential brought about by surface adsorption of volatile organic compound), ambient light, audio noise level, pressure (e.g. gas, and/or liquid), acceleration, time, radar, lidar, radio signals (e.g., ultra-wideband radio signals), passive infrared, glass breakage, or movement detectors. The sensor ensemble (e.g., 1605) may comprise non-sensor devices, such as buzzers and light emitting diodes. Examples of sensor ensembles and their uses can be found in U.S. patent application Ser. No. 16/447,169, filed Jun. 20, 2019, titled “SENSING AND COMMUNICATIONS UNIT FOR OPTICALLY SWITCHABLE WINDOW SYSTEMS,” that is incorporated herein by reference in its entirety.

In some embodiments, an increase in the number and/or types of sensors may be used to increase a probability that one or more measured property is accurate and/or that a particular event measured by one or more sensor has occurred. In some embodiments, sensors of sensor ensemble may cooperate with one another. In an example, a radar sensor of sensor ensemble may determine presence of a number of individuals in an enclosure. A processor (e.g., processor 1615) may determine that detection of presence of a number of individuals in an enclosure is positively correlated with an increase in carbon dioxide concentration. In an example, the processor-accessible memory may determine that an increase in detected infrared energy is positively correlated with an increase in temperature as detected by a temperature sensor. In some embodiments, network interface (e.g., 1650) may communicate with other sensor ensembles similar to sensor ensemble. The network interface may additionally communicate with a controller.

Individual sensors (e.g., sensor 1610A, sensor 1610D, etc.) of a sensor ensemble may comprise and/or utilize at least one dedicated processor. A sensor ensemble may utilize a remote processor (e.g., 1654) utilizing a wireless and/or wired communications link. A sensor ensemble may utilize at least one processor (e.g., processor 1652), which may represent a cloud-based processor coupled to a sensor ensemble via the cloud (e.g., 1650). Processors (e.g., 1652 and/or 1654) may be located in the same building, in a different building, in a building owned by the same or different entity, a facility owned by the manufacturer of the window/controller/sensor ensemble, or at any other location. In various embodiments, as indicated by the dotted lines of FIG. 16, sensor ensemble 1605 is not required to comprise a separate processor and network interface. These entities may be separate entities and may be operatively coupled to ensemble 1605. The dotted lines in FIG. 16 designate optional features. In some embodiments, onboard processing and/or memory of one or more ensemble of sensors may be used to support other functions (e.g., via allocation of ensembles(s) memory and/or processing power to the network infrastructure of a building).

In some embodiments, a plurality of sensors of the same type may be distributed in an enclosure. At least one of the plurality of sensors of the same type, may be part of an ensemble. For example, at least two of the plurality of sensors of the same type, may be part of at least two ensembles. The sensor ensembles may be distributed in an enclosure. An enclosure may comprise a conference room. For example, a plurality of sensors of the same type may measure an environmental parameter in the conference room. Responsive to measurement of the environmental parameter of an enclosure, a parameter topology of the enclosure may be generated. A parameter topology may be generated utilizing output signals from any type of sensor of sensor ensemble, e.g., as disclosed herein. Parameter topologies may be generated for any enclosure of a facility such as conference rooms, hallways, bathrooms, cafeterias, garages, auditoriums, utility rooms, storage facilities, equipment rooms, and/or elevators.

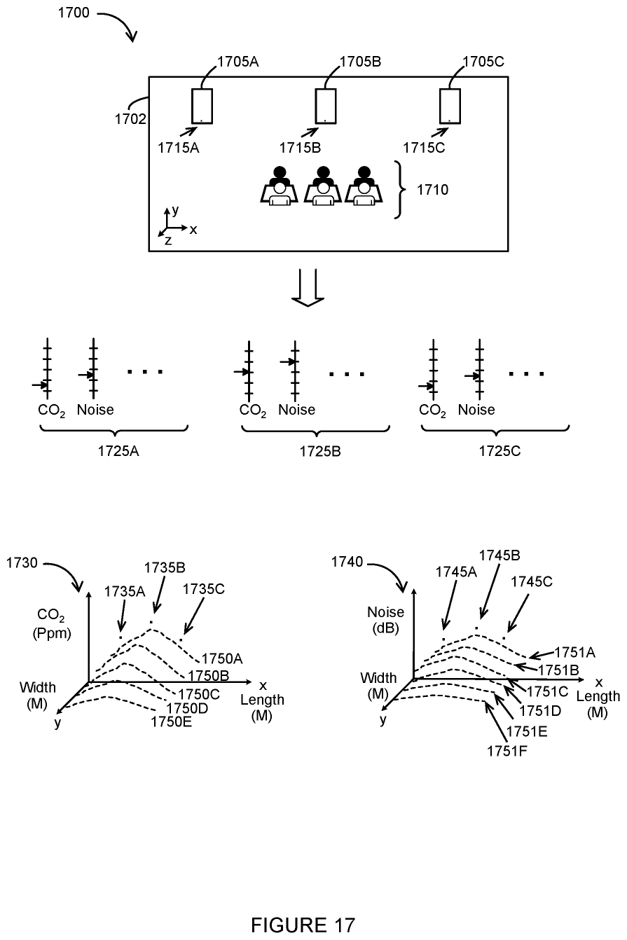

FIG. 17 shows an example of a diagram 1700 of an arrangement of sensor ensembles distributed within an enclosure. In the example shown in FIG. 17, a group 1710 of individuals are seated in conference room 1702. The conference room includes an “X” dimension to indicate length, a “Y” dimension to indicate height, and a “Z” dimension to indicate depth. XYZ being directions a Cartesian coordination system. Sensor ensembles 1705A, 1705B, and 1705C comprise sensors can operate similar to sensors described in reference to sensor ensemble 1605 of FIG. 16. At least two sensor ensembles (e.g., 1705A, 1705B, and 1705C) may be integrated into a single sensor module. Sensor ensembles 1705A, 17058, and 1705C can include a carbon dioxide (CO₂) sensor, an ambient noise sensor, or any other sensor disclosed herein. In the example shown in FIG. 17, a first sensor ensemble 1705A is disposed (e.g., installed) near point 1715A, which may correspond to a location in a ceiling, wall, or other location to a side of a table at which the group 1710 of individuals are seated. In the example shown in FIG. 17, a second sensor ensemble 1705B is disposed (e.g., installed) near point 17158, which may correspond to a location in a ceiling, wall, or other location above (e.g., directly above) a table at which the group 1710 of individuals are seated. In the example shown in FIG. 17, a third sensor ensemble 1705C may be disposed (e.g., installed) at or near point 1715C, which may correspond to a location in a ceiling, wall, or other location to a side of the table at which the relatively small group 1710 of individuals are seated. Any number of additional sensors and/or sensor modules may be positioned at other locations of conference room 1702. The sensor ensembles may be disposed anywhere in the enclosure. The location of an ensemble of sensors in an enclosure may have coordinates (e.g., in a Cartesian coordinate system). At least one coordinate (e.g., of x, y, and z) may differ between two or more sensor ensembles, e.g., that are disposed in the enclosure. At least two coordinates (e.g., of x, y, and z) may differ between two or more sensor ensembles, e.g., that are disposed in the enclosure. All the coordinates (e.g., of x, y, and z) may differ between two or more sensor ensembles, e.g., that are disposed in the enclosure. For example, two sensor ensembles may have the same x coordinate, and different y and z coordinates. For example, two sensor ensembles may have the same x and y coordinates, and a different z coordinate. For example, two sensor ensembles may have different x, y, and z coordinates.

In particular embodiments, one or more sensors of the sensor ensemble provide readings. In some embodiments, the sensor is configured to sense a parameter. The parameter may comprise temperature, particulate matter, volatile organic compounds, electromagnetic energy, pressure, acceleration, time, radar, lidar, glass breakage, movement, or gas. The gas may comprise a Nobel gas. The gas may be a gas harmful to an average human. The gas may be a gas present in the ambient atmosphere (e.g., oxygen, carbon dioxide, ozone, chlorinated carbon compounds, or nitrogen). The gas may comprise radon, carbon monoxide, hydrogen sulfide, hydrogen, oxygen, water (e.g., humidity). The electromagnetic sensor may comprise an infrared, visible light, ultraviolet sensor. The infrared radiation may be passive infrared radiation (e.g., black body radiation). The electromagnetic sensor may sense radio waves. The radio waves may comprise wide band, or ultra-wideband radio signals. The radio waves may comprise pulse radio waves. The radio waves may comprise radio waves utilized in communication. The gas sensor may sense a gas type, flow (e.g., velocity and/or acceleration), pressure, and/or concentration. The readings may have an amplitude range. The readings may have a parameter range. For example, the parameter may be electromagnetic wavelength, and the range may be a range of detected wavelengths.

In some embodiments, the sensor data is responsive to the environment in the enclosure and/or to any inducer(s) of a change (e.g., any environmental disruptor) in this environment. The sensors data may be responsive to emitters operatively coupled to (e.g., in) the enclosure (e.g., an occupant, appliances (e.g., heater, cooler, ventilation, and/or vacuum), opening). For example, the sensor data may be responsive to an air conditioning duct, or to an open window. The sensor data may be responsive to an activity taking place in the room. The activity may include human activity, and/or non-human activity. The activity may include electronic activity, gaseous activity, and/or chemical activity. The activity may include a sensual activity (e.g., visual, tactile, olfactory, auditory, and/or gustatory). The activity may include an electronic and/or magnetic activity. The activity may be sensed by a person. The activity may not be sensed by a person. The sensors data may be responsive to the occupants in the enclosure, substance (e.g., gas) flow, substance (e.g., gas) pressure, and/or temperature.

In one example, sensor ensembles 1705A, 1705B, and 1705C include carbon dioxide (CO₂) sensor, and an ambient noise sensor. A carbon dioxide sensor of sensor ensemble 1705A may provide a reading as depicted in sensor output reading profile 1725A. A noise sensor of sensor ensemble 1705A may provide a reading also depicted in sensor output reading profile 1725A. A carbon dioxide sensor of sensor ensemble 17058 may provide a reading as depicted in sensor output reading profile 17258. A noise sensor of sensor ensemble 17058 may provide a reading also as depicted in sensor output reading profile 17258. Sensor output reading profile 17258 may indicate higher levels of carbon dioxide and noise relative to sensor output reading profile 1725A. Sensor output reading profile 1725C may indicate lower levels of carbon dioxide and noise relative to sensor output reading profile 17258. Sensor output reading profile 1725C may indicate carbon dioxide and noise levels similar to those of sensor output reading profile 1725A. Sensor output reading profiles 1725A, 17258, and 1725C may comprise indications representing other sensor readings, such as temperature, humidity, particulate matter, volatile organic compounds, ambient light, pressure, acceleration, time, radar, lidar, ultra-wideband radio signals, passive infrared, and/or glass breakage, movement detectors.

In some embodiments, data from a sensor in a sensor in the enclosure (e.g., and in the sensor ensemble) is collected and/or processed (e.g., analyzed). The data processing can be performed by a processor of the sensor, by a processor of the sensor ensemble, by another sensor, by another ensemble, in the cloud, by a processor of the controller, by a processor in the enclosure, by a processor outside of the enclosure, by a remote processor (e.g., in a different facility), by a manufacturer (e.g., of the sensor, of the window, and/or of the building network). The data of the sensor may have a time indicator (e.g., may be time stamped). The data of the sensor may have a sensor location identification (e.g., be location stamped). The sensor may be identifiably coupled with one or more controllers.

In particular embodiments, sensor output reading profiles 1725A, 1725B, and 1725C may be processed. For example, as part of the processing (e.g., analysis), the sensor output reading profiles may be plotted on a graph depicting a sensor reading as a function of a dimension (e.g., the “X” dimension) of an enclosure (e.g., conference room 1702). In an example, a carbon dioxide level indicated in sensor output reading profile 1725A may be indicated as point 1735A of CO₂ graph 1730 of FIG. 17. In an example, a carbon dioxide level of sensor output reading profile 17258 may be indicated as point 1735B of CO₂ graph 1730. In an example, a carbon dioxide level indicated in sensor output reading profile 1725C may be indicated as point 1735C of CO₂ graph 1730. In an example, an ambient noise level indicated in sensor output reading profile 1725A may be indicated as point 1745A of noise graph 1740. In an example, an ambient noise level indicated in sensor output reading profile 17258 may be indicated as point 1745B of noise graph 1740. In an example, an ambient noise level indicated in sensor output reading profile 1725C may be indicated as point 1745C of noise graph 1740.

In some embodiments, processing data derived from the sensor comprises applying one or more models. The models may comprise mathematical models. The processing may comprise fitting of models (e.g., curve fitting). The model may be multi-dimensional (e.g., two or three dimensional). The model may be represented as a graph (e.g., 2 or 3 dimensional graph). For example, the model may be represented as a contour map (e.g., as depicted in FIG. 7). The modeling may comprise one or more matrices. The model may comprise a topological model. The model may relate to a topology of the sensed parameter in the enclosure. The model may relate to a time variation of the topology of the sensed parameter in the enclosure. The model may be environmental and/or enclosure specific. The model may consider one or more properties of the enclosure (e.g., dimensionalities, openings, and/or environmental disrupters (e.g., emitters)). Processing of the sensor data may utilize historical sensor data, and/or current (e.g., real time) sensor data. The data processing (e.g., utilizing the model) may be used to project an environmental change in the enclosure, and/or recommend actions to alleviate, adjust, or otherwise react to the change.

In particular embodiments, sensor ensembles 1705A, 1705B, and/or 1705C, may be capable of accessing a model to permit curve fitting of sensor readings as a function of one or more dimensions of an enclosure. In an example, a model may be accessed to generate sensor profile curves 1750A, 1750B, 1750C, 1750D, and 1750E, utilizing points 1735A, 1735B, and 1735C of CO₂ graph 1230. In an example, a model may be accessed to generate sensor profile curves 1751A, 1751B, 1751C, 1751B, 1751E, and 1751F utilizing points 1745A, 1745B, and 1745C of noise graph 1740. Additional models may utilize additional readings from sensor ensembles (e.g., 1705A, 1705B, and/or 1705C) to provide curves in addition to sensor profile curves 1750A-E and 1751A-F of FIG. 17. Sensor profile curves generated in response to use of a model may sensor output reading profiles indicate a value of a particular environmental parameter as a function of a dimension of an enclosure (e.g., an “X” dimension, a “Y” dimension, and/or a “Z” dimension).

In certain embodiments, one or more models utilized to form curves 1750A-1750E and 1751A-1751F) may provide a parameter topology of an enclosure. In an example, a parameter topology (as represented by curves 1750A-1750E and 1751A-1751F) may be synthesized or generated from sensor output reading profiles. The parameter topology may be a topology of any sensed parameter disclosed herein. In an example, a parameter topology for a conference room (e.g., conference room 1702) may comprise a carbon dioxide profile having relatively low values at locations away from a conference room table and relatively high values at locations above (e.g., directly above) a conference room table. In an example, a parameter topology for a conference room may comprise a multi-dimensional noise profile having relatively low values at locations away from a conference table and slightly higher values above (e.g., directly above) a conference room table.

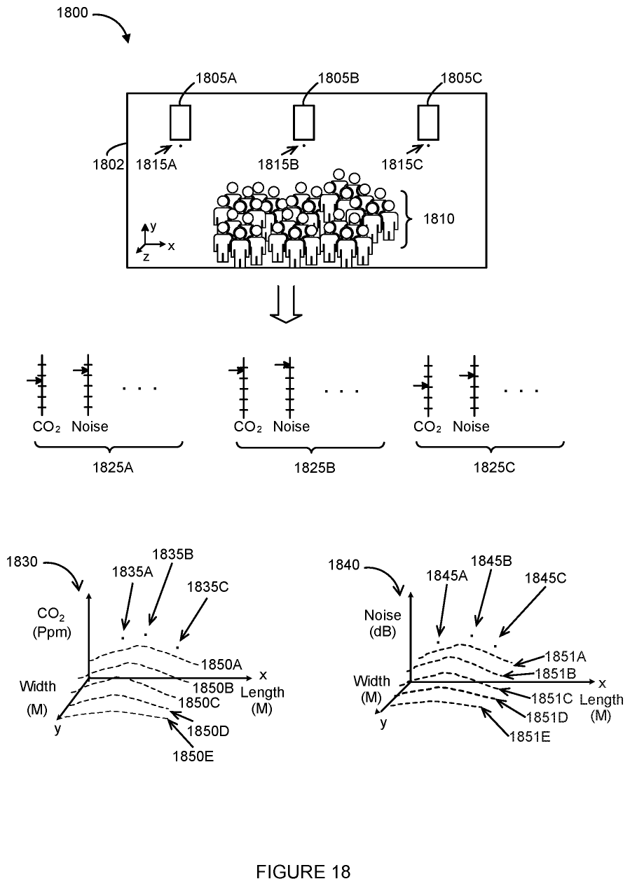

FIG. 18 shows an example of a diagram 1800 of an arrangement of sensor ensembles distributed within an enclosure. In the example shown in FIG. 18, a relatively large group 1810 of individuals (e.g., larger relative to conference room group 1010) are assembled in auditorium 1802. The auditorium includes an “X” dimension to indicate length, a “Y” dimension to indicate height, and a “Z” dimension to indicate depth. Sensor ensembles 1805A, 1805B, and 1805C may comprise sensors that operate similar to sensors described in reference to sensor ensemble 1605 of FIG. 16. At least two sensor ensembles (e.g., 1805A, 1805B, and 1805C) may be integrated into a single sensor module. Sensor ensembles 1805A, 1805B, and 1805C can include a carbon dioxide (CO₂) sensor, an ambient noise sensor, or any other sensor disclosed herein. In the example shown in FIG. 18, a first sensor ensemble 1805A is disposed (e.g., installed) near point 1815A, which may correspond to a location in a ceiling, wall, or other location to a side of seating area at which the relatively large group 1810 of individuals are seated. In the example shown in FIG. 18, a second sensor ensemble 1805B may be disposed (e.g., installed) at or near point 1815B, which may correspond to a location in a ceiling, wall, or other location above (e.g., directly above) an area at which the relatively large group 1810 of individuals are congregated. A third sensor ensemble 1805C may be disposed (e.g., installed) at or near point 1815C, which may correspond to a location in a ceiling, wall, or other location to a side of the table at which the relatively large group 1810 of individuals are positioned. Any number of additional sensors and/or sensor modules may be positioned at other locations of auditorium 1802. The sensor ensembles may be disposed anywhere in the enclosure.

In one example, sensor ensembles 1805A, 1805B, and 1805C, includes a carbon dioxide sensor of sensor ensemble 1805A may provide a reading as depicted in sensor output reading profile 1825A. A noise sensor of sensor ensemble 1805A may provide a reading also depicted in sensor output reading profile 1825A. A carbon dioxide sensor of sensor ensemble 18058 may provide a reading as depicted in sensor output reading profile 18258. A noise sensor of sensor ensemble 18058 may provide a reading also as depicted in sensor output reading profile 18258. Sensor output reading profile 18258 may indicate higher levels of carbon dioxide and noise relative to sensor output reading profile 1825A. Sensor output reading profile 1825C may indicate lower levels of carbon dioxide and noise relative to sensor output reading profile 18258. Sensor output reading profile 1825C may indicate carbon dioxide and noise levels similar to those of sensor output reading profile 1825A. Sensor output reading profiles 1825A, 18258, and 1825C may comprise indications representing other sensor readings of any sensed parameter disclosed herein.

In particular embodiments, sensor output reading profiles 1825A, 18258, and 1825C may be plotted on a graph depicting a sensor reading as a function of a dimension (e.g., the “X” dimension) of an enclosure (e.g., auditorium 1802). In an example, a carbon dioxide level indicated in sensor output reading profile 1825A (shown in FIG. 18) may be indicated as point 1835A (shown in FIG. 18) of CO₂ graph 1830. In an example, a carbon dioxide level of sensor output reading profile 18258 (shown in FIG. 18) may be indicated as point 18358 (shown in FIG. 18) of CO₂ graph 1830. In an example, a carbon dioxide level indicated in sensor output reading profile 1825C may be indicated as point 1835C of CO₂ graph 1830. In an example, an ambient noise level indicated in sensor output reading profile 1825A may be indicated as point 1845A of noise graph 1840. In an example, an ambient noise level indicated in sensor output reading profile 18258 may be indicated as point 18458 of noise graph 1840. In an example, an ambient noise level indicated in sensor output reading profile 1825C may be indicated as point 1845C of noise graph 1840. In particular embodiments, sensor ensembles 1805A, 1805B, and/or 1805C, may be capable of utilizing and/or accessing (e.g., configured to utilize and/or access) a model to permit curve fitting of sensor readings as a function of one or more dimensions of an enclosure. In an example shown in FIG. 18, a model may be accessed to provide sensor profiles, utilizing points 1835A, 18358, and 1835C of CO₂ graph 1830. In an example shown as an example in FIG. 18, a model may be accessed to provide sensor profile 1851 utilizing points 1845A, 18458, and 1845C of noise graph 1840. Additional models may utilize additional readings from sensor ensembles (e.g., 1805A, 1805B, 1805C) to provide sensor profile curves (e.g. sensor profile curve 1850A, 1850B, 1850C, 1850D, and 1850E) of FIG. 18. Models may be utilized to provide sensor profile curves corresponding to ambient noise levels (e.g., sensor profile curves 1850A, 18508, 1850C, 1850D, and 1851E). Sensor profile curves generated in response to use of a model may indicate a value of a particular environmental parameter as a function of a dimension of an enclosure (e.g., an “X” dimension, a “Y” dimension, and/or a “Z” dimension). In certain embodiments, one or more models utilized to form sensor profile curves 1850 and 1851) may provide a parameter topology of an enclosure. A parameter topology may be indicative of a particular type of enclosure. In an example, a parameter topology may be synthesized or generated from sensor profile curves 1850 and 1851, which may correspond to a parameter topology for an auditorium. In an example, a parameter topology for an auditorium may comprise a carbon dioxide profile having at least moderately high values at all locations and very high values at locations near the center of the auditorium. In an example, a parameter topology for an auditorium may comprise a noise profile having relatively high values at all locations of an auditorium and higher values near the center of the auditorium. In particular embodiments, sensor readings from one or more sensors of a sensor ensemble may be obtained. Sensor readings may be obtained by the sensor itself. Sensor readings may be obtained by a cooperating sensor, which may be of the same type or a different type of sensor. Sensor readings may be obtained by one or more processors and/or controllers Sensor reading may be processed by considering one or more other readings from other sensors disposed (e.g., installed) within an enclosure, historical readings, benchmarks, and/or modeling, to generate a result (e.g., a prediction or an estimation of a sensor reading.) A generated result may be utilized to detect an outlier of a sensor reading and/or an outlier sensor. A generated result may be utilized to detect an environmental change at a time and/or location. A generated result may be utilized to predict future readings of the one or more sensors in the enclosure.

In some embodiments, the sensor(s) are operatively coupled to at least one controller and/or processor. Sensor readings may be obtained by one or more processors and/or controllers. A controller may comprise a processing unit (e.g., CPU or GPU). A controller may receive an input (e.g., from at least one sensor). The controller may comprise circuitry, electrical wiring, optical wiring, socket, and/or outlet. A controller may deliver an output. A controller may comprise multiple (e.g., sub-) controllers. The controller may be a part of a control system. A control system may comprise a master controller, floor (e.g., comprising network controller) controller, a local controller. The local controller may be a window controller (e.g., controlling an optically switchable window), enclosure controller, or component controller. For example, a controller may be a part of a hierarchal control system (e.g., comprising a main controller that directs one or more controllers, e.g., floor controllers, local controllers (e.g., window controllers), enclosure controllers, and/or component controllers). A physical location of the controller type in the hierarchal control system may be changing. For example: At a first time: a first processor may assume a role of a main controller, a second processor may assume a role of a floor controller, and a third processor may assume the role of a local controller. At a second time: the second processor may assume a role of a main controller, the first processor may assume a role of a floor controller, and the third processor may remain with the role of a local controller. At a third time: the third processor may assume a role of a main controller, the second processor may assume a role of a floor controller, and the first processor may assume the role of a local controller. A controller may control one or more devices (e.g., be directly coupled to the devices). A controller may be disposed proximal to the one or more devices it is controlling. For example, a controller may control an optically switchable device (e.g., IGU), an antenna, a sensor, and/or an output device (e.g., a light source, sounds source, smell source, gas source, HVAC outlet, or heater). In one embodiment, a floor controller may direct one or more window controllers, one or more enclosure controllers, one or more component controllers, or any combination thereof. The floor controller may comprise a floor controller. For example, the floor (e.g., comprising network) controller may control a plurality of local (e.g., comprising window) controllers. A plurality of local controllers may be disposed in a portion of a facility (e.g., in a portion of a building). The portion of the facility may be a floor of a facility. For example, a floor controller may be assigned to a floor. In some embodiments, a floor may comprise a plurality of floor controllers, e.g., depending on the floor size and/or the number of local controllers coupled to the floor controller. For example, a floor controller may be assigned to a portion of a floor. For example, a floor controller may be assigned to a portion of the local controllers disposed in the facility. For example, a floor controller may be assigned to a portion of the floors of a facility. A master controller may be coupled to one or more floor controllers. The floor controller may be disposed in the facility. The master controller may be disposed in the facility, or external to the facility. The master controller may be disposed in the cloud. A controller may be a part of, or be operatively coupled to, a building management system. A controller may receive one or more inputs. A controller may generate one or more outputs. The controller may be a single input single output controller (SISO) or a multiple input multiple output controller (MIMO). A controller may interpret an input signal received. A controller may acquire data from the one or more components (e.g., sensors). Acquire may comprise receive or extract. The data may comprise measurement, estimation, determination, generation, or any combination thereof. A controller may comprise feedback control. A controller may comprise feed-forward control. Control may comprise on-off control, proportional control, proportional-integral (PI) control, or proportional-integral-derivative (PID) control. Control may comprise open loop control, or closed loop control. A controller may comprise closed loop control. A controller may comprise open loop control. A controller may comprise a user interface. A user interface may comprise (or operatively coupled to) a keyboard, keypad, mouse, touch screen, microphone, speech recognition package, camera, imaging system, or any combination thereof. Outputs may include a display (e.g., screen), speaker, or printer.

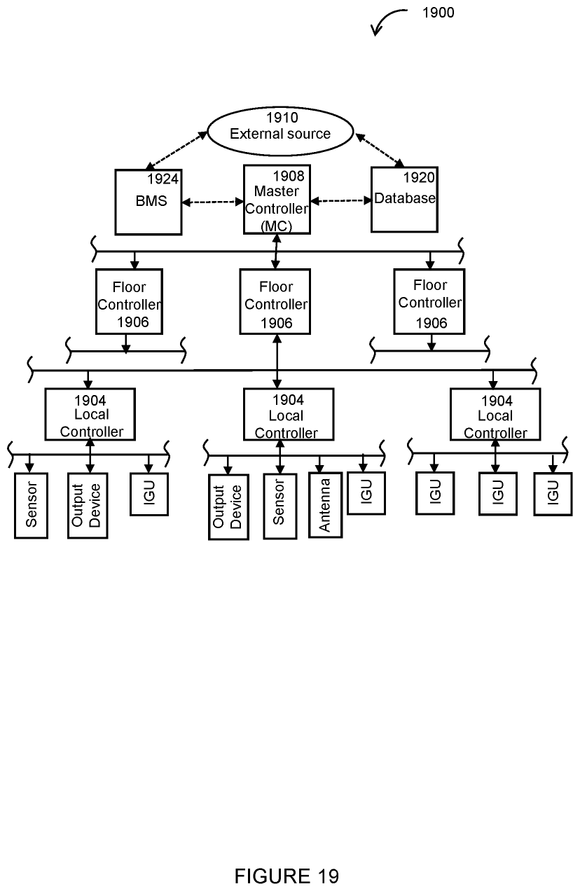

FIG. 19 shows an example of a control system architecture 1900 comprising a master controller 1908 that controls floor controllers 1906, that in turn control local controllers 1904. In some embodiments, a local controller controls one or more IGUs, one or more sensors, one or more output devices (e.g., one or more emitters), or any combination thereof. FIG. 19 shows an example of a configuration in which the master controller is operatively coupled (e.g., wirelessly and/or wired) to a building management system (BMS) 1924 and to a database 1920. Arrows in FIG. 19 represents communication pathways. A controller may be operatively coupled (e.g., directly/indirectly and/or wired and/wirelessly) to an external source 1910. The external source may comprise a network. The external source may comprise one or more sensor or output device. The external source may comprise a cloud-based application and/or database. The communication may be wired and/or wireless. The external source may be disposed external to the facility. For example, the external source may comprise one or more sensors and/or antennas disposed, e.g., on a wall or on a ceiling of the facility. The communication may be monodirectional or bidirectional. In the example shown in FIG. 19, the communication all communication arrows are meant to be bidirectional.

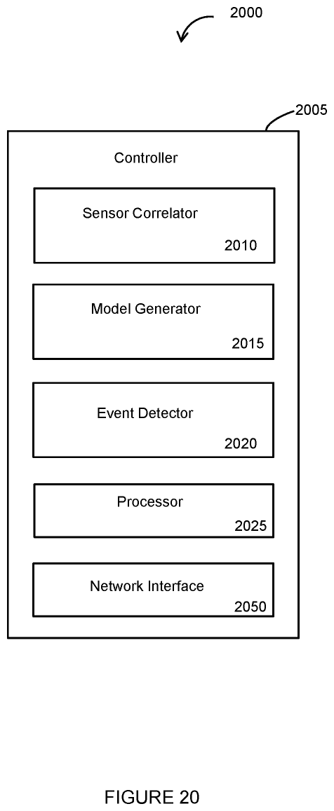

FIG. 20 shows an example of a controller for controlling one or more sensors. Controller 2005 comprises sensor correlator 2010, model generator 2015, event detector 2020, processor and memory 2025, and the network interface 2050. Sensor correlator 2010 operates to detect correlations between or among various sensor types. For example, an infrared radiation sensor measuring an increase in infrared energy may be positively correlated with an increase in measure temperature. A sensor correlator may establish correlation coefficients, such as coefficients for negatively-correlated sensor readings (e.g., correlation coefficients between −1 and 0). For example, the sensor correlator may establish coefficients for positively-correlated sensor readings (e.g., correlation coefficients between 0 and +1).

In some embodiments, the sensor data may be time dependent. In some embodiments, the sensor data may be space dependent. The model may utilize time and/or space dependency of the sensed parameter. A model generator may permit fitting of sensor readings as a function of one or more dimensions of an enclosure. In an example, a model provides sensor profile curves for carbon dioxide may utilize various gaseous diffusion models, which may allow prediction of a level of carbon dioxide at points in between sensor locations. Processor and memory (e.g., 2025) may facilitate processing of models.

In some embodiments, the sensor and/or sensor ensemble may act as an event detector. The event detector may operate to direct activity of sensors in an enclosure. In an example, in response to event detector determining that very few individuals remain in an enclosure, event detector may direct carbon dioxide sensors to reduce a sampling rate. Reduction of a sampling rate may extend the life of a sensor (e.g., a carbon dioxide sensor). In another example, in response to event detector determining that a large number of individuals are present in a room, event detector may increase the sampling rate of a carbon dioxide sensor. In an example, in response to event detector receiving a signal from a glass breakage sensor, event detector may activate one or more movement detectors of an enclosure, one or more radar units of a detector. A network interface (e.g., 2050) may be configured or designed to communicate with one or more sensors via wireless communications links, wired communications links, or any combination thereof.

The controller may monitor and/or direct (e.g., physical) alteration of the operating conditions of the apparatuses, software, and/or methods described herein. Control may comprise regulate, manipulate, restrict, direct, monitor, adjust, modulate, vary, alter, restrain, check, guide, or manage. Controlled (e.g., by at least one controller) may include attenuated, modulated, varied, managed, curbed, disciplined, regulated, restrained, supervised, manipulated, and/or guided. The control may comprise controlling a control variable (e.g. temperature, pressure, gas flow, occupancy, power, voltage, and/or current). The control can comprise real time or off-line control. The control can comprise in situ control. A calculation utilized by the controller can be done in real time, and/or offline. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from at least one sensor). The controller may deliver an output. The controller may comprise multiple (e.g., sub-) controllers. The controller may be a part of a control system. The control system may comprise a master controller, floor controller, local controller (e.g., enclosure controller, or window controller). The controller may receive one or more inputs. The controller may generate one or more outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise (or operatively coupled to) a keyboard, keypad, mouse, touch screen, microphone, speech recognition package, camera, imaging system, or any combination thereof. The outputs may include a display (e.g., screen), speaker, or printer. The methods, systems and/or the apparatus described herein may comprise a control system. The control system can be in communication with any of the apparatuses (e.g., sensors) described herein. The sensors may be of the same type or of different types, e.g., as described herein. For example, the control system may be in communication with the first sensor and/or with the second sensor. The control system may control the one or more sensors. The control system may control one or more components of a building management system (e.g., lightening, security, and/or air conditioning system). The controller may regulate at least one (e.g., environmental) characteristic of the enclosure. The control system may regulate the enclosure environment using any component of the building management system. For example, the control system may regulate the energy supplied by a heating element and/or by a cooling element. For example, the control system may regulate velocity of gas(es) flowing through a vent to and/or from the enclosure. The control system may comprise a processor. The processor may be a processing unit. The controller may comprise a processing unit. The processing unit may be central. The processing unit may comprise a central processing unit (abbreviated herein as “CPU”). The processing unit may be a graphic processing unit (abbreviated herein as “GPU”). The controller(s) or control mechanisms (e.g., comprising a computer system) may be programmed to implement one or more methods of the disclosure. The processor may be programmed to implement methods of the disclosure. The controller may control at least one component of the forming systems and/or apparatuses disclosed herein.

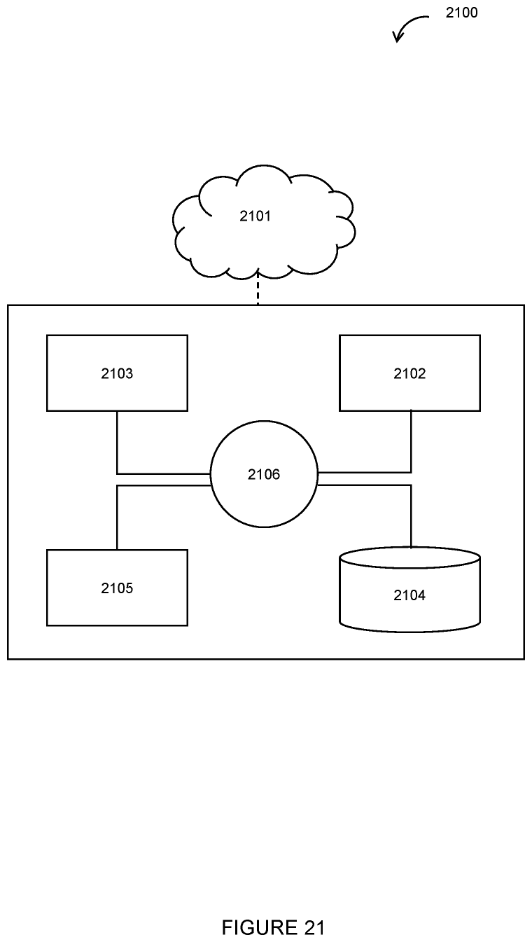

FIG. 21 shows a schematic example of a computer system 2100 that is programmed or otherwise configured to one or more operations of any of the methods provided herein. The computer system can control (e.g., direct, monitor, and/or regulate) various features of the methods, apparatuses and systems of the present disclosure, such as, for example, control heating, cooling, lightening, and/or venting of an enclosure, or any combination thereof. The computer system can be part of, or be in communication with, any sensor or sensor ensemble disclosed herein. The computer may be coupled to one or more mechanisms disclosed herein, and/or any parts thereof. For example, the computer may be coupled to one or more sensors, valves, switches, lights, windows (e.g., IGUs), motors, pumps, optical components, or any combination thereof.

The computer system can include a processing unit (e.g., 2106) (also “processor,” “computer” and “computer processor” used herein). The computer system may include memory or memory location (e.g., 2102) (e.g., random-access memory, read-only memory, flash memory), electronic storage unit (e.g., 2104) (e.g., hard disk), communication interface (e.g., 2103) (e.g., network adapter) for communicating with one or more other systems, and peripheral devices (e.g., 2105), such as cache, other memory, data storage and/or electronic display adapters. In the example shown in FIG. 21, the memory 2102, storage unit 2104, interface 2103, and peripheral devices 2105 are in communication with the processing unit 2106 through a communication bus (solid lines), such as a motherboard. The storage unit can be a data storage unit (or data repository) for storing data. The computer system can be operatively coupled to a computer network (“network”) (e.g., 2101) with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 2102. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 2100 can be included in the circuit.

The storage unit can store files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

The computer system can communicate with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

Methods as described herein can be implemented by way of machine (e.g., computer processor) executable code stored on an electronic storage location of the computer system, such as, for example, on the memory 2102 or electronic storage unit 2104. The machine executable or machine-readable code can be provided in the form of software. During use, the processor 2106 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

In some embodiments, the processor comprises a code. The code can be program instructions. The program instructions may cause the at least one processor (e.g., computer) to direct a feed forward and/or feedback control loop. In some embodiments, the program instructions cause the at least one processor to direct a closed loop and/or open loop control scheme. The control may be based at least in part on one or more sensor readings (e.g., sensor data). One controller may direct a plurality of operations. At least two operations may be directed by different controllers. In some embodiments, a different controller may direct at least two of operations (a), (b) and (c). In some embodiments, different controllers may direct at least two of operations (a), (b) and (c). In some embodiments, a non-transitory computer-readable medium cause each a different computer to direct at least two of operations (a), (b) and (c). In some embodiments, different non-transitory computer-readable mediums cause each a different computer to direct at least two of operations (a), (b) and (c). The controller and/or computer readable media may direct any of the apparatuses or components thereof disclosed herein. The controller and/or computer readable media may direct any operations of the methods disclosed herein.

In some embodiments, the at least one sensor is operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include temperature sensor, weight sensor, material (e.g., powder) level sensor, metrology sensor, gas sensor, or humidity sensor. The metrology sensor may comprise measurement sensor (e.g., height, length, width, angle, and/or volume). The metrology sensor may comprise a magnetic, acceleration, orientation, or optical sensor. The sensor may transmit and/or receive sound (e.g., echo), magnetic, electronic, or electromagnetic signal. The electromagnetic signal may comprise a visible, infrared, ultraviolet, ultrasound, radio wave, or microwave signal. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensor, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The one or more sensors may be connected to a control system (e.g., to a processor, to a computer).

In some embodiments, measurements of one or more sensors (e.g., comprising VOC sensor(s)) may be utilized to adjust a smell (e.g., smell profile), gas borne compounds, and/or gaseous compounds of an environment. In some embodiments, gas borne comprises air borne. The smell, gas borne compounds, and/or gaseous compounds may be requested and/or preferred. The gas borne compounds may be volatile compounds. The smell may have a profile composed of one or more chemicals (e.g., gas borne chemicals). The smell may be requested and/or preferred by a user (e.g., as disclosed herein), and/or by jurisdictional (e.g., health) standard(s). The measurements of the one or more sensors may be utilized to form a sensed profile (e.g., sensed map). The profile may be as a function of space and/or time. The profile may be a two, three, or four dimensional profile. At least one of the profile data may relate to (i) space (e.g., compound(s) concentration as a function of space), and/or (ii) time (e.g., compound(s) concentration as a function of space). When the sensed profile of the chemical(s) deviates from the requested profile, the profile in the environment may be adjusted. Adjustment may be at least in part by modifying a chemical make-up of an atmosphere of the environment, changes in air flow, and/or changes in atmospheric temperature. For example, adjustment may be by adding (e.g., injecting) and/or dispersing one or more chemicals into an atmosphere. For example, adjustment may be by subtracting (e.g., expelling, extracting, or ejecting) one or more chemicals out of an atmosphere. The subtraction can be active (e.g., suction) or passive (e.g., absorption). At least one of the adjusted chemical(s) may be the same as the sensed chemical(s) found as deficient. At least one of the adjusted chemical(s) may be different from the sensed chemical(s) found deficient. Adjustment of the chemical(s) into/out of the atmosphere may occur when the requested chemical profile deviates from a requested chemical profile. The adjusted chemical(s) may masque the sensed chemical profile. The masking may be relative to an average user (e.g., smell that is sensed as masque by an average user). The user may be an occupant of the environment. The adjustment may be of individual compounds and/or of a mixture of compounds. The chemical(s) may be chemically identifiable or may be as part of a mixture that is not (e.g., fully) identifiable.

In some embodiments, a control system adjusts an environment based at least in part on preferences. The preferences may include (e.g., personal) preferences of a user. The preference may include jurisdictional (e.g., health) preferences, standards, and/or recommendations. A user may input an environmental preference. The environmental preference may include environmental characteristic types comprising temperature, chemical make-up of an atmosphere, gas movement velocity (e.g., ventilation speed), light intensity, or noise levels. The environmental preference may comprise rejection of one or more environmental conditions. For example, an input of the user may comprise (i) liking an environment, (ii) disliking an environment, and/or (iii) preference of a different specified environment. The specific environment may be enumerated in a menu (e.g., dropdown menu). The specific environment may be generated by the user by selection of one or more of the environmental characteristic types from a menu. An environmental characteristic type may have various levels. For example, the environmental characteristic of temperature may have various temperature levels such as about 10° C., 15° C., 20° C., 25° C., or 30° C. The chemical makeup of the atmosphere may comprise various levels (e.g., indicated as percentage or ppm) of a certain chemical (e.g., CO₂, O₂, or a particular VOC). The user may indicate a preference to a chemical makeup of the atmosphere of the enclosure. The preference may be disliking the current smell, liking the current smell, or preferring a different smell profile. The preference may be registered as user input, and coupled with a time of input entry and/or space of user entry. Various preference of the user as a function of space and/or time, may be used by the learning system as input. The learning system may use these preferences and predict future smell predictions, e.g., optionally as a function of space. The learning system may use preferences of a plurality of users (e.g., a group of users) and predict future smell predictions, e.g., optionally as a function of space and/or space types. The users may occupy the space adjacent to each other (e.g., in one open space region). The users may occupy similar space types. The space types may comprise similar type of rooms such as office rooms, conference rooms, break-rooms, cafeterias, corridors, bathrooms, or elevators. The space types may be defined and/or identified, e.g., in a database. The space types may be identified by a function an occupant performs therein (e.g., studying, lecturing and/or listening to a lecture, conferring, eating, drinking, resting, secreting (e.g., urine), expelling (e.g., defecating), washing, and/or waiting).

In some embodiments, a control system adjusts an environment based at least in part on a learning scheme. The control system may be communicatively coupled to a network (e.g., as disclosed herein). The user input may be entered into a database that is operatively coupled to the network. A learning system may track the user input, e.g., as a function of space and/or time. The learning system may utilize the user input as a learning set. The learning system may form predictions(s) in a future time based at least in part of the user input. The learning system may comprise any learning scheme (e.g., algorithm) as disclosed herein. For example, the learning system may utilize an artificial intelligence scheme. In some embodiments, a control system adjusts the chemical make-up of an environment based at least in part on preferences. The preferences may include (e.g., personal) preferences of a user (e.g., an occupant). The preference may include jurisdictional (e.g., health) preferences, standards, and/or recommendations. A user may entered a smell preference. The smell preference may comprise rejection of a present smell in the environment. The smell preference may comprise liking a present smell in the environment. The smell preference may comprise indication of a requested smell in the environment (e.g., citrus smell). The control system may utilize input from at least one chemical sensor to form a present smell profile in the environment. The control system may analyze (e.g., compare) the present small profile with the requested smell profile, and generate a comparison. The smell profile may comprise indication of time, space, chemical type, and/or level of the chemical type. The control system may include one or more controllers and/or processors. The control system may analyze the comparison with respect to a threshold (e.g., value and/or function). The threshold function may be of time, space, and/or chemical type. When the comparison is greater than the threshold, the control system may adjust the smell profile of the environment by controlling a ventilation system, and/or injecting a smell component(s) (e.g., citrus smell) into the environment. The control system may utilize the learning system to anticipate requests and/or preferences of the user. The control system may automatically (e.g., without explicit user request) adjust one or more environmental characteristic based at least in part on the learning system (e.g., learning module). The user may (e.g., manually) override an environmental adjustment of the control system. Input of environmental preference of the user may be done using an application. The application may be operatively (e.g., communicatively) coupled to a mobile device. While an example of smell adjustment was provided, adjustment may be similarly done to any other atmospheric components and/or characteristic.

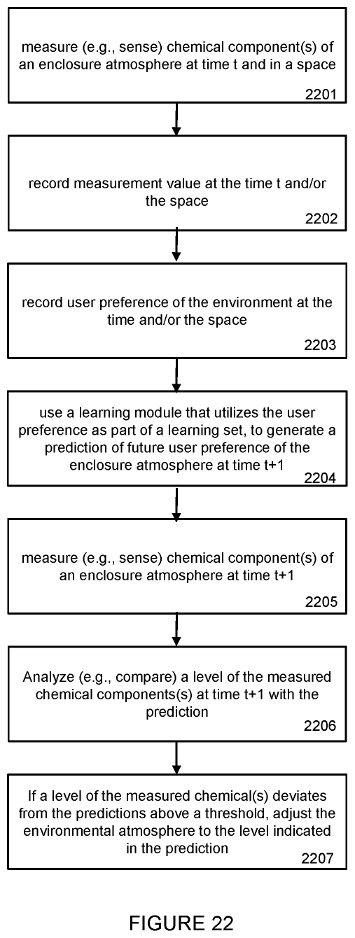

FIG. 22 shows an example of environmental adjustment for the environmental characteristic of smell. In block 2201, one or more sensors measure (e.g., sense) chemical component(s) of an enclosure atmosphere at time “t” and in a space (e.g., where the user is disposed). The space can be derived from tracking of a user tag and/or mobile device (e.g., cellular phone). The space can be derived from location of the sensor(s). The sensor(s) can be part of a device ensemble (e.g., as disclosed herein). In block 2202, the measurement value is recorded at the time t (e.g., as a timestamp) and/or the space. Recordation can be in a database. In block 2203, a user provides user preference input that is recorded, which user preference is of the environment at the time and/or the space. The recordation can be in the same or different database. In block 2204, a learning module (e.g., comprising AI) utilizes the user preference as part of a learning set, to generate a prediction of future user preference of the enclosure atmosphere at time t+1. In block 2205, the one or more sensors measure at time t+1 the chemical component(s) of an enclosure atmosphere. In block 2206, a level of the measured chemical components(s) at time t+1 is analyzed (e.g., compared with the prediction generated in block 2204). In block 2207, the environmental atmosphere is adjusted to the level indicated in the prediction if a level of the measured chemical(s) deviates from the predictions above a threshold. The analysis can be performed by any of the circuitry (e.g., one or more processors) disclosed herein. The control of the atmosphere can be done by the control system (e.g., comprising one or more controllers). Communication between the sensor(s) and the circuitry and/or controller(s) is done by wirelessly and/or wired communication using a network (e.g., as disclosed herein). The sensor(s) can be part of a device ensemble. Sensors sensing the chemical compound(s) (e.g., VOCs) may be referred to as an “electronic nose.” While an example of smell adjustment was provided, adjustment may be similarly done to any other atmospheric components and/or characteristic.

In some embodiments, the component (e.g., device such as sensor, emitter, or transceiver) is operatively coupled to the network. The network may be operatively (e.g., communicatively) coupled to one or more controllers. The network may be operatively (e.g., communicatively) coupled to one or more processors.

In some example, any discovery of the component operatively coupled to the network by a user can be restricted by at least one security protocol (e.g., dangerous manufacturing machinery may be available only to permitted manufacturing personnel). The security protocol can have one or more security levels. The discovery of a component on the network by a user can be restricted according to an enclosure (e.g., a room), floor, building, or facility in which the user is located. The discovery of a component on the network by a user can be restricted according to a type of component, purpose allocation of the component, or any combination thereof.

In some embodiments, the component is communicatively coupled to the network. The component may utilize a network authentication protocol. The network authentication protocol may open one or more ports for network access. The port(s) may be opened when an organization and/or a facility authenticates (e.g., through network authentication) an identity of a component that attempts to operatively couple (and/or physically couples) to the network. Operative coupling may comprise communicatively coupling. The organization and/or facility may authorize (e.g., using the network) access of the component to the network. The access may or may not be restricted. The restriction may comprise one or more security levels. The identity of the component can be determined based on the credentials and/or certificate. The credentials and/or certificate may be confirmed by the network (e.g., by a server operatively coupled to the network). The authentication protocol may or may not be specific for physical communication (e.g., Ethernet communication) in a local area network (LAN), e.g., that utilizes packets. The standard may be maintained by the Institute of Electrical and Electronics Engineers (IEEE). The standard may specify the component (e.g., physical media) and/or the working characteristics of the network (e.g., Ethernet). The networking standard may support virtual LANs (VLANs) on a local area (e.g., Ethernet) network. The standard may support power over local area network (e.g., Ethernet). The network may provide communication over power line (e.g., coaxial cable). The power may be direct current (DC) power. The power may be at least about 12 Watts (W), 15 W, 25 W, 30 W, 40 W, 48 W, 50 W, or 100 W. The standard may facilitate mesh networking. The standard may facilitate a local area network (LAN) technology and/or wide area network (WAN) applications. The standard may facilitate physical connections between components and/or infrastructure devices (hubs, switches, routers) by various types of cables (e.g., coaxial, twisted wires, copper cables, and/or fiber cables). Examples of network authentication protocols can be 802.1X, or KERBEROS. The network authentication protocol may comprise secret-key cryptography. The network can support (e.g., communication) protocols comprising 802.3, 802.3af (PoE), 802.3at (PoE+), 802.1Q, or 802.11s. The network may support a communication protocol for Building Automation and Control (BAC) networks (e.g., BACnet). The protocol may define service(s) used to communicate between building devices. The protocol services may include device and object discovery (e.g., Who-Is, I-Am, Who-Has, and/or I-Have). The protocol services may include Read-Property and Write-Property (e.g., for data sharing). The network protocol may define object types (e.g., that are acted upon by the services). The protocol may define one or more data links/physical layers (e.g., ARCNET, Ethernet, BACnet/IP, BACnet/IPv6, BACnet/MSTP, Point-To-Point over RS-232, Master-Slave/Token-Passing over RS-485, ZigBee, and/or LonTalk). The protocol may be dedicated to devices (e.g., Internet of Things (IoT) devices and/or machine to machine (M2M) communication). The protocol may be a messaging protocol. The protocol may be a publish-subscribe protocol. The protocol may be configured for messaging transport. The protocol may be configured for remote devices. The protocol may be configured for devices having a small code footprint and/or minimal network bandwidth. The small code footprint may be configured to be handled by microcontrollers. The protocol may have a plurality of quality of service levels including (i) at most once, (ii) at least once, and/or (iii) exactly once. The plurality of quality of service levels may increase reliability of the message delivery in the network (e.g., to its target). The protocol may facilitate messaging (i) between device to cloud and/or (ii) between cloud to device. The messaging protocol is configured for broadcasting messages to groups of targets such as components (e.g., devices), sensors, and/or emitters. The protocol may comply with Organization for the Advancement of Structured Information Standards (OASIS). The protocol may support security schemes such as authentication (e.g., using tokens). The protocol may support access delegation standard (e.g., OAuth). The protocol may support granting a first application (and/or website) access to information on a second application (and/or website) without providing the second with a security code (e.g., token and/or password) relating to the first application. The protocol may be a Message Queuing Telemetry Transport (MQTT) or Advanced Message Queuing Protocol (AMQP) protocol. The protocol may be configured for a message rate of at least one (1) message per second per publisher. The protocol may be configured to facilitate a message payload size of at most 64, 86, 96, or 128 bytes. The protocol may be configured to communicate with any device (e.g., from a microcontroller to a server) that operates a protocol compliant (e.g., MQTT) library and/or connects to compliant broker (e.g., MQTT broker) over a network. Each component (such as sensor, or emitter) can be a publisher and/or a subscriber. A broker can handle millions of concurrently connected devices, or less than millions. The broker can handle at least about 100, 10000, 100000, 1000000, or 10000000 concurrently connected devices. In some embodiments, the broker is responsible for receiving (e.g., all) messages, filtering the messages, determining who is interested in each message, and/or sending the message to these subscribed device (e.g., broker client). The protocol may require internet connectivity to the network. The protocol may facilitate bi-directional, and/or synchronous peer-to-peer messaging. The protocol may be a binary wire protocol. Examples of such network protocol, control system, and network can be found in U.S. Provisional Patent Application Ser. No. 63/000,342 filed Mar. 26, 2020 titled “MESSAGING IN A MULTI CLIENT NETWORK,” which is incorporated herein by reference in its entirety. Examples of network security, communication standards, communication interface, messaging, coupling of devices to the network, and control can be found in U.S. Provisional Patent Application Ser. No. 63/000,342, and in International Patent Application Serial No. PCT/US20/70123 filed Jun. 4, 2020, titled “SECURE BUILDING SERVICES NETWORK,” each of which is incorporated herein by reference in its entirety.

In some embodiments, the network allows a component to couple to the network. The network (e.g., using controller(s) and/or processor(s)) may let the component join the network, authenticate the component, monitor its activity on the network (e.g., activity relating to the component), facilitate performance of maintenance and/or diagnostics, and secure the data communicated over the network. The security levels may allow bidirectional or monodirectional communication between a user and a component. For example, the network may allow only monodirectional communication of the user to the component. For example, the network may restrict availability of data communicated through the network and/or coupled to the network, from being accessed by a third party owner of a component (e.g., service device). For example, the network may restrict availability of data communicated through the network and/or coupled to the network, from being accessed by the organization and/or facility into data relating to a third party owner and/or manufacturer of a component (e.g., service device).

In some embodiments, the control system is operatively coupled to a learning module. The learning module may utilize a learning scheme, e.g., comprising artificial intelligence. The learning module may be learn preference of one or more users associated with the facility. Users associated with the facility may include occupants of the facility and/or users associated with an entity residing and/or owning the facility (e.g., employees of a company residing in the facility). The learning modules may analyze preference of a user or a group of users. The learning module may gather preferences of the user(s) as to one or more environmental characteristic. The learning module may use past preference of the user as a learning set for the user or for the group to which the user belongs. The preferences may include environmental preference or preferences related to a component (e.g., service machine, and/or production machine).

In some embodiments, a control system conditions various aspects of an enclosure. For example, the control system may condition an environment of the enclosure. The control system may project future environmental preferences of the user, and condition the environment to these preferences in advance (e.g., at a future time). The preferential environmental characteristic(s) may be allocated according to (i) user or group of users, (ii) time, (iii) date, and/or (iv) space. The data preferences may comprise seasonal preferences. The environmental characteristics may comprise lighting, ventilation speed, atmospheric pressure, smell, temperature, humidity, carbon dioxide, oxygen, VOC(s), particulate matter (e.g., dust), or color. The environmental characteristics may be a preferred color scheme or theme of an enclosure. For example, at least a portion of the enclosure can be projected with a preferred theme (e.g., projected color, picture, or video). For example, a user is a heart patient and prefers (e.g., requires) an oxygen level above the ambient oxygen level (e.g., 20% oxygen) and/or a certain humidity level (e.g., 70%). The control system may condition the atmosphere of the environment for that oxygen and humidity level when the heart patient occupant is in a certain enclosure (e.g., by controlling the BMS). In some embodiments, a control system may operate a component according to preference of a user or a group of users. In some embodiments, the control system may adjust the environment and/or component according to hierarchical preferences.

In some embodiments, the control system considers results (e.g., scientific and/or research based results) regarding environmental conditions that affect health, safety and/or performance of enclosure occupants. The control system may establish thresholds and/or preferred window-ranges for one or more environmental characteristic of the enclosure (e.g., of an atmosphere of the enclosure). The threshold may comprise a level of atmospheric component (e.g., VOC, particulate matter, and/or gas), temperature, and time at a certain level. The certain level may be abnormally high, abnormally low, or average. For example, the controller may allow short instances of abnormally high VOC and/or particulate matter level, but not prolonged time with that VOC and/or particulate matter level. The control system may automatically override preference of a user if it contradicts health and/or safety thresholds. Health and/or safety thresholds may be at a higher hierarchical level relative to a user's preference. The hierarchy may utilize majority preferences. For example, if two occupants of a meeting room have one preference, and the third occupant has a conflicting preference, then the preferences of the two occupants will prevail (e.g., unless they conflict health and/or safety considerations).

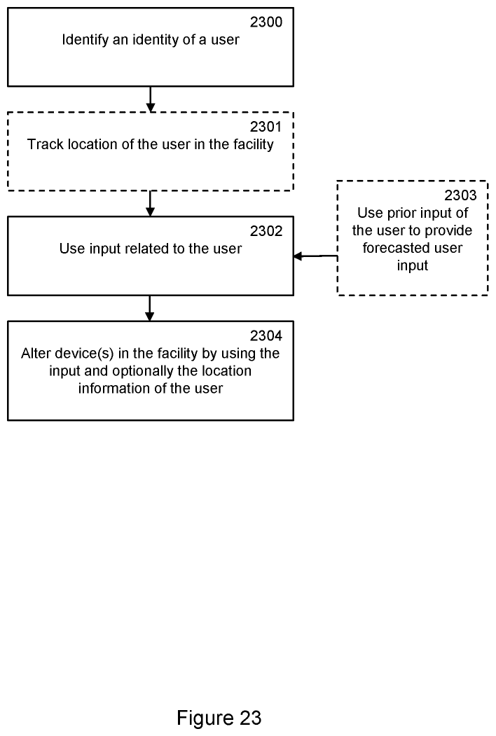

FIG. 23 shows an example of a flow chart depicting operations of a control system that is operatively coupled to one or more devices in an enclosure (e.g., a facility). In block 2300 an identify of a user is identified by a control system. The identity can be identified by one or more sensors (e.g., camera) and/or by an identification tag (e.g., by scanning or otherwise sensing by one or more sensors). In block 2301, a location of the user may optionally be tracked as the user spends time in the enclosure. The use may provide input as to any preference. The preference may be relating to a component such as a target apparatus, and/or environmental characteristics. A learning module may optionally track such preferences and provide predictions as to any future preference of the user in block 2303. Past elective preferences by the user may be recorded (e.g., in a database) and may be used as a learning set for the learning module. As the learning process progress over time and the user provides more and more inputs, the predictions of the learning module may increase in accuracy. The learning module may comprise any learning scheme (e.g., comprising artificial intelligence and/or machine learning) disclosed herein. The user may override recommendations and/or predictions made by the learning module. The user may provide manual input into the control system. In block 2302, the user input is provided (whether directly by the user or by predictions of the learning module) to the control system. The control system may alter (or direct alteration of) one or more devices in the facility to materialize the user preferences (e.g., input) by using the input. The control system may or may not use location of the user. The location may be a past location or a current location. For example, the user may enter a workplace by scanning a tag. Scanning of the identification tag (ID tag) can inform the control system of an identify of the user, and the location of the user at the time of scanning. The user may express a preference for a sound of a certain level that constitutes the input. The expression of preference may be by manual input (including tactile, voice and/or gesture command). A past expression of preference may be registered in a database and linked to the user. The user may enter a conference room at a prescheduled time. The sound level in the conference room may be adjusted to the user preference (i) when the prescheduled meeting was scheduled to initiate and/or (ii) when one or more sensors sense presence of the user in the meeting room. The sound level in the conference room may be return to a default level and/or adjusted to another's preference (i) when the prescheduled meeting was scheduled to end and/or (ii) when one or more sensors sense absence of the user in the meeting room.

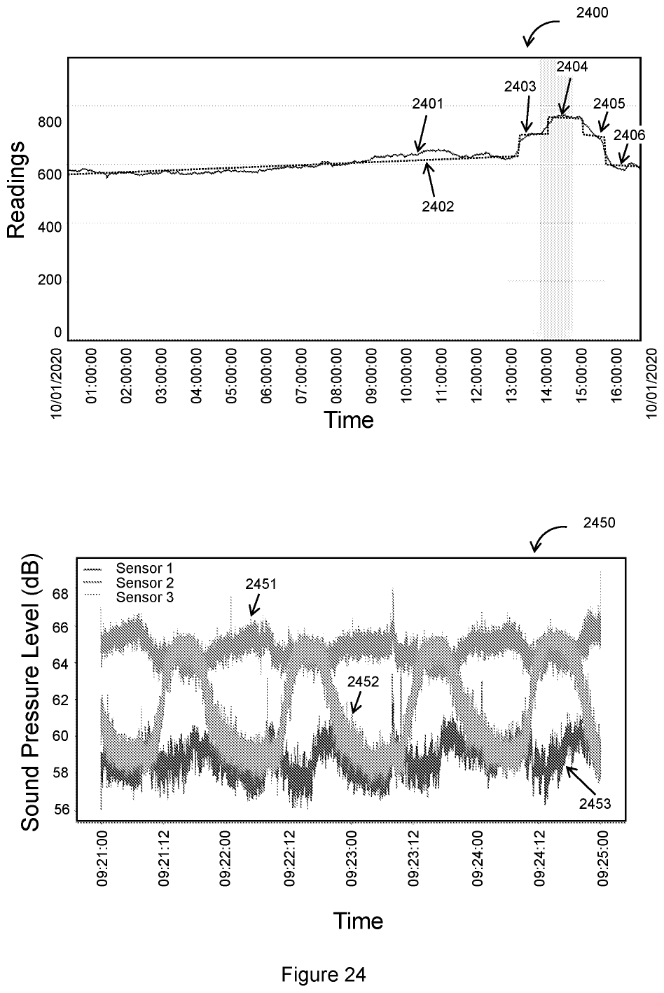

In some embodiments, detection association of personnel interaction with sensor data is obviated from the data. The sensor data may require analysis. For example, the senor data may require finding a baseline of the sensed property (e.g., sensed attribute). For example, the sensor data may require matching to a graph manipulating the data. The data manipulation may comprise filtering (e.g., high pass or low pass filtering); finding mean, average, or median; discretizing data (e.g., according to a threshold). The threshold may comprise a threshold value or a threshold function. FIG. 24 shows an example of carbon dioxide sensor data values plotted as a function of time, in graph 2400 showing sensor data 2401. An average baseline may be matched in 2402 and 2406. The carbon dioxide data may be discretized. For example, discretized values 2403, 2404, and 2405 represent discretization of the sensor data 2401. The discretization may be matched with number of personnel and/or their behavior. For example, a first person may enter a room in which the carbon dioxide sensor(s) are disposed. These sensor(s) generate data 2401. When the first person enters the room, the sensor data may elevate to a level 2403. When a second person enters the room, the sensor data may elevate to a level 2404. When the second sensor leaves the room, the sensor data may reduce to level 2403, and finally, when the first person exits the room, the sensor data will revert to the baseline level 2406. Corroboration of the entry of personnel to the room may be with other sensors. For example, ID sensor(s), or noise sensor(s). Such corroboration and/or accumulation of data over prolonged time may foresee and/or characterize behavior in that room (e.g., or in the facility). FIG. 24 shows an example of noise sensor data values plotted as a function of time, in graph 2450 showing first sensor data 2451, second sensor data 2452, and third sensor data 2453, which sensors are disposed at known and different locations in the facility. Sensor data 2451 discloses a lower noise levels as compared to sensor data 2452 that depicts a noisier environment. Sensor data 2452 depicts regular noise oscillations that could match oscillation of a motor. The level of noise can be monitored, thus obviating when a noise level is above a threshold. This provide an opportunity to alleviate such noise conditions when it arises (e.g., regardless and/or before a complaint is put forward). Such level of knowledge may provide an opportunity to monitor the motorized devices, e.g., using machine learning or another control scheme. For example, when the sound oscillation become non-repetitive, and/or exhibit another change (e.g., altered sound level, altered frequency, altered full-width-at-half-maximum (FWHM), or any combination thereof), an action may be prescribed (e.g., notification is provided). Such knowledge may allow monitoring the facility or any component (e.g., service machinery and/or production machinery) of the facility.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1.-63. (canceled)

64. A method for controlling an atmosphere of an enclosure, the method comprising:
(A) determining a present concentration of a substance in the atmosphere of the enclosure, which substance has (i) a first concentration regime, and (ii) a second concentration regime; and
(B) when the present concentration is at the first concentration regime then (I) determining, an atmosphere exchange rate to yield a target concentration at the second concentration regime, which atmosphere exchange rate is determined within a time and at an occupancy in the enclosure at the time, and (II) adjusting a ventilation system based at least in part on the atmosphere exchange rate determined.

65. The method of claim 64, wherein:
the first concentration regime has a detrimental effect on one or more occupants in the enclosure, and
the second concentration regime has a non-detrimental effect on the one or more occupants in the enclosure.

66. The method of claim 64, wherein the ventilation system comprises a heat pump, gas handler, or a combination thereof.

67. The method of claim 64, wherein adjusting the ventilation system comprises adjusting the ventilation system to optimize an atmospheric quality, an energy usage, or a combination thereof.

68. The method of claim 64, wherein adjusting the ventilation system is further based at least in part on a maximum occupancy, a minimum ventilation rate, a maximum ventilation rate, a target ventilation rate, target differential concentration, or a combination thereof.

69. The method of claim 64, wherein adjusting the ventilation system is further based at least in part on sensor data comprising a measured actual concentration of the substance in the atmosphere of the enclosure, a measured actual concentration of the substance in an atmosphere external to the enclosure, a measured actual ventilation rate, a measured actual occupancy, or a combination thereof.

70. The method of claim 64, wherein adjusting the ventilation system is further based at least in part on one or more user preferences.

71. The method of claim 64, wherein adjusting the ventilation system is further based at least in part on one or more projected future preferences of one or more users.

72. The method of claim 64, further comprising (C) when the present concentration is at the second concentration regime then (I) determining a ventilation rate of the ventilation system to supply air into the enclosure to obtain a concentration of the substance in the second concentration regime, and (II) adjusting the ventilation system based at least in part on the ventilation rate determined.

73. The method of claim 64, wherein, in (B)(I), the atmosphere exchange rate is determined using a natural logarithm of a ratio of the present concentration to the target concentration divided by the time.

74. The method of claim 64, wherein, in (B)(II), adjustment of the ventilation system comprises converting the atmosphere exchange rate determined to a compensatory flow rate and adjusting the ventilation system using the compensatory flow rate.

75. The method of claim 64, wherein the present concentration of the substance is determined using at least one atmospheric sensor disposed in the enclosure.

76. The method of claim 75, wherein the at least one atmospheric sensor includes a carbon dioxide concentration sensor, a volatile organic compound (VOC) concentration sensor, and/or a particular matter concentration sensor.

77. The method of claim 75, wherein the present concentration of the substance is responsive to an activity taking place in the enclosure.

78. The method of claim 77, further comprising determining the activity based on data from the at least one atmospheric sensor indicative of the present concentration of the substance.

79. The method of claim 64, further comprising determining an occupancy number corresponding to a number of the one or more occupants in the enclosure.

80. The method of claim 79, wherein the occupancy number is estimated in response to the present concentration of carbon dioxide in the enclosure, and a per person generation rate of the carbon dioxide.

81. The method of claim 79, wherein the occupancy number is estimated using at least one ambient noise sensor.

82. The method of claim 79, wherein:
the occupancy number is a predicted number for a future time, and
the predicted number is derived from stored historical concentration data, from scheduling data, from current occupancy measurements, or a combination thereof.

83. The method of claim 64, wherein the substance is a particulate matter, wherein the ventilation system includes a filter for removing the particulate matter, wherein the method further comprises:
(C) determining a present filter efficiency of the filter using a present ventilation flow rate and the present concentration of the particulate matter;
(D) comparing the present filter efficiency to an efficiency threshold; and
(E) generating a notification and/or a report when the present filter efficiency declines below the efficiency threshold.

84. A method of adjusting an environment of an enclosure, the method comprising:
(a) receiving measurements of a sensed chemical property from one or more sensors disposed in the environment;
(b) comparing the measurements of the sensed chemical property to a requested profile of the chemical property to generate a result, which requested profile is generated by a learning module that is configured to (i) utilize past measurements of the one or more sensors and/or (ii) past preferences of an occupant of the environment; and
(c) adjusting the chemical profile of the environment to the requested chemical profile, if the comparison deviates from a threshold.

85. A method of controlling a facility, the method comprising:
(a) identifying an identity of a user by a control system;
(b) optionally tracking location of the user in the facility by using one or more sensors disposed in the facility, which one or more sensors are communicatively coupled to the control system;
(c) using an input related to the user; and
(d) using the control system to automatically alter one or more devices in the facility by using the input and location information of the user, which one or more devices are communicatively coupled to the control system.
